(19) United States
(12) Patent Application Publication
(10) Pub. No.: US 2012/0310788 A1
(43) Pub. Date: Dec. 6, 2012

(54) SALES SYSTEM

(75) Inventor: Norihiko NAONO, Tokyo (JP)

(73) Assignee: RIPPLEX INC., Tokyo (JP)

(21) Appl. No.: 13/560,550

(22) Filed: Jul. 27, 2012

Related U.S. Application Data
(63) Continuation of application No. PCT/JP2010/071242, filed on Nov. 29, 2010.

(30) Foreign Application Priority Data
Jan. 28, 2010 (JP) 2010-016326

(51) Int. Cl. G06Q 30/06

(52) U.S. Cl. 705/27.1

(57) ABSTRACT

A provider of a service Z permits server X to use delivery destination information of a user stored in server Z from server Y. A mobile terminal of a user A reads an image code related to a product URL using server Y. When sending to server Y, the product URL and an ID of user A are sent to server X and stored in a table. When the mobile terminal receives authentication from server Z of the service Z, delivery destination information selected by the mobile terminal A from among delivery destination information of user A stored in server Z is sent to server X, correlated with the product URL and sender ID and stored in the table. When user A completes payment in server Y and server X receives payment completed information, a product is sent using the delivery destination information received from server Z.

### CROSS REFERENCE TO RELATED APPLICATIONS

This application is a U.S. continuation application filed under 35 USC 111(a) claiming benefit under 35 USC 120 and 365(c) of PCT application JP2010/071242, filed on Nov. 29, 2010, which claims a priority to Japanese Patent Application No. 2010-016326 filed on Jan. 28, 2010, the entire contents of the foregoing applications being incorporated herein by reference.

### FIELD OF THE INVENTION

The present invention is related to a system and a server which provide a sales service via the internet. In addition, the present invention is related to a data processing system, a data processing server, a data processing terminal and data processing method which provide a delivery or sending service of goods or postal goods by linking a mobile terminal and a server.

### DESCRIPTION OF THE RELATED ART

Many goods sales services are being provided over the Internet with the rise in Internet users (refer to Japanese Patent Laid Open No. 2002-245351). A user performs a goods purchase and delivery procedure by moving to a goods sales service via various network services such as a search service or portal, news, SNS, chat, or blog. Advertisements are displayed on many of these goods sales service and include an advertisement media function. Advertisements on these types of network services are a window into obtaining users for goods sales services. Goods sales services pay remuneration for user acquisition or sales profit realization of advertisement media network services. In this way, goods sales services can realize an increase in profits and advertisement media network services can acquire advertisement profits.

Click remuneration or results remuneration is widely used as an advertisement remuneration system in network services. In a click remuneration system, a user selects an advertisement of a goods sales services displayed on a network service and remuneration is paid to the network service which displays the advertisement from the goods sales service for an event which is moving/linking to the goods sales service. On the other hand, in a results remuneration system, remuneration is paid to a network service from a goods sales service only when a user purchases a product on the goods sales service via an advertisement on the goods sales service displayed on the network service.

In addition, in a Web service for goods sales or product sales, a user selects a product via a browser window displayed on a data terminal and settlement via a credit card etc. is performed after the user inputs an address and name. Following this, the provider of the goods sales service delivers or sends the good to the address which is input by the user.

On the other hand, access to the internet is recently generally made by a mobile terminal and providers of Web services for product sales which can be used on a mobile terminal are increasing. Generally, a Web page which introduces a product group for sale is displayed on a mobile terminal and an advertisement or sales promotion of the product is performed by inputting a URL (Uniform Resource Locator) to a mobile terminal or by reading a bar code or an image code such as a two-dimensional code by an image reading means on the mobile terminal. In addition, there are Web services which include a function which can perform settlement or delivery orders after a user selects a product to purchase from a product group displayed on a mobile terminal. Furthermore, there are also Web services which include a function for sending a product which is selected from a product group displayed on a mobile terminal and purchased to another person as a gift.

More detail description is found in U.S. Pat. No. 5,715,314.

### SUMMARY OF THE INVENTION

The largest problem to be solved by both a goods sales service and an advertisement media network service related to advertisements of this type of network service us improving a close rate. A close rate is the number of contracts subtracted by the number of times a browser moves to and browses a goods service via an advertisement, and the close rate is said to be about 1% to 5% via network service advertisements. This means most of nearly all of the users who visit a goods sales service via an advertisement leave without purchasing a product. The provider of a goods sales service should improve their close rate and improve the user interface within the goods sales service. For example, by improving a goods sales service with a close rate of 2% by just 1%, the amount of sales of the goods sales service increase by 1.5 times. Because a low close rate means that there is considerable room for improving profits, improvement of the close rate is an extremely important problem for a goods sales service.

Improvement of a close rate in a goods sales service is equally an important problem to network service which runs advertisements. Improvement of a close rate on the side of a goods sales service in the case where a network service adopts a results remuneration system is directly linked to an increase in remuneration of the network service. In the case where a click remuneration service is adopted, there is no direct relationship between improving the close rate on the side the goods sales service and the remuneration system. However, because there is limit to the overall number of clicks in a network service which runs advertisements, an increase in the remuneration amount per click is necessary for improving the profit of the network service, Even in a click remuneration system, the sales profit of a goods sales service is their main source of revenue and improvement of the close rate on the side of the goods sales service is essential for increasing remuneration per click.

In addition, generally the display size of display means of a mobile terminal is smaller compared to a standing type terminal and there are also many limitations to input means. As a result, in a mobile terminal there is a tendency for a user to avoid processes which require multiple display or input steps. Therefore, a service for introducing a product via a mobile terminal is widely used because there are only a few steps for inputting to a mobile terminal in the case of displaying a Web page for introducing a product. On the other hand, in a Web service in which after purchasing a product delivery to one's home or delivery to another person as a gift is requested, a mobile terminal is less useful because multiple display and input steps are required such as selection of a product or input of a delivery destination and therefore is not widely used. In particular, in a Web site for gifts it is necessary to input multiple destination names and address as well as selection of a product. As a result, the number of display and inputs steps tends to be greater than in other Web services.

Furthermore, a user generally uses multiple Web services. In addition, delivery destination information is divided and stored among a plurality of servers of Web services used by a user. For example, when a user A requests delivery of a product or a postal, which is sold on a Web service Z, user A registers delivery destination information such as the name and the address of a user B in a server of the Web service Z by using an input means of the mobile terminal of user A. In the server of the Web service Z, this is registered as the delivery destination of user A so that it can be reused again in the future. Next, when user A requests delivery of a product or a postal item, which is sold on Web service Y, to user B, user A similarly registers the delivery destination such as the name and the address of user B in the server of Web service Y by using the input means of the mobile terminal. Furthermore, when user A requests delivery of a product or a postal item, which is sold on Web service Z, to user B, user A similarly registers the delivery destination such as the name and the address of user B in the server of Web service Z by using the input means of the mobile terminal.

In this way, in a Web service which provides a service for requesting delivery of a gift or postcard, the delivery destination information is often stored in the server of some Web service. However, in a current method or a system, the delivery destination information in a Web service are each independent and cannot be mutually utilized. As a result, it is necessary for a user to input the same delivery destination information a number of times in order to send gifts using different Web services. In particular, because there are many input means limitations in the case of a mobile terminal, the need to repeatedly input delivery destination information is an obstacle to the spread of gift or postcard Web service.

There are two important means for improving a closing rate. The first is reducing the number of steps until a purchase process after a user selects a product using a goods sales service, inputs delivery destination information, and makes payment is completed. The second is moving a user to a goods sales service from a network service while providing a high purchasing incentive to a user on the network service side.

First, a reduction in the number of steps is explained. A user first selects a product to purchase in almost all goods sales services. A shopping card model is used when selecting a product. First, it is often the case in this model that after one or more products are selected and entered into a shopping cart, and finally a purchasing process is performed (as described in Japanese Patent Laid Open No. 2002-245351 and U.S. Pat. No. 5,895,454). Usually, after a product is selected, it is necessary to input the name and the address of the user him/herself in order to have the product delivered etc. before the payment process. In addition, in the case of delivery of a product to a third party other than the user who purchase the product using a goods sales service, the name and the address of the delivery destination is also input. The process which has the most number of steps or involves complex operation by a user amount the product purchasing processes in a goods sales service is the process whereby a user inputs his/her own name and address into a data terminal. In the case of sending a product to a third party, a further is added for inputting the name and the address of the delivery destination. In particular, this problem is exacerbated when sending a plurality of products to a plurality of delivery destinations. This process of inputting these names and these addresses is the reason why most users leave a goods sales service.

In order to solve this problem, in many goods sales services, a user who inputs for the first time is encouraged to obtain an ID for uniquely identifying the user on the Web service called a member registration, and a function for storing the name and the address of the user who has obtained an ID and which are correlated with the ID on the server of the goods sales service is provided. In this way, a user who has obtained an ID can reduce the number of input steps after the second input and improvement in the closing rate can be expected. However, this method does not contribute to an improvement in the closing rate of a user who moves to a goods sales service for the first time via a network service advertisement. Because the problem to be solved by the present invention is an improvement in the closing rate in the case of visiting a goods sales service via a network service advertisement, reuse of user information or delivery information via member registration which is widely performed does not solve this problem. Reversely, the leaving rate of users is sometimes increased by encouraging a user who visits a goods sales service via a network service advertisement to perform a member registration process, and does not solve a significant drop in the closing rate due to complex input steps such as the name and address of a user and name and address of the delivery station.

In addition, improving a purchase incentive on the side of a network service is explained. A network service advertisement includes a link to a goods sales service. On the network service screen information related to a product for sale is pasted around the link to the goods sales service with the aim of improving a purchasing incentive after moving to the sales goods service. In the case where the network service provides a search service, a link to a goods sales service related to a search term is often displayed. This is because since the probability that a user of a search service is searching for a product related to a search term is high, a product purchasing incentive at the point where a user moves to a goods sales service is higher than a general advertisement.

However, there is a large gap between “being interested in information related to a product” or “searching for information related to a product” and “intending to purchase a product” and it is not easy to provide a strong product purchasing incentive at the point of moving from a network service to a goods sales service in this type of conventional method.

The present invention attempts to alleviate this situation by being able to improve usefulness to a user by reducing the number of steps of a product purchasing process or delivery process when a user moves to a goods sales service via a network service advertisement. Furthermore, a method, a server, a system. and a data terminal are provided for significantly improving a closing rate in a goods sales service and increasing both the profits of a network service and goods sales service.

In addition, the present invention attempts to solve the situation described above by reducing the input steps to the data terminal of a user by reading an image code correlated with the product or postal item and by using delivery destination data stored in the server of another Web service in a Web service which delivers or sends a product or postal item via a mobile terminal. In addition, the present invention provides a data processing method, a system, a mobile terminal, and a network for contributing to an increase in profits of a Web service provider by allowing the mutual use of delivery destination information among a plurality of Web services.

As one embodiment of the present invention, a system is provided including a first server (V) providing a first network service (sV) which a first user uses (A), a first information terminal (tA) of the first user, and a second server (X) providing a first goods sales service; wherein the first server sends to the first information terminal of the first user first name information of a first acquaintance of the first user and second name information of a second acquaintance of the first user wherein the first server correlates and stores a first ID which uniquely specifies the first user from among users of the first network service, the first information terminal displays the first name information of the first acquaintance and the second name information of the second acquaintance, the first user selects the first name information of the first acquaintance displayed on the first information terminal, the first information terminal sends the selection information of the first acquaintance to the first server, the first server sends first address information and the first name information of the first acquaintance which the first server correlates and stores with the first ID to the second server; the second server sends first product information of a first product to be sold by the first goods sales service and second product information of a second product to be sold by the first goods sales service to the first information terminal, the first information terminal displays the first product information and the second product information, the first information terminal sends selection information of the first product selected by the first user to the second server, and the second server performs a first sending process in which the first product is sent to the first acquaintance by sending the first name information and the first address information of the first acquaintance in a state being correlated with the first product information to a first sending process system.

As one embodiment of the present invention, a system is provided including a first server (V) providing a first network service (sV) which a first user (A) uses, a first information terminal (tA) of the first user, and a second server (X) providing a first goods sales service; wherein the first server sends the first information terminal of the first user first name information of a first acquaintance of the first user and second name information of a second acquaintance of the first user wherein the first server correlates and stores a first ID which uniquely specifies the first user from among users of the first network service, the first information terminal displays the first name information and the second name information of the second acquaintance by the first information terminal, the first user selects the first name information and the second name information, which are displayed on the first information terminal, the first information terminal sends the selection information of the first acquaintance and the second acquaintance to the first server, the first server sends the first name information and first address information of the first acquaintance which the first server correlates and stores with the first ID, and the second name information and second address information of the second acquaintance which the first server correlates and stores with the first ID to the second server, the second server sends first product information of a first product to be sold by the first goods sales service and second product information of a second product to be sold by the first goods sales service to the first information terminal, the first information terminal displays the first product information and the second product information, the first information terminal sends selection information of the first product selected by the first user to the second server, the second server sends the first name information and the second name information in a state being correlated with the first product information to the first information terminal, the first information terminal displays the first name information and the second name information in a state of being correlated with the first product information, the first user selects the first name information, the first information terminal sends the selection information of the first name information to the second server, and the second server performs a first sending process in which the first product is sent to the first acquaintance by sending the name information and the address information of the first acquaintance in a state being correlated with the first product information to a first sending process system by the second server.

As one embodiment of the present invention, a system is provides including a first server (X) providing a first network service which a first user (A) uses, a first information terminal (tA) of the first user, and a second server (V) providing a first goods sales service; wherein the first server send to the first information terminal of the first user first name information of a first acquaintance of the first user and first user name information of the first user wherein the first server correlates and stores a first ID which uniquely specifies the first user from among users of the first network service, the first information terminal displays the name information of the first acquaintance and the first user name information, the first user selects the first name information, the first information terminal sends the selection information of the first name information to the first server, the first server sends first address information of the first user and first user name information correlated and stored with the first ID to the second server, the second server send first product information of a first product to be sold by the first goods sales service and second product information of a second product to be sold by the first goods sales service to the first information terminal, the first information terminal displays the first product information and the second product information, the first information terminal sends selection information of the first product selected by the first user to the second server, the second server performing a second sending process in which the first product is sent to the first user by sending the first user name information and the first user address information in a state being correlated with the first product information to a first sending process system.

As one embodiment of the present invention, a system is provided including a first server (X) providing a first goods sales server which a first user (A) uses, a first information terminal (A) of the first user, and a second server (V) of a first network service that the first users uses; wherein the first server sends first product information of a first product to be sold by the first goods sales service and second product information of a second product to be sold by the first goods sales service to the first information terminal, the first information terminal displays the first product information and the second product information, the first information terminal sends first selection information of the first product selected by the first user to the first server, the first information terminal sends a first ID for identifying the first user among users of a first network service and a first password of the first user to the second server, the second server authenticates the first user using the first ID and the first password, the second server sends to the first information terminal first name information of a first acquaintance of the first user and second user information of a second acquaintance of the first user which the second server correlates and stores with the first ID, the first information terminal displays the first name information and the second name information, the first user selects the first name information displayed in the first information terminal, the first information terminal sends selection information of the first acquaintance to the second server, the second server sends first address information of the first acquaintance and the first name information which the second server correlates and stores with the first ID to the first server (X), and the first server performs a sending process in which the first product is sent to the first acquaintance by sending the first name information and the first address information in a state being correlated with the first product information to a sending process system.

As one embodiment of the present invention, a system is provided including a first server (X) of a first goods sales service which a first user (A) uses, a first information terminal (A) of the first user, and a second server (P) of a second network service (sW); wherein the first server sends first product information of a first product to be sold by a first goods sales service and second product information of a second product to be sold by the first goods sales service to a first information terminal, the first information terminal displays the first product information and the second product information, the first information terminal sends first selection information of the first product selected by the first user to the first server, the first information terminal receives first network service information of a first network service (sV) and second network service information of the second network service from the second server which provides a link service, the first user selects the first network service information using the first information terminal, the first information terminal sends a first ID of the first user for identifying the first user among users of the first network service and a first password of the first user to a third server (V) of the first network service specified by the first network service information, the third server authenticates the first user using the first ID and the first password, the third server sends first name information of a first acquaintance of the first user and second name information of a second acquaintance of the first user which the third server correlates and stores with the first ID to the first information terminal, the first information terminal displays the first name information and the second name information, the first user selects the first name information displayed in the first information terminal, the first information terminal sends selection information of the first acquaintance to the third server, the third server sends first address information of the first acquaintance and the first name information which the third server correlates and stores with the first ID to the first server, and the first server performs a sending process in which the first product is sent to the first acquaintance by sending the first name information and the first address information in a state being correlated with the first product information to a sending process system.

As one embodiment of the present invention, a server for providing a goods sales service is provided executing the steps of sending first product information of a first product and second product information of a second product to a first information terminal of a first user; receiving selection information of the first product by the first information terminal; storing a first product ID for identifying the first product in a first table; receiving first name information and first address information of a first acquaintance of the first user and second name information and second address information of a second acquaintance of the first user which the first user make stored in a first network service server (V) of the first network service from the first network service server; correlating and storing the first name information, the first address information, the second name information, and the second address information, which are received, with the first product ID in the first table; sending the first name information and the second name information to the first information terminal; receiving selection information of the first acquaintance from the first information terminal; and sending the first product to the first acquaintance by sending the first name information and the first address information to a product sending system.

As one embodiment of the present invention, a server for providing a goods sales service is provided executing the steps of sending first product information of a first product and second product information of a second product to a first information terminal of a first user; receiving selection information of the first product from the first information terminal; storing a first product ID for identifying the first product in a first table; receiving first user name information and first user address information of the first user and first name information and first address information of a first acquaintance of the first user which the first user make stored in a first network service server (V) of the first network service from the first network service server; correlating and storing the first user name information, the first user address information, the first name information, and the first address information, which are received, with the first product ID in the first table; sending the first user name information and the first name information to the first information terminal; receiving selection information by the first user from the first information terminal; and sending the first product to the first user by sending the name first user information and the first user address information to a product sending system.

As one embodiment of the present invention, a server for providing a goods sales service is provided executing the steps of: sending first product information of a first product and second product information of a second product to a first information terminal of a first user; receiving selection information of the first product from the first information terminal; storing a first product ID for identifying the first product in a first table; receiving first user name information and first user address information of the first user which the first user makes stored in a first network service server (V) of the first network service from the first network service server; correlating and storing the first user name information and the first user address information, which are received, with the first product ID in the first table; performing a first sending process in which the first product is sent to the first user by sending the first user name information and the first user address information to a product sending system; sending the first product information and the second product information to a second information terminal of second user; receiving selection information of the second product from the second information terminal; storing the first product ID in a second table; receiving second user name information and second user address information of the second user which the second user makes stored in a second network service server (W) of the second network service from the second network service server; correlating and storing the second user name information and the second user address information, which are received, with the first product ID in the second table; and performing a second sending process in which the first product is sent to the second user by sending the second user name information and the second user address information to a product sending system.

As one embodiment of the present invention, a server for providing a goods sales service is provided executing the steps of sending first product information of a first product and second product information of a second product to a first information terminal of a first user; receiving selection information of the first product from the first information terminal; storing a first product ID for identifying the first product in a first table; sending a request for obtaining first network service information of a first network service and second network service information of a second network service from a link service server to the first information terminal; receiving from the first network service server first name information and first address information of a first acquaintance of the first user and second name information and second address information of a second acquaintance of the first user which are stored in a first network service server (V) of the first network service which is selected by the first user using the first information terminal from among the network service information of the first network service and the network service information of the second network service sent from the link service server according to the request; correlating and storing the first name information, the first address information, the second name information, and the second address information, which are received, with the first product ID in the first table; sending the first name information and the second name information to the first information terminal; receiving selection information of the first acquaintance from the first information terminal; and sending the first product to the first acquaintance by sending the first name information and the first address information to a product sending system.

As one embodiment of the present invention, a server for providing a goods sales service is provided executing the steps of sending first product information of a first product and second product information of a second product to a first information terminal of a first user; receiving selection information of the first product from the first information terminal; storing a first product ID for identifying the first product in a first table; receiving network service information of a first network service and network service information of a second network service from a link service; sending the network service information of the first network service and the service information of the second network service to the first information terminal; receiving from a first network service server first name information and first address information of a first acquaintance of the first user and second name information and second address information of a second acquaintance of the first user stored in a first network service server (V) of the first network service selected by the first user using the first information terminal; correlating and storing the first name information, the first address information, the second name information, and the second address information, which are received, with the first product ID in the first table; sending the first name information and the second name information to the first information terminal; receiving selection information of the first acquaintance from the first information terminal; and sending the first product to the first acquaintance by sending the first name information and the first address information to a product sending system.

As one embodiment of the present invention, a server for providing a goods sales service executing the steps of receiving from a first network service server first name information and first address information of a first acquaintance of a first user and second name information and second address information of a second acquaintance of the first user which the first user makes stored in a first network service server (V) which provides a first network service; storing the first name information, the first address information, the second name information, and the second address information, which are received, in a first table; sending first product information of a first product and second product information of a second product to a first information terminal of the first user; receiving selection information of the first product from the first information terminal; correlating and storing a first product ID for identifying the first product with the first name information and the first address information and the second name information and the second address information in the first table; sending the first name information and the second name information to the first information terminal; receiving selection information of the first acquaintance from the first information terminal; and sending the first product to the first acquaintance by sending the first name information and the first address information to a product sending system.

As one embodiment of the present invention, a server for providing a goods sales service is provided executing the steps of receiving from a first network service server first user name information and first user address information of a first user and first name information and first address information of a first acquaintance of the first user which the first user makes stored in a first network service server (V) which provides a first network service; storing the first user name information, the first user address information, the first name information, and the first address information, which are received, in a first table; sending first product information of a first product and second product information of a second product to a first information terminal of the first user; receiving selection information of the first product from the first information terminal; correlating and storing a first product ID for identifying the first product with the first user name information and the first user address information and the first name information and the first address information in the first table; sending the first user name information and the first name information to the first information terminal; receiving selection information of the first user from the first information terminal; and sending the first product to the first user by sending the first user name information and the first user address information a product sending system.

As one embodiment of the present invention, a server for providing a goods sales service is provided executing the steps of receiving from a first network service server first user name information and first user address information of a first user which the first user makes stored in a first network service server (V) which provides a first network service; sending first product information of a first product and second product information of a second product to a first information terminal of the first user; receiving first selection information of the first product from the first information terminal; performing a first sending process which sends the first product to the first user by sending the first user name information and the first user address information to a product sending system; receiving from a second network service server (W) second user name information and second user address information of a second user which the second user makes stored in the second network service server which provides a second network service; sending the first product information of the first product and the second product information of the second product to a second information terminal of the second user; receiving second selection information of the first product from the second information terminal; and performing a first sending process in which the first product is sent to the second user by sending the second user name information and the second user address information to a product sending system.

As one embodiment of the present invention, a server (V) for providing a network service is provided executing the steps of sending first name information of a first acquaintance of a first user and second name information of a second acquaintance of the first user correlated with a first ID for identifying the first user from among users of the network service to a first information terminal (A) of the first user; receiving selection information of the first acquaintance from the first information terminal; sending the first name information and first address information which is correlated and stored with the first ID to a first goods sales server (X) of a first goods sales service in order to send a product sold by the first goods sales service to the first acquaintance; sending the first name information and the second name information to the first information terminal; receiving selection information of the second acquaintance from the first information terminal; and sending the second name information and the second address information of the second acquaintance correlated and stored with the first ID to a second goods sales server (Y) of a second goods sales service in order to send a product sold by the second first goods sales service to the second acquaintance.

As one embodiment of the present invention, a server (V) for providing a network service executing the steps of sending first user name information of a first user and first name information of a first acquaintance of the first user correlated with a first ID for identifying the first user from among users of the network service to a first information terminal (A) of the first user; receiving selection information of the first acquaintance from the first information terminal; sending the first name information and the first address information correlated and stored with the first ID to a first goods sales server (X) of a first goods sales service in order to send a product sold by the first goods sales service to the first acquaintance; sending the first user name information of the first user and the first name information to the first information terminal; receiving selection information of the first user from the first information terminal; and sending the first user name information and the first user address correlated and stored with the first ID to a second goods sales server (Y) of a second goods sales service in order to send a product sold by the second first goods sales service to the first user.

As one embodiment of the present invention, a server (V) for providing a network service is provided executing the steps of sending first name information of a first acquaintance of a first user and second name information of a second acquaintance of the first user correlated with a first ID for identifying the first user from among users of the network service to a first information terminal (A) of the first user; receiving selection information of the first acquaintance from the first information terminal; receiving first goods sales service information of a first goods sales service and second goods sales service information of a second goods sales service from a link service server of a link service; sending the first goods sales service information and the second goods sales service information to the first information terminal; receiving selection information of the first goods sales service from the first information terminal; sending the first name information and the first address information correlated and stored with the first ID to a first goods sales server of the first goods sales service in order to send a product sold by the first goods sales service to the first acquaintance; sending the first name information and the second name information to the first information terminal; receiving selection information of the second acquaintance from the first information terminal; receiving the first goods sales service information and the second goods sales service information from the link service server; sending the first goods sales service information and the second goods sales service information to the first information terminal; receiving selection information of the second goods sales service information from the first information terminal; and sending the second name information and the second address information correlated and stored with the first ID to a second goods sales server of the second goods sales service in order to send a product sold by the second first goods sales service to the second acquaintance.

In one embodiment of the present invention, it is possible to reuse delivery destination information which has been input once in a certain Web service in a different Web service. In this way, it is possible to reduce the display and input steps when a user uses a gift or postcard Web service using a mobile terminal, and promote the spread of a gift or postcard Web service using a mobile terminal.

So far, using delivery destination information stored by a user in a certain Web service as delivery destination information of a different Web service has neither been realized nor predicted. The reason for this is that for a provider of a Web service, delivery destination information of a user is thought of as a source of profits or a tool for distinguishing between competing providers, and therefore, was an obstacle to realizing or predicting use of this information in a different Web service. For example, in the example described above, a name and an address which are delivery destination information of a user A is stored in a server of a Web service Z and this delivery destination information is reused only when a user A uses the Web service Z and input to a mobile terminal is omitted. Due to the convenience of being able to omit input of this information to a mobile terminal, it is more likely that the user A will request delivery of a gift or a postcard using Web service Z.

In a current method or a system, in order to make it possible for a user A to use delivery destination information of the user A stored in a server of the Web service Z in Web service Y, it is necessary to send and store the delivery destination information of the user A stored in the Web service Z to a server of the Web service Y. Because this reduces the competitive position of the Web service Z with respect to the Web service Y for the user A, the Web service Z would never send delivery destination information of a user stored in its server to a server of another Web service.

The inventor of the present invention has proposed a method for mutual use of acquaintance information in different Web services in a separate patent application. However, a method or system for mutual use of a delivery destination for reducing the number of input steps of a user and for promoting use of a gift Web service using a mobile terminal did not exist.

As one embodiment of the present invention, a system is provided including a first server (Y) having a first table (a product URL table) which correlates and stores a product identification tag (a product ID) and product additional information and providing a first Web service (a service Y), a mobile terminal, a second server, and a third server: wherein the first server generates an image code which represents a product identification tag in the first table, the mobile terminal sends a first identification tag (IDya) of a user (A) in the first Web service (the service Y) to the first server (Y), the first server (Y) authenticates the first user identification tag (IDya), the mobile terminal sends the product identification tag to the first server (Y) after the mobile terminal reads the image code, the first server (Y) sends the product identification tag (the product ID) and the first user identification tag (IDya) to a second server (X), the second server (X) correlates the product identification tag (the product ID) and the first user identification tag (IDya) and stores in a first row of a second table (a temporary product delivery information storage table), the mobile terminal sends a second user identification tag (IDza) of the user in a second Web service (a service Z) to a third server (Z) which provides the second Web service (the service Z), the third server authenticates the second user identification tag (IDza), the third server (Z) sends delivery destination information of the user stored in the third sever (Z) to the mobile terminal, the mobile terminal displays delivery destination information of the user, the mobile terminal sends selection completed delivery destination information selected by the mobile terminal to the third server (Z), the third server (Z) sends the selection completed delivery destination information to the second server (X) by the second server, the second server (X) correlates the selection completed delivery destination information with the product identification tag (the product ID) and the first user identification tag (IDya) in the first row and storing in the first row of the second table, the second server (X) performs a process for sending the selection completed delivery destination information to a printing device when the second server receives payment completion information from the first server (Y).

As one embodiment of the present invention, a server is provided executing the steps of receiving a product identification tag from a mobile terminal of a user and a user identification tag (IDya) in a first Web service of a user by a first server (Y), correlating the product identification tag and the user identification tag and storing in a row of a table (a temporary product delivery information storage table), receiving selection completed delivery information selected from delivery destination selection information sent to a second server (Z) from the mobile terminal of the user from among delivery destination information of the user stored by the second server (Z), correlating the selection completed delivery destination information with the product identification information and the user identification tag (IDya) and storing in the first row of the table, and sending the selection completed delivery destination information to a printing device when payment completed information is received by the first server (Y).

As one embodiment of the present invention, mobile terminal is provided executing the steps of sending a first identification tag of a first user in a first Web service (a service Y) and a first authentication tag (IDxa) of the user in the first Web service (the service Y) to a first server (Y) which provides the first Web service (the service Y), receiving a service identification tag group comprised from a plurality of identification tags which shows each of a plurality of Web services other than the first Web service (the service Y) by a second server (X) which provides a link service, sending a specific service identification tag which shows a third Web service (a service Z) selected by the user from the service identification tag group using an input means to the second server (X), sending a second identification tag of the user in the third Web service (the service Z) and a second authentication tag (IDza) of the user in the third Web service (the service Z) to a third server which provides the third Web service, receiving a plurality of delivery destination information groups of the user stored by the third server (Z) from the third server (Z), sending partial delivery destination information groups selected by the user using the input means from among the delivery destination information groups to the third server (Z), and sending payment information to the first server (Y).

### BRIEF EXPLANATION OF THE DRAWINGS

FIG. 1 is a structural diagram of a goods delivery processing system related to one embodiment of the present invention,

FIG. 2 is an example of a structure of a server of a link service X related to one embodiment of the present invention,

FIG. 3 is an exemplary structural diagram of a delivery destination printing device related to one embodiment of the present invention,

FIG. 4 is an exemplary structural diagram of a server of a Web service Y related to one embodiment of the present invention,

FIG. 5 is an e exemplary structural diagram of a server of a Web service X related to one embodiment of the present invention,

FIG. 6 is an exemplary structural diagram of a mobile terminal of a user A related to one embodiment of the present invention,

FIG. 7 is an exemplary structural diagram of a management terminal of a Web service Y, and a Web service Z related to one embodiment of the present invention,

FIG. 8 is a flow chart of an access control process to a link service X related to one embodiment of the present invention,

FIG. 9 is an example of an access control screen displayed on a management terminal related to one embodiment of the present invention,

FIG. 10 is an example of an access control table related to one embodiment of the present invention,

FIG. 11 is a flow chart of a process for sending a product sold by a Web service Y as a gift etc. in one embodiment of the present invention,

FIG. 12 is an example of a product URL table in one embodiment of the present invention,

FIG. 13 is an example of an image code which represents a product URL in one embodiment of the present invention,

FIG. 14 is an example of a product confirmation screen in one embodiment of the present invention,

FIG. 15 is an example of an authentication screen in one embodiment of the present invention,

FIG. 16 is an example of a user table in one embodiment of the present invention,

FIG. 17 is a flow diagram of a sending process in a server X in one embodiment of the present invention,

FIG. 18 is an example of a product delivery temporary storage table in one embodiment of the present invention,

FIG. 19 is an example of a service link screen in one embodiment of the present invention,

FIG. 20 is an example of an authentication screen of a Web service Z related to embodiment of the present invention,

FIG. 21 is an example of a user table of a Web service Z related to embodiment of the present invention,

FIG. 22 is an example of a delivery destination table in a Web service Z related to embodiment of the present invention,

FIG. 23 is an example of a display of a delivery destination list stored in a Web service Z related to one embodiment of the present invention,

FIG. 24 is an example of a product delivery information temporary storage table in one embodiment of the present invention,

FIG. 25 is a process flow chart for selecting a delivery destination of a product from among a delivery destination list of a Web service Y,

FIG. 26 is an example of a user table in one embodiment of the present invention,

FIG. 27 is an example of a delivery destination table in a Web service Z related to one embodiment of the present invention,

FIG. 28 is an example of a display of a delivery destination list of a Web service Y related to one embodiment of the present invention,

FIG. 29 is an example of a product delivery information temporary storage table in one embodiment of the present invention,

FIG. 30 is a flow diagram of a process up to sending a selected product to a delivery destination in one embodiment of the present invention,

FIG. 31 is an example of a sending receipt screen in one embodiment of the present invention,

FIG. 32 is an approximate structural diagram of a goods sales system related to one embodiment of the present invention,

FIG. 33 is a structural diagram of an information terminal in one embodiment of the present invention,

FIG. 34 is a structural diagram of a server of a link service in one embodiment of the present invention.

FIG. 35 is a structural diagram of a server of a goods service in one embodiment of the present invention,

FIG. 36 is a structural diagram of a network service related to one embodiment of the present invention,

FIG. 37 is a structural diagram of a delivery information processing device related to one embodiment of the present invention,

FIG. 38 is a flow chart of linking process of a network service and goods sales related to one embodiment of the present invention,

FIG. 39 is an example of an acquaintance information table related to one embodiment of the present invention,

FIG. 40 is an example of an acquaintance information display screen of a user in a network service related to one embodiment of the present invention,

FIG. 41 is a structural diagram of a temporary storage table created in a storage means within a server of a network service related to one embodiment of the present invention,

FIG. 42 is an example of a temporary storage table created in a storage means within a server of a bet service related to one embodiment of the present invention,

FIG. 43 is an example of a goods sales service selection screen in a network service related to one embodiment of the present invention,

FIG. 44 is an example of a network service table related to one embodiment of the present invention,

FIG. 45 is a flow chart of a process for a user to send to a good to an acquaintance using a goods sales service related to one embodiment of the present invention,

FIG. 46 is a diagram which shows the structure of a table generated in a process for a user to send a good to an acquaintance using a goods sales service related to one embodiment of the present invention,

FIG. 47 is an example of a product selection screen related to one embodiment of the present invention,

FIG. 48 is an example of a user information screen related to one embodiment of the present invention,

FIG. 49 is an example of a delivery destination selection screen related to one embodiment of the present invention,

FIG. 50 is an example of a delivery destination selection screen related to one embodiment of the present invention,

FIG. 51 is an example of an acquaintance information display screen related to one embodiment of the present invention,

FIG. 52 is an example of a temporary storage table of a server related to one embodiment of the present invention,

FIG. 53 is an example of a goods sales service selection screen related to one embodiment of the present invention,

FIG. 54 is an example of a temporary storage table of a server related to one embodiment of the present invention,

FIG. 55 is an example of a user information screen related to one embodiment of the present invention,

FIG. 56 is an example of a delivery destination selection screen related to one embodiment of the present invention,

FIG. 57 is an example of a delivery destination selection screen related to one embodiment of the present invention,

FIG. 58 is a flow chart of a process related to one embodiment of the present invention,

FIG. 59 is an example of a user information screen related to one embodiment of the present invention, and

FIG. 60 is an example of an authentication screen related to one embodiment of the present invention.

### DETAILED DESCRIPTION OF THE INVENTION

The currently considered preferred embodiments for working the present invention are explained below. Furthermore, since the scope of the present invention is clearly defined by the scope of the appended claims this explanation should not be construed to a limited meaning and will be performed with the aim of exemplifying the general principles of the invention.

### First Embodiment

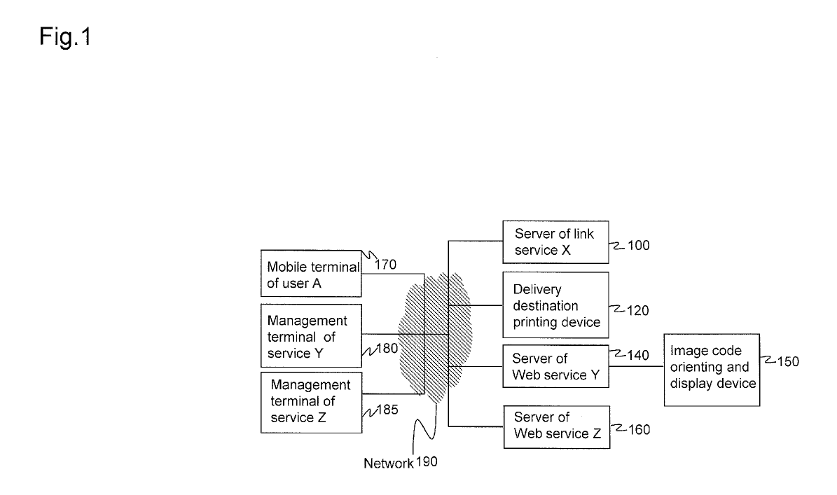

FIG. 1 is a structural diagram of a goods delivery processing system related to a first embodiment of the present invention. The goods delivery processing system related to the present embodiment includes a server 100 of a link service X, a delivery destination printing device 120, a server 140 of a Web service Y, a server 160 of a Web service Z, a mobile terminal 170 of a user A, a management terminal 180 of the Web service Y, and a management terminal 185 of the Web service Z, and these are connected via a network. In addition, an image code printing and display device 150 is connected to the server 140 of the Web service Y. This connection may be a direct connection or via a network 190 or other network.

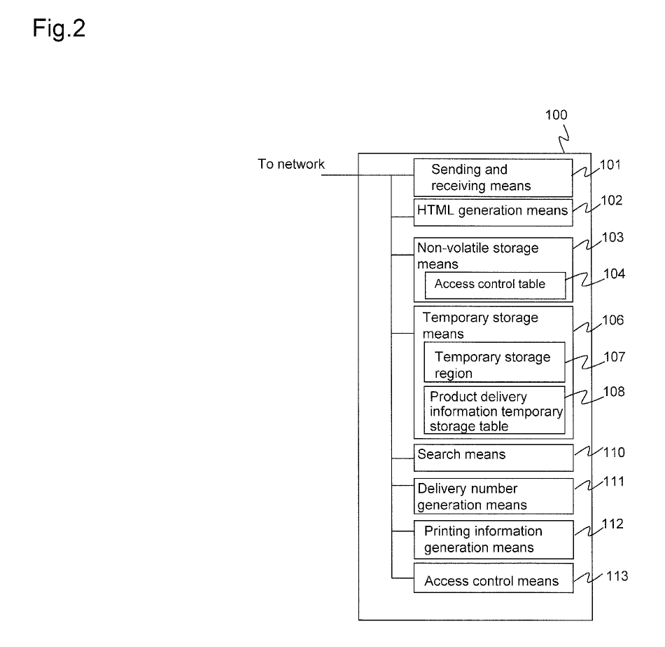

FIG. 2 shows an exemplary structure of the server 100 of the link service X. The server 100 of the link service X includes a sending and receiving means 101, an HTML generation means 102, a non-volatile storage means 103, a temporary storage means 106, a search means 110, a delivery number generation means 111, a printing information generation means 112, and an access control means 113. The non-volatile storage means 103 includes an access control table 104. The temporary storage means 106 includes a temporary storage region 1077 and a product delivery information temporary storage table 108.

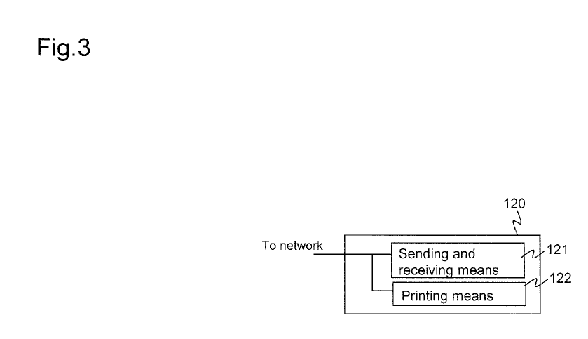

FIG. 3 shows an exemplary structure of the delivery destination printing device 120. The delivery destination printing device 120 includes a sending and receiving means 121 and a printing means 122.

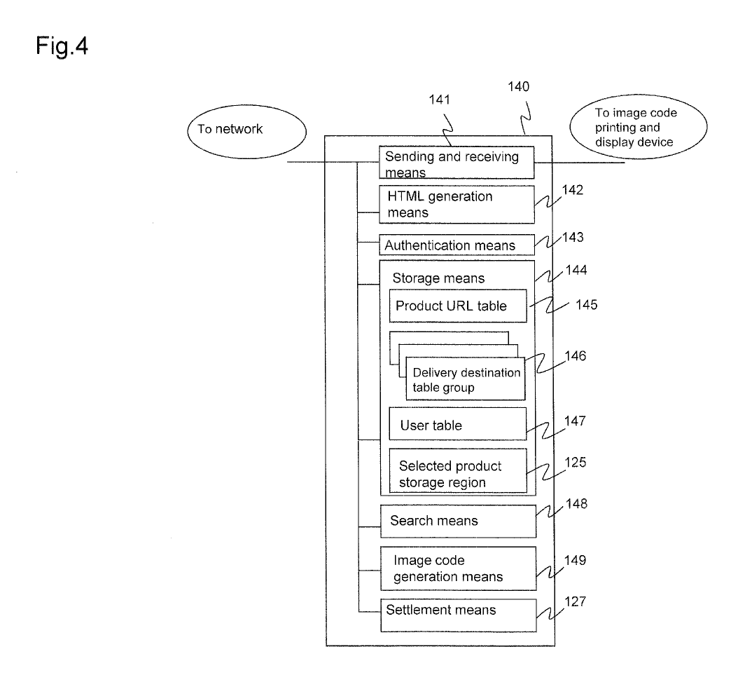

FIG. 4 shows an exemplary structure of the server 140 of the Web service Y. The server 140 of the Web service Y includes a sending and receiving means 141, an HTML generation means 142, an authentication means 143, a storage means 144, a search means 148, an image code generation means 149, and a payment completion (settlement) means 127. In addition the storage means 144 includes a product URL table 145, a delivery destination table group 146, a user table 147, and a selected product storage region 125.

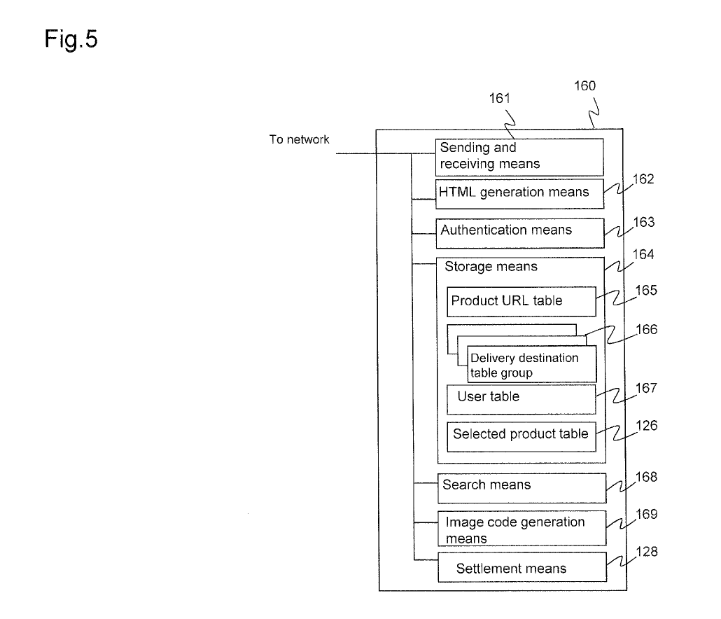

FIG. 5 shows an exemplary structure of the server 160 of the Web service Z. The server 160 of the Web service Z includes a sending and receiving means 161, an HTML generation means 162, an authentication means 163, a storage means 164, a search means 168, an image code generation means 169, and a payment completion means 128. In addition the storage means 164 includes a product URL table 165, a delivery destination table group 166, a user table 167, and a selected product storage region 126.

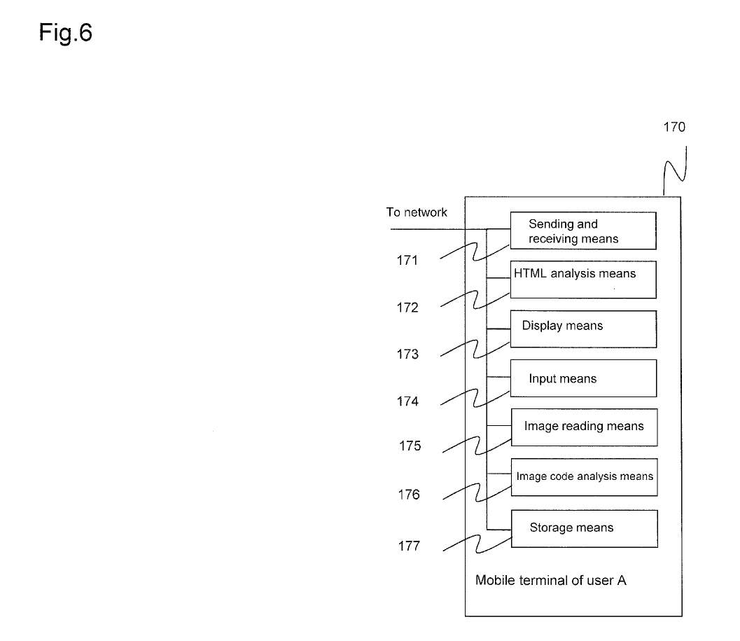

FIG. 6 shows an exemplary structure of a mobile terminal 170 of the user A. The mobile terminal 170 of the user A includes a sending and receiving means 171, an HTML analysis means 172, a display means 173, an input means 174, an image reading means 175, an image code analysis means 176, and a storage means 177.

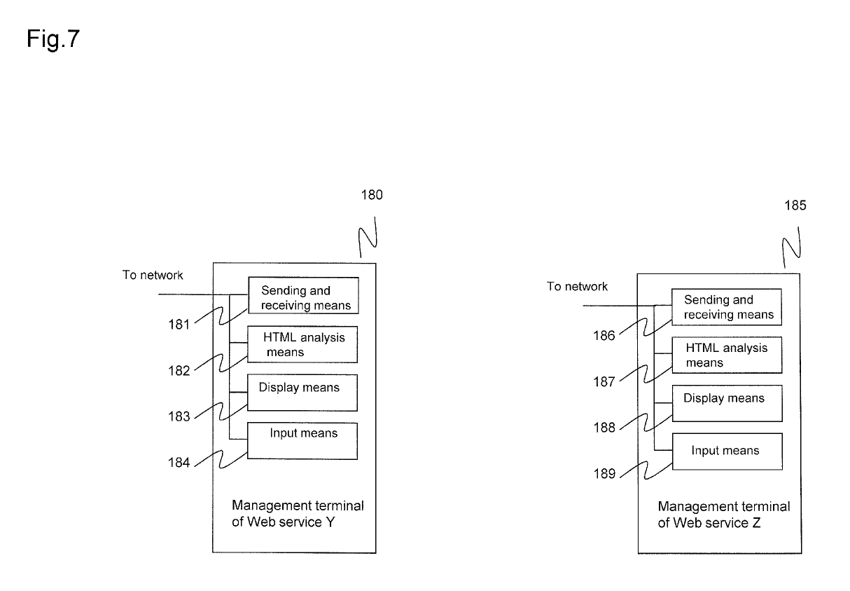

FIG. 7 shows an exemplary structure of a management terminal 180 of the Web service Y, and the Web service Z. The management terminal 180 of the Web service Y includes a sending and receiving means 181, an HTML analysis means 182, a display means 183, and an input means 184. The management terminal 185 of the Web service Z includes a sending and receiving means 186, an HTML analysis means 187, a display means 188, and an input means 189.

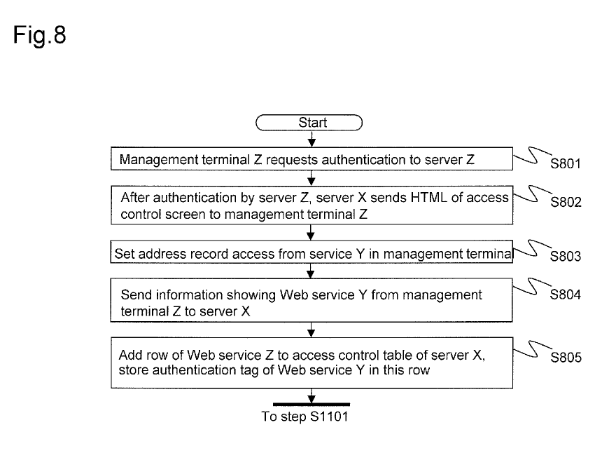

Next, an access control to a link service X is explained using the flow chart in shown in FIG. 8. The access control to the link service X refers to a selection by a provider of a Web service and/or a user of a Web service whether the user may use delivery destination information of the user stored in a server of a different Web service via another Web service. For example, it is possible for a provider of Web service Z to set whether a user A can use delivery destination information of user A managed by Web service Z via Web service Y. In the present embodiment, it is assumed that the Web service Y sells a good or a postal item to a user and the user request delivery of the good or postal item. In addition, it is assumed that Web service Z sells a good or postal item to a user and provides a delivery service or SNS, mail, chat or voice communication. In addition, Web service Y and Web service Z may be any kind of Web service. The Web service Y is provided via the server 140 of the Web service Y. In addition, the Web service Z is provided by the server 160 of the Web service Z. Below, the server 100 of the link service X is abbreviated to server 100, the server 140 of the Web service Y to server Y, and the server 160 of the Web service Z to server Z. In the flow charts below, the management terminal 185 of the Web service Z is abbreviated to management terminal Z and the management terminal 180 of the Web service Y.

First, the manager of the Web service Z requests authentication to the server Z from the management terminal Z185 (step S801). This authentication may be realized by combination of a manager ID and password etc., or by a different method. In addition, authentication may be realized using the IP address of the sender in the case where the management terminal Z1885 requests authentication. When the authentication means 163 of the server Z authenticates the management terminal of the service Z, connection of the management terminal of the server Z is redirected to the server X. Next, the HTML generation means 102 of the server X generates an HTML code of an access control screen of a link service, and the sending and receiving means 101 sends this to the management terminal Z185 via the network 190 (step S802). When the sending and receiving means 186 of the management terminal Z185 receives this, an access control screen is displayed on a display means 188 after analysis by the HTML analysis means 187.

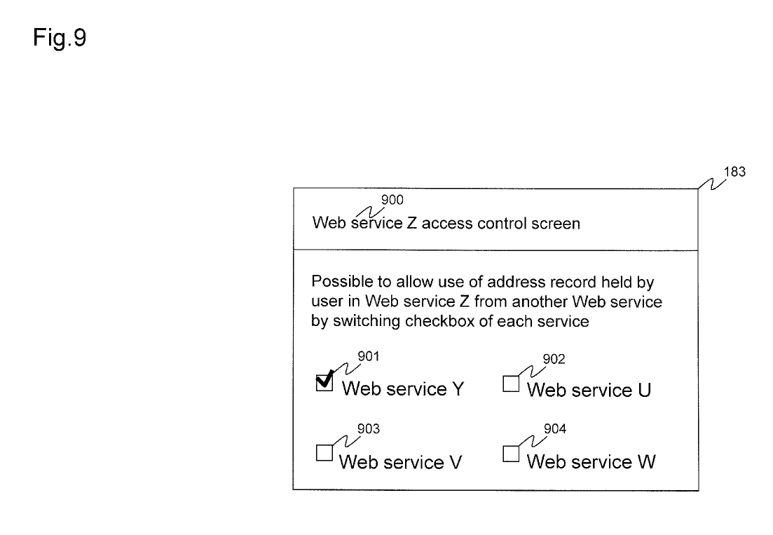

An example of an access control screen displayed on the display means 188 of the management terminal Z185 is shown in FIG. 9. The access control screen is a screen which controls whether permission is given for use of delivery destination information of a user in the Web service Z stored in the server Z in the case where a user in a different service requests delivery. In addition, the access control screen, as is shown in FIG. 9, may include a display 900 which shows that it is a screen which controls use of delivery destination information. In addition, a different Web service list which can be linked to by Web service Z is displayed on the access control screen. A manager of the Web service Z which receives authentication via the server Z can select a linked Web service by selecting a checkbox displayed in the list of the Web service to ON via the input means 189. In the example shown in FIG. 9, the manager of the Web service Z switches ON the checkbox 901 of the Web service Y. For example, in the example in FIG. 9, an operation for switching ON the checkbox 901 may allow a user of the Web service Y to be able to use the delivery destination information of a user stored in the server Z from the Web service Y (step S803). In other words, in the case where a user in the Web service Y requests delivery of a good etc., it is possible to use the delivery destination information stored in the server Z.

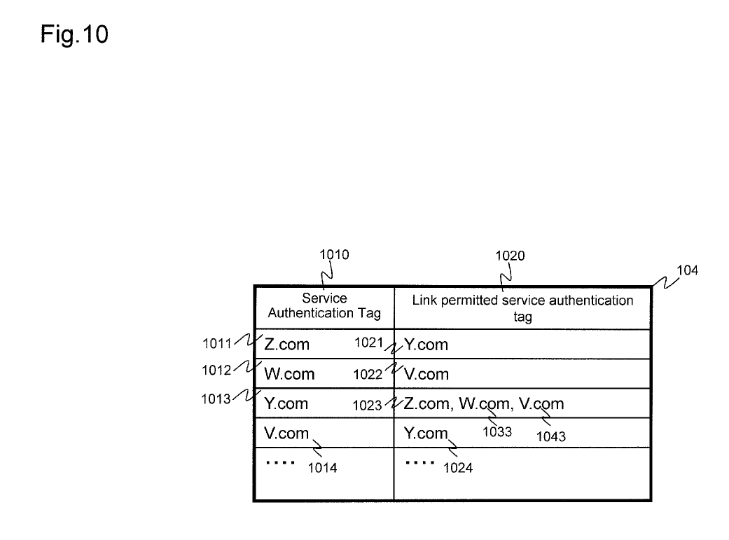

Next, the sending and receiving means 186 of the management terminal Z185 sends information which shows the Web service Y to the server X100 via the network 190 (step S804). When the sending and receiving means 101 of the server X receives this, a new row is added to the access control table 104 of the non-volatile storage means 103 and information which shows the Web service Y is stored. An example of the access control table 104 is shown in FIG. 10. The access control table includes a service identification tag column 1010 and a link permitted service identification tag column 1020. Each field of the link permitted service identification tag may have an arbitrary length.

A row including an identification tag Z.com 1011 of the Web service Z which sets access control in step S804 is added and an identification tag Y.com 1021 which shows Web service Y is stored as a link permissible server of the Web service Z (step S805). Furthermore, the processes from step S801 to step S805 correspond to a process in which the manager of the Web service Z makes a setting so that a user of the Web service Z can use the delivery destination information stored in the server Z via the Web service Y. Here, the delivery destination information stored by a user of the Web service Z in the server Z is stored in a delivery destination group 166.

All the managers of the Web services can mutually set this type of access control by accessing the link service X. For example, in the example shown in FIG. 10, the manager of the Web service Y can perform a setting so that the delivery destination information stored by a user of the Web service Y in the server Y via the Web service Z 1023, Web service W 1033, and Web service V 1043 by adding a row of the Web service Y 1013 to the access control table 104 from the management terminal 180. The explanation of processes for performing this are omitted here since they are the same as the processes from steps S801 to S805. The setting shown in FIG. 10 is realized by the manager of the Web service Y selecting Web service Z, W, and V as a web service for linking using the access control screen. In this way, in the present embodiment, the manager of the Web service can set whether a user of the Web service can use the delivery destination information stored in a server of the Web service via another Web service.

Two arbitrary Web services may mutually allow the use of delivery destination information stored in the server of another Web service or not. For example, in the example shown in FIG. 10, the delivery destination information stored by a user of the Web service W 1012 in a server of this Web service can be used via the Web service V 1012. However, the delivery destination information stored by a user of the Web service V 1014 in a server of this Web service cannot be used via the Web service W.

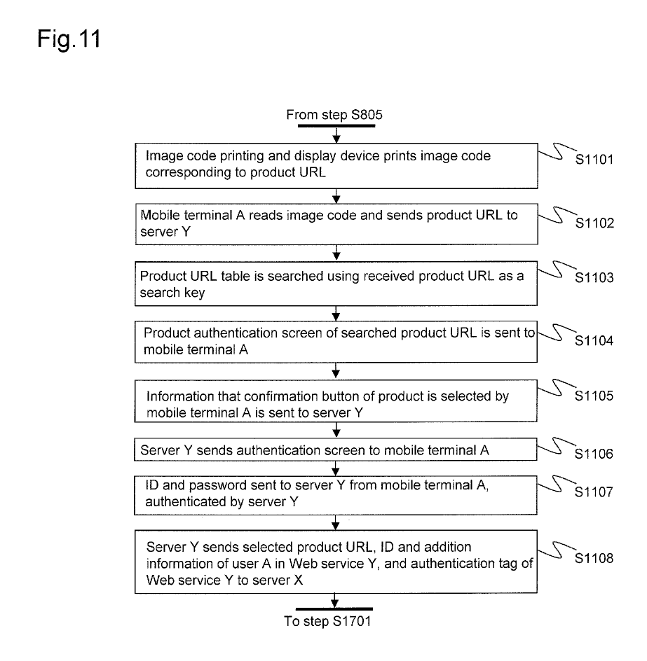

Next, with reference with the flow diagram shown in FIG. 11, a process is explained whereby user A makes a request for sending a product as a gift sold on the Web service Y to user B registered as delivery destination information stored in the server 160 of the Web service Z. The delivery destination information to user B is stored by user A in the server 160 in the Web service Z. Alternatively, the delivery destination information to user B may also be stored by a user other than user A in the server 160 of Web service Z.

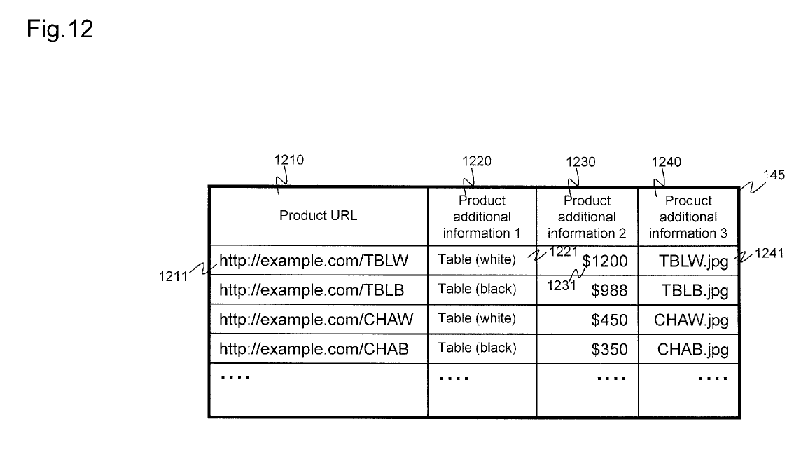

Furthermore, the mobile terminal of user A is abbreviated to the mobile terminal A below. The storage means of the server Y includes a product URL table 145 and a product URL is correlated with the product and product additional information are stored in the table. An example of the product URL table is shown in FIG. 12. In the example shown in FIG. 12, three product additional information of a product name 1220, a product price 1230, and a product image 124 are correlated with a URL which can uniquely specify a product sold on the Web service Y and stored. The product additional information correlated with the product URL and stored may contain any amount or type of information.

First, the image code generation means 149 of the server Y generates an image code corresponding to each product URL and an image code printing and displaying device prints or displays the image codes (step S1101). In FIG. 1, the image code printing and displaying device 150 is connected to the server 140. However, they may also be connected via a network. In addition, the image codes generated by the image code generation means of the server Y may also be displayed on a device such as a television receiver. In addition, the display device does not have to be connected to the server Y and the image codes generated in the server Y may be stored in a storage media and printed after being read by the image code printing and displaying device. Furthermore, a server does not have to include the image code generation means does and the image code printing and displaying device may include the image code generation means and may perform generation, printing and display of an image code.

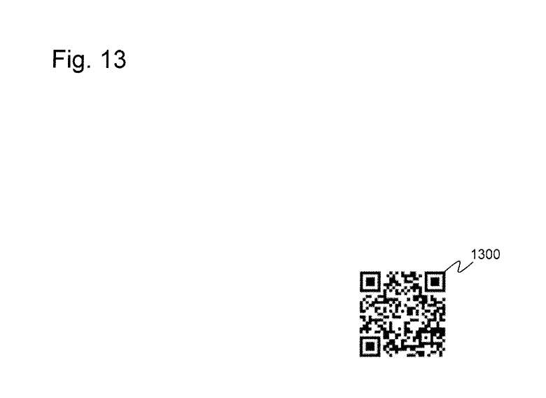

An example of an image code of a product URL 911 of the product URL table is shown in FIG. 13. In the example shown in FIG. 13, a product URL 1211 is converted to an image code 1300 according to a two dimensional code (for example, ISO/IEC 18004). The image code 1300 may be any image as long as it uniquely determines a product URL.

In the present embodiment, address information of a user B which is required when sending a product to user B is not stored in server Y but may be stored in a delivery destination table 166 in a storage means 164 of server Z. That is, in the present embodiment, it is possible to send a product sold by Web service Y to user B using address information stored in the delivery destination table in Web service Z. At this time, according to the present embodiment, it is not necessary for the provider of Web service Y to store address information of user B stored in server Z as a database in a server of Web service Y.

Next, an image code 1300 printed or displayed by an image code printing and displaying device is read by the image reading means 175 of the mobile terminal A and analyzed by the image code analysis means 176. Then, a product URL which is represented by the image code 1300 is extracted and stored in the storage means 177. In the example shown in FIG. 13, the extracted product URL is http://example.com/TBLW. Next, the product URL is sent to server Y 140 by the sending and receiving means 171 via network 190 (step S1102).

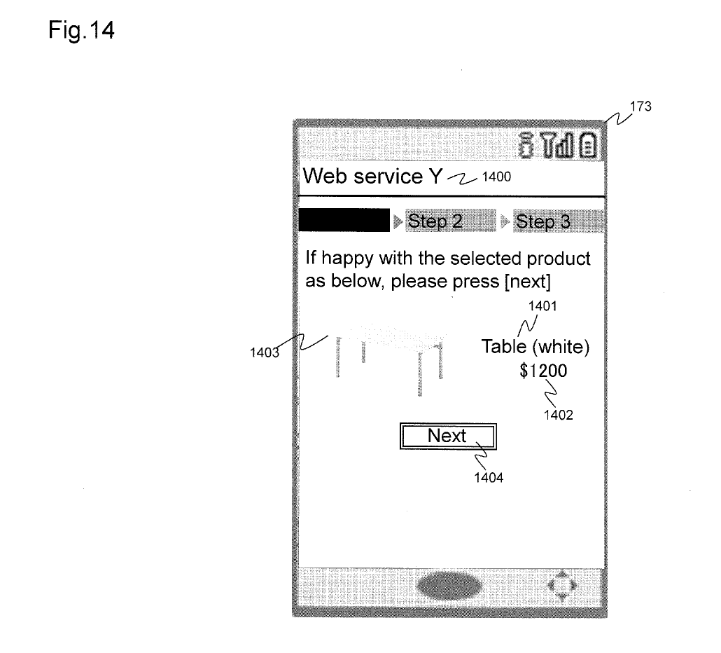

The sending and receiving means 141 of server Y receives the product URL from the mobile terminal of user A. The product URL table is searched by the search means 148 using the product URL, which is received, as a search key and product additional information correlated with the product URL 1211 and stored is obtained (step S1103). Next, the HTML generation means 142 generates an HTML code for a product confirmation screen including the product additional information and the sending and receiving means 141 sends this to the mobile terminal A via network 190 (step S1104). When the sending and receiving means 171 of the mobile terminal A receives the HTML code, the HTML analysis means 172 analyzes the code and is displayed on the display means 173. An example of a product confirmation screen is shown in FIG. 14.

A display 1400 which indicates that a displayed screen is the screen of the Web service Y and product additional information received by the mobile terminal A from the server Y are displayed in the display means 173 of the mobile terminal A in FIG. 14. The product additional information 1401 and product additional information 1402 shown in FIG. 14 each correspond to the product additional information 1221 and product additional information 1231 of the product URL table shown in FIG. 12. In addition, the product additional information 1403 shown in FIG. 14 is an image file which represents a file name of the additional information 1241 of the product URL table shown in FIG. 12. Next, the confirmation button 1404 displayed on the display means 173 is selected when user A operates the input means 174 of the mobile terminal A. Then, the sending and receiving means 171 sends the information which shows that the confirmation button has been selected to the server Y 140 via network 190 (step S1105).

When the sending and receiving means 141 receives the information which shows that the confirmation button has been selected, a product URL of a product confirmed by the selection in step S1105 is stored in a selected product storage region 125. The HTML generation means 142 generates an HTML code for displaying a confirmation screen and the sending and receiving means 141 sends this HTML code to the mobile terminal A via network 190. When the sending and receiving means 171 of mobile terminal A receives the HTML code, the code is analyzed by the HTML analysis means 172 and as a result a confirmation screen is displayed on the display means 173.

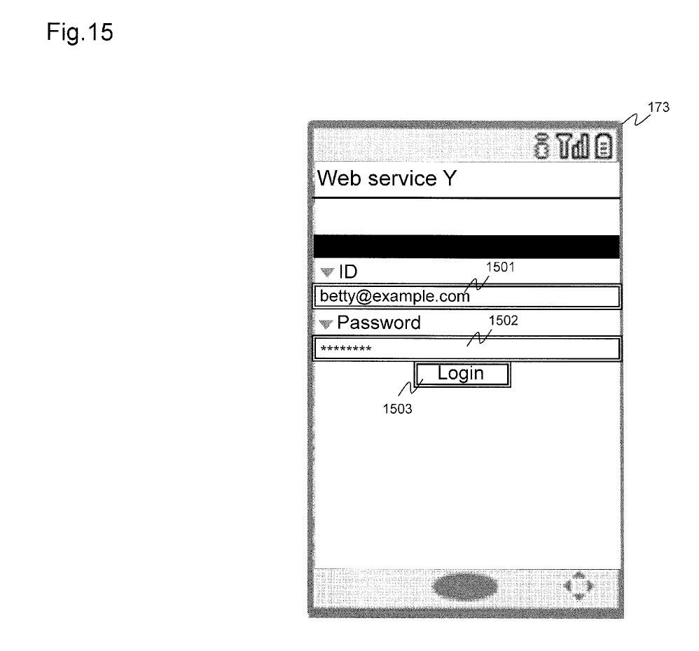

An example of a confirmation screen is shown in FIG. 15. User A inputs an ID in the Web service Y to the ID input area 1501 and a password in the Web service Y to the password input area using the input means 174 and a log-in button 1503 is selected. In the example shown in FIG. 15, “betty@example.com” is input as the ID and “stone123” is input as the password. Then, the sending and receiving means 171 sends the input ID and password to the server Y 140 via network 190.

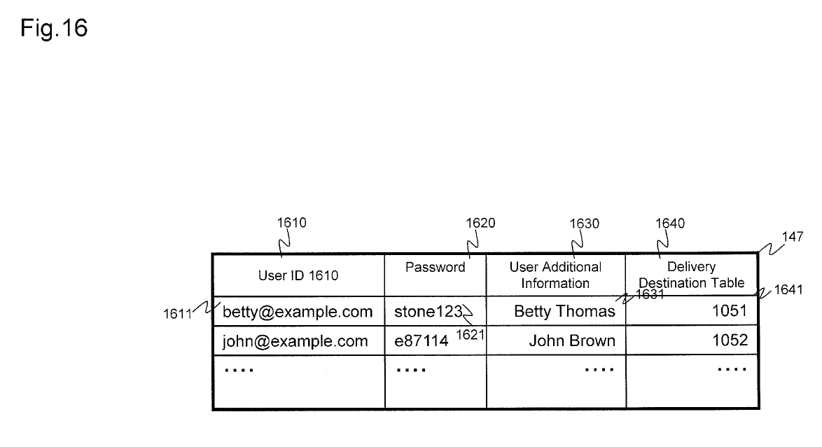

When the sending and receiving means 141 of server Y receives the ID and the password, the search means 148 searches the user table 147 in the storage means using the ID, which is received, as a search key. As a result of this search, if the password stored in the user table correlated with the ID, which is received, matches the password, which is received, match, the authentication of user A is completed (step S1107). The example of a user table shown in FIG. 16 includes the columns of user ID1610, password 1620, additional information 1630, and delivery destination information 1640. The user additional information may be a plurality of information and information such as the name and address of a user.

In the example shown in FIG. 16, user A is authenticated when a match between the password “stone132” 1621 searched using “betty@example.com”, which is received, as a search key, and the password received from the mobile terminal A is detected. Furthermore, the information sent from the mobile terminal A to the server Y may be any kind of information as long as it is information that allows the server Y to authenticate user A. For example, the information may be an identifier of a mobile terminal stored in mobile terminal A or biological information of user A, which is read by the image reading means of the mobile terminal A.

When user A is confirmed by server Y, the sending and receiving means 141 of server Y sends the product URL stored in the selected product storage region 125 after step S1105, the ID of user A in Web service Y, user additional information of user A and a service identification tag which shows Web service Y to the server X 100 (step S1108). This means that the information of user A which becomes a delivery destination is correlated with the product sent by user A and sent to server X. At this time, while it is confirmed that the delivery sender is user A, the delivery destination is not confirmed. Furthermore, the user ID of user A sent to server X from server Y may be any ID as long as it can uniquely specify user A in the server Y. For example, in addition to the user table shown in FIG. 16, a further temporary ID column may be added, a temporary ID may be correlated with the ID 1611 of user A and stored and the temporary ID correlated with ID 1611 may be sent to the server Y instead of ID 1611. By adopting this process, it is possible to obtain the effects of the present invention without informing the provider of the sending process service X of the ID of user A in Web service Y.

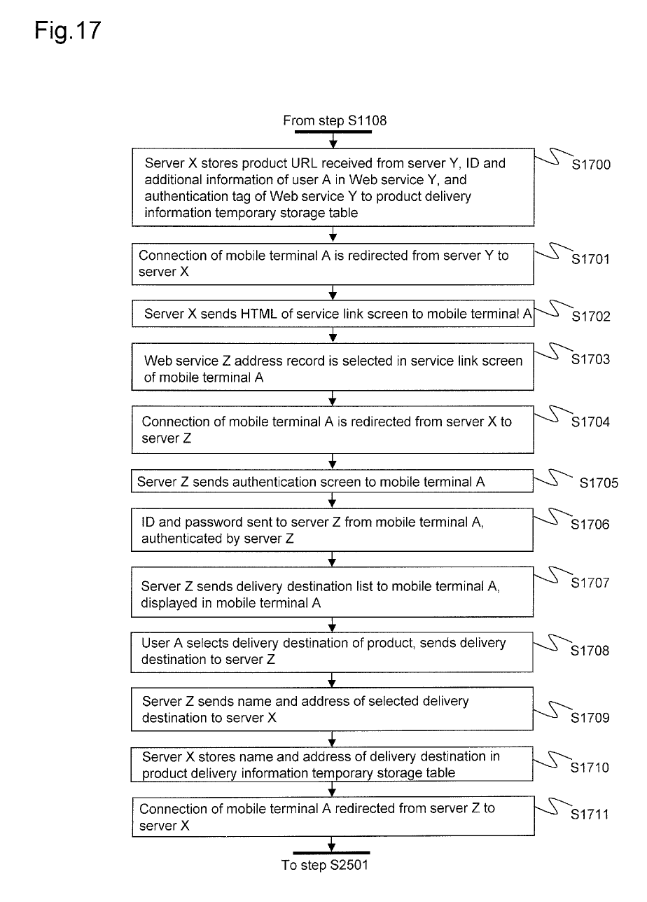

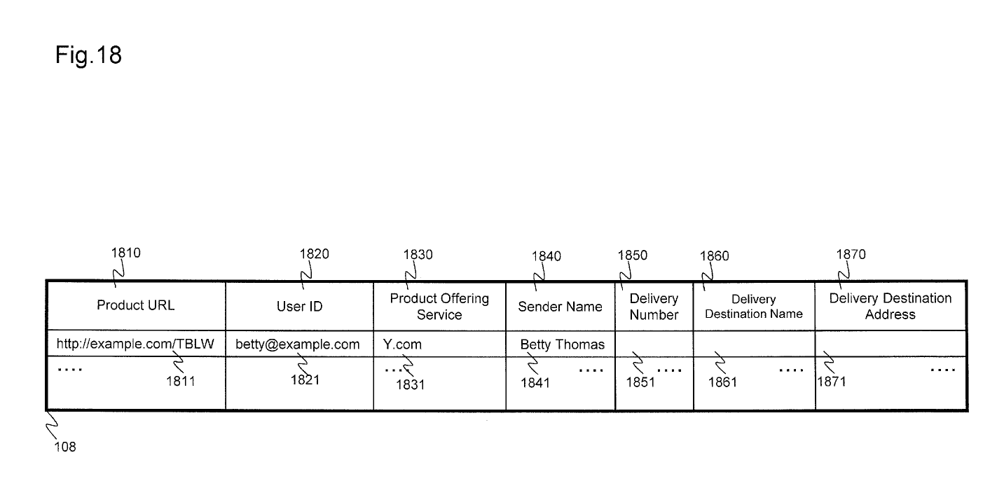

Next, a delivery process and service linking step in the server X are explained with reference to the flow diagram shown in FIG. 17. The product URL sent from server Y by the sending and receiving means 101 of server X in step 11108, the ID of user A in Web service Y, the user additional information of user A and a service identification tag which shows the Web service Y are stored in a product delivery information temporary storage table 108 (step S1700). An example of the product delivery information temporary storage table 108 is shown n FIG. 18. The product delivery information temporary storage table includes a product URL column 1810, a product offering service column 1820, a delivery sender name column 1830, a delivery number column 1840, a delivery destination column 1850, and a delivery destination address column 1861. The product delivery information temporary storage table may also include a delivery sender additional information and a delivery destination additional information column etc. In the example shown in FIG. 18, a row is added to the product delivery information temporary storage table 108 and a product URL 1811 received by the server Y in step S1700, the ID 1821 of user A in the Web service Z, a service identification tag 1831 of the Web service Y which is a product offering service, and a name 1841 which is additional information of the user A in the Web service Y which is the delivery sender are correlated and stored in the row. The delivery number 1851, the delivery destination name 1861, the delivery destination address 1871 in this row are empty until step S1710 is performed (or an empty value is stored for example).

Next, the connection of the mobile terminal is redirected to the server X from the server Y (step S1701). Next, the HTML generation means 102 of the server X generates an HTML code for displaying a service link screen and the sending and receiving means 101 sends the HTML code to the mobile terminal A via network 190. Next, the sending and receiving means 171 of the mobile terminal A receives the HTML code, and the display means 173 displays a service link screen after the analysis by the HTML analysis means 172 (step S1702)

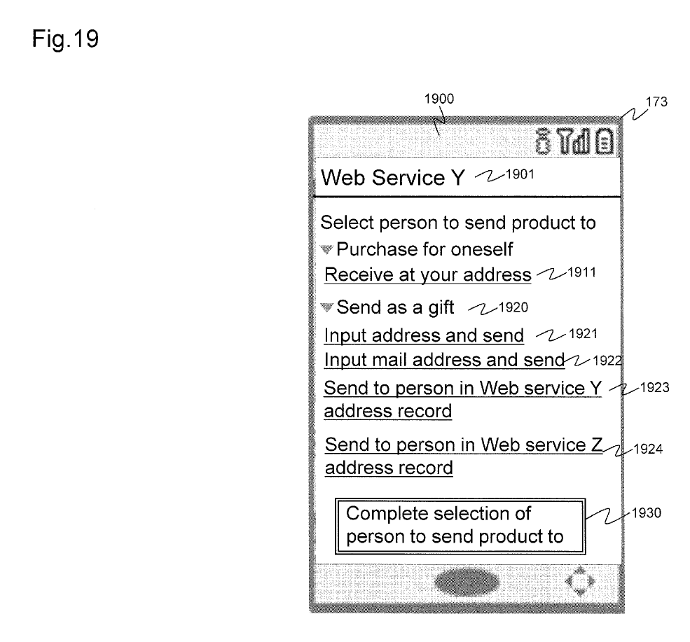

FIG. 19 shows an example of the service link screen 1900. In FIG. 19, the service link screen 1900 displayed in the display means of the mobile terminal A includes a display 1901 which indicates that this is the screen of the Web service Y. The service link screen 1900 is sent to the mobile terminal A by the server X. However, as is shown in FIG. 19, the display 1901 may be displayed as the service of Web service Y in the display means 173 of the mobile terminal A. Next, user A selects “send to a person at registered address in Web service Z” in the service link screen using the input means 174 (step 1703). Then, the sending and receiving means 171 sends a request to the server X for obtaining the delivery destination information stored by server 160 of Web service Z via a network.

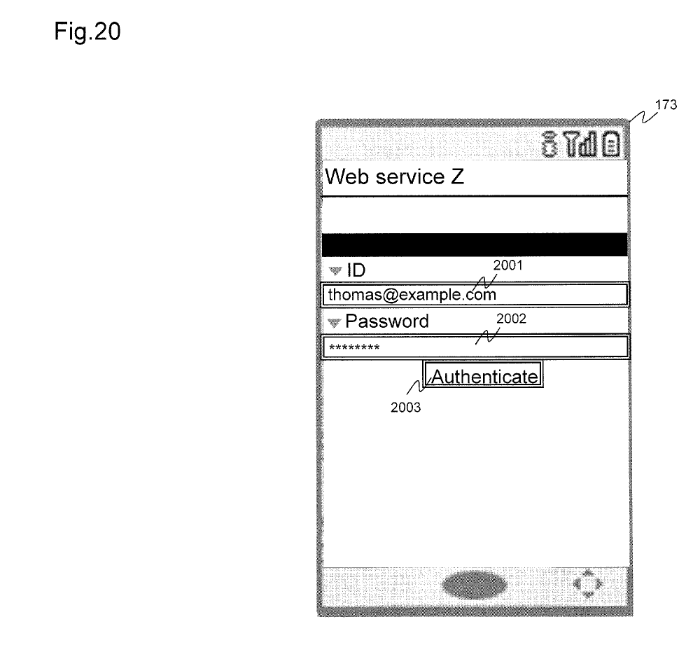

Next, the connection between the mobile terminal A and server X is redirected to the server Z (step S1704). The HTML generation means 162 of the server Z generates an HTML code for displaying a confirmation screen of Web service Z and the sending and receiving means 161 sends the HTML code to the mobile terminal A via network 190 (step S1705). The sending and receiving means 171 of the mobile terminal A receives the HTML code, and the display means 173 displays the confirmation screen of Web service Z after the analysis by the HTML analysis means 172. An example of the confirmation screen of Web service Z is shown in FIG. 20. In the present embodiment, it is assumed that user A is simultaneously a user of the Web service Y and a user of the Web service Z. User A selects the authentication button 2003 after inputting the ID in the Web service Z into the ID input space 2001 and the password in the Web service Z into the password input space 2002 using the input means 174. In the example shown in FIG. 20 “Thomas@example.com” is input as the ID and “abc12123” is input as the password. Then, the ID and password which are input are sent to the server 160 by the sending and receiving means 171 via the network 190.

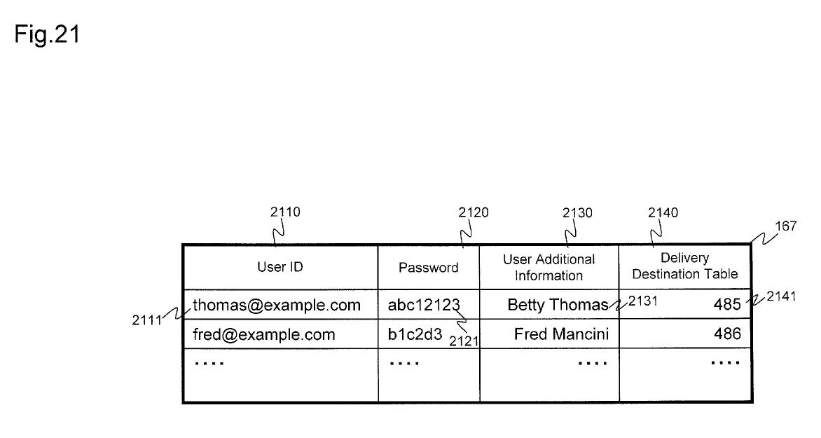

When the sending and receiving means 161 of server Z receives the ID and password, the user table 167 in the storage means is searches by the search means 168 using the ID, which is received, as a search key. As a result of this search, if the password which is correlated with the ID, which is received, and stored in the user table and the password, which is received, match, then authentication of the user is completed (step S1706). The example of the user table in Web service Z shown in FIG. 21 includes columns for a user ID 2110, a password 2120, additional information 2130, and a delivery destination table 2140. The user additional information may be a plurality of information and information such as the name and the address of a user. In the example shown in FIG. 21, user A is authenticated when a match between the password “abc12123” 2121 searched using “thomas@example.com”, which is received, as a search key, and the password received from the mobile terminal A is detected. Furthermore, the information sent from the mobile terminal A to the server Z may be any kind of information as long as it is information that allows the server Z to authenticate user A. For example, the information may be an identifier of a mobile terminal stored in mobile terminal A or biological information of user A, which is read by the image reading means of the mobile terminal A.

When user A is authenticated by server Z, the search means reads a delivery destination table correlated and stored with the user table 167 correlated with the ID of user A from the delivery destination group 166. In the example of the user table shown in FIG. 21, a delivery destination table number 2141 correlated with the ID 2111 of user A is read from the delivery destination table group 166 to a storage means.

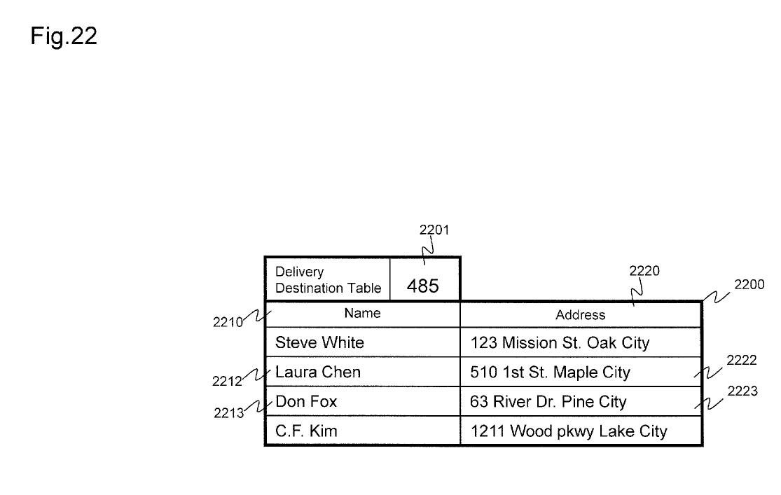

An example 2200 of a delivery destination table of the user A in Web service Z is shown in FIG. 22. The delivery destination table 2200 includes a delivery destination table number 2201. In addition, the delivery destination table 2200 includes a name column 2210 and an address column 2220. The table may also include a column for additional information related to a delivery destination. In the example shown in FIG. 22, the example 2200 of a delivery destination table includes four names and address information correlated with each name. The information of the delivery destination table which is obtained is sent to the mobile terminal A by the sending and receiving means 161 via the network 191 after being converted to an HTML code by the HTML generation means 162. In addition, the name and the address of user A may be registered as the delivery destination. When selecting the information of user A as delivery destination, it is possible to select receive at one's own home 1911 in the link screen 1900 displayed in the display means of the mobile terminal A in step S1703.

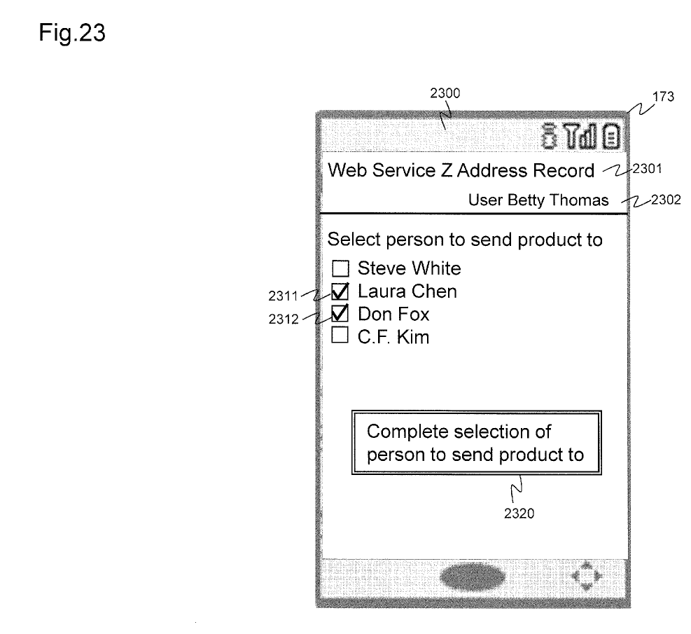

The sending and receiving means 171 in mobile terminal A receives the HTML code and a delivery destination list is displayed by the display means 173 after an analysis by the HTML analysis means 172 (step S1707). An example 2300 of a delivery destination list of Web service Z displayed in the display means 173 is shown in FIG. 23. The delivery destination list 2300 includes a display 2301 which shows that this is delivery destination information of the Web service Z, the name of the delivery destination in the delivery destination table 2200 of user A and a checkbox correlated with each name. A display correlated with each name does not have to be a checkbox but may be any type of display which shows that each name is selected.

Next, user A selects the delivery destination of a product confirmed by user A in step S1105 using the input means 174. In the example shown in FIG. 23, the checkbox of Laura Chen 2311 and the checkbox of Don Fox 2312 are selected from among the delivery destinations in the delivery destination table shown in FIG. 22. This corresponds to an input to the mobile terminal A which says that Betty Thomas, who is user A, sends a product selected in step S1105 to Laura Don and Don Fox. Next, the sending and receiving means 171 sends the selected delivery destination to the server Z via network 190 (step S1708).

When the sending and receiving means 161 of server Z receives the selected delivery destination, the search means searches addresses of the selected delivery destination in step S1708 from the delivery destination table 2200. Then, the sending and receiving means 161 sends the name and address of the delivery destination selected in step S1708 to the server X via network 190 (step S1709). Here, the delivery destination table may also include any additional information related to a delivery destination in addition to the column exemplified in FIG. 22. In this case, server Z may also send additional information in addition to the name and address of the delivery destination selected in step S1709 to the server X.

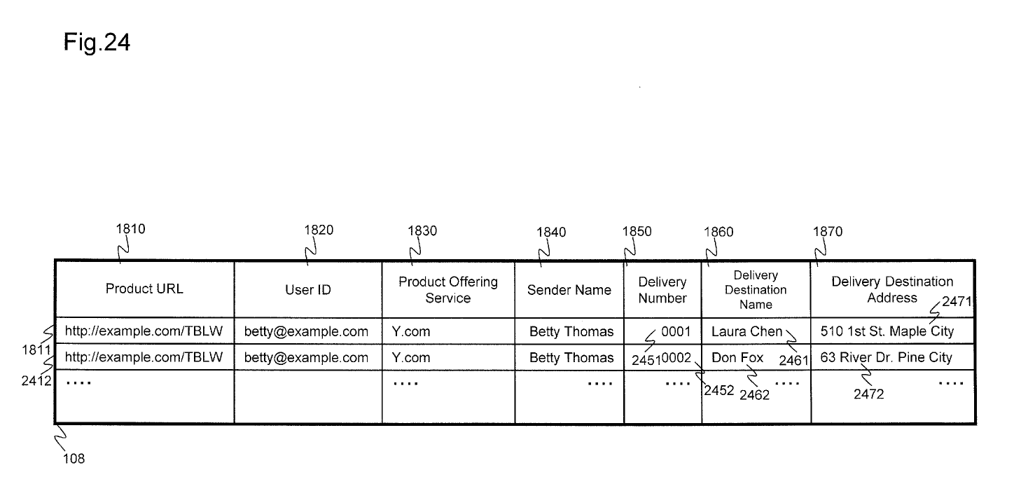

Next, the sending and receiving means 101 of server X receives the name and the address of the delivery destination selected in step S1708 and these are correlated with the product URL stored in step 1700 and stored in the product delivery information temporary storage table 108 (step S1710). An example of the product delivery information temporary storage table 108 after step S1710 is performed is shown in FIG. 24. Because the delivery destination received from server X in step S1710 contains two names, two rows are added to the product delivery information temporary storage table and the product URL stored in step S1700, the user ID of user A in Web service Y, an identification tag of Web service Y which is a product offering service, and the name of user A which is the delivery sender are copied to this row 2412. Furthermore, a delivery number generated by the delivery number generation means 111 is provided to the row 1811 and row 2421. In addition, the name and the address of the delivery destination received from the server Y are each stored in column 1860 and 1870 respectively.

In the example shown in FIG. 24, the name Laura Chen 2461 and her address 2471 correlated with the delivery number 0001 and the name Don Fox 2462 and his address 2472 correlated with the delivery number 0002 are stored. Next, the connection of mobile terminal A to server Z is redirected to server X (step S1711).

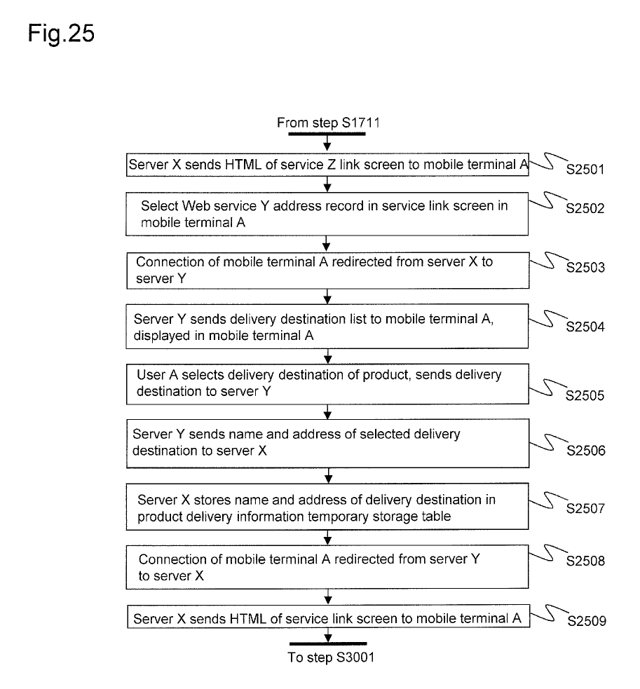

A process whereby a delivery destination of a product selected by user A is selected from a delivery destination list of Web service Y is explained using the flow diagram shown in FIG. 25. Next, the HTML generation means 102 of server X generates an HTML code for displaying a service link screen and the sending and receiving means 101 sends the HTML code to the mobile terminal A via a network. Next, the sending and receiving means 171 of mobile terminal A receives the HTML code and the display means 173 displays a link screen after the analysis by the HTML analysis means 172 (step S2501). The service link screen 1900 shown as an example in FIG. 19 is again displayed in the display means 173. Next, when user A selects “send to person of Web service Y delivery destination information” in the service link screen using the input means 174 (step S2502), the sending and receiving means 171 sends a request to the server X for obtaining the delivery destination information stored by server 140 of Web service Y via a network. Next, the connection of mobile terminal A with server X is redirected to server Y (step S2503).

In the process shown in FIG. 17, in the case where delivery to a delivery destination of the delivery destination information stored in the Web service is requested, the process is performed via an authentication process of user A by server Z. On the other hand, in the present embodiment, user A has already received authentication by server Y via the information terminal A in step S1107. As a result, the authentication process by server Y is not required. However, in the case where user has not received authentication from server Y at this time, it is necessary to perform step S1705 and an authentication process by server Y corresponding to step S1705.

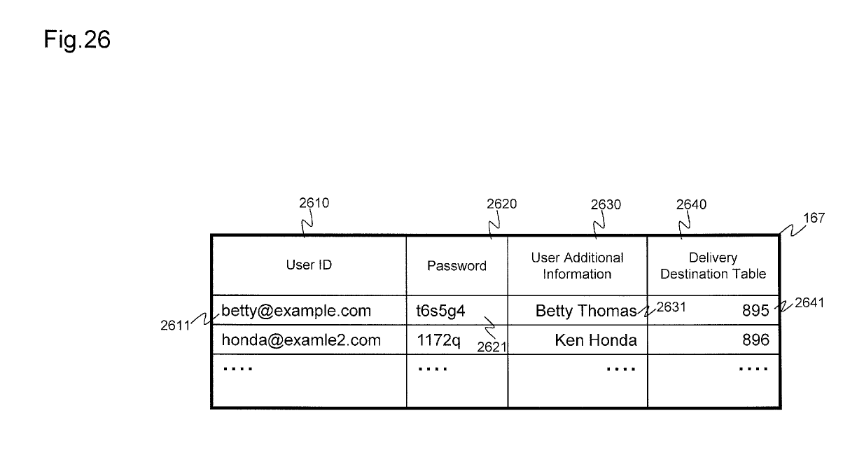

Next, a search means of server Y reads a delivery destination table correlated and stored with the user table 147 correlated with the ID of user A from the delivery destination table group 146. In the example of a user table shown in FIG. 26, the delivery destination table number 2641 correlated with the ID 2611 of user A is read from the delivery destination table group 146 by a storage means.

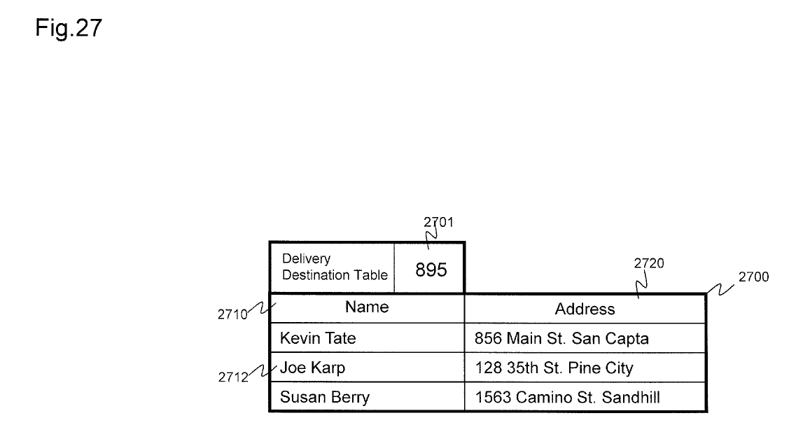

An example 2700 of a delivery destination table of user A in Web service Z is shown in FIG. 27. The delivery destination table 2700 includes a delivery destination table number 2701. In addition, the delivery destination table 2700 includes a name column 2710 and an address column 2720. The table may also include a column for additional information related to a delivery destination. In the example shown in FIG. 27, the example 2700 of a delivery destination table includes three names and address information correlated with each name. The information of the delivery destination table which is read is sent to the mobile terminal A by the sending and receiving means 141 via the network 191 after being converted to an HTML code by the HTML generation means 142. Here, the name and the address of user A may be included in the delivery destination information included in the HTML code. When selecting the information of user A as delivery destination, it is possible to select “receive at one's own home” 1911 in the link screen 1900 displayed in the display means of the mobile terminal A in step S2502.

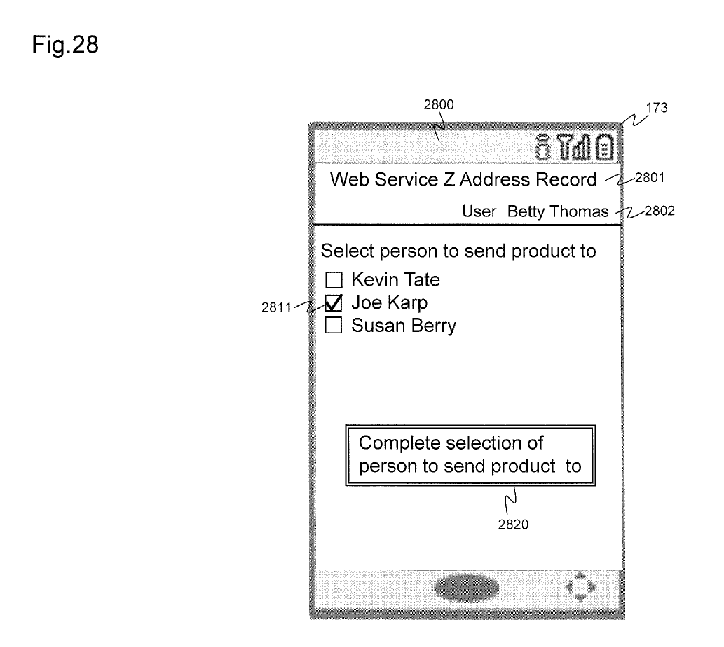

The sending and receiving means 171 in mobile terminal A receives the HTML code and a delivery destination list is displayed by the display means 173 after an analysis by the HTML analysis means 172 (step S2504). An example 2800 of a delivery destination list of Web service Y displayed in the display means 173 is shown in FIG. 28. In FIG. 28, the delivery destination list 2800 includes a display 2801 which shows that this is delivery destination information of the Web service Y, the name of the delivery destination in the delivery destination table 2800 of user A and a checkbox correlated with each name. A display correlated with each name does not have to be a checkbox but may be any type of display which shows that each name is selected.

Next, user A selects the delivery destination of a product selected by a confirmation button etc. by user A in step S1105 using the input means 174. In the example shown in FIG. 28, the checkbox Joe Karp 2811 is selected from among the delivery destinations in the delivery destination table shown 2700 shown in FIG. 27. This corresponds to an input to the mobile terminal A which indicates that Betty Thomas, who is user A, sends a product selected in step S1105 to Joe Karp. When user A selects a button 2820 for completing selection of a person for sending a product using the input means 174, the sending and receiving means 171 sends the selected delivery destination to the server Y via network 190 (step S2505).

When the sending and receiving means 141 of server Y receives the selected delivery destination, the search means searches addresses of the selected delivery destination in step S2505 from the delivery destination table 2700. Then, the sending and receiving means 141 sends the name and the address included in the delivery information destination selected in step S2505 to the server X via network 190 (step S2506). Here, the delivery destination table may also include any additional information related to a delivery destination in addition to the column exemplified in FIG. 27. In this case, server Z may also send additional information in addition to the name and the address included in the delivery destination information selected in step S2505 to the server X.

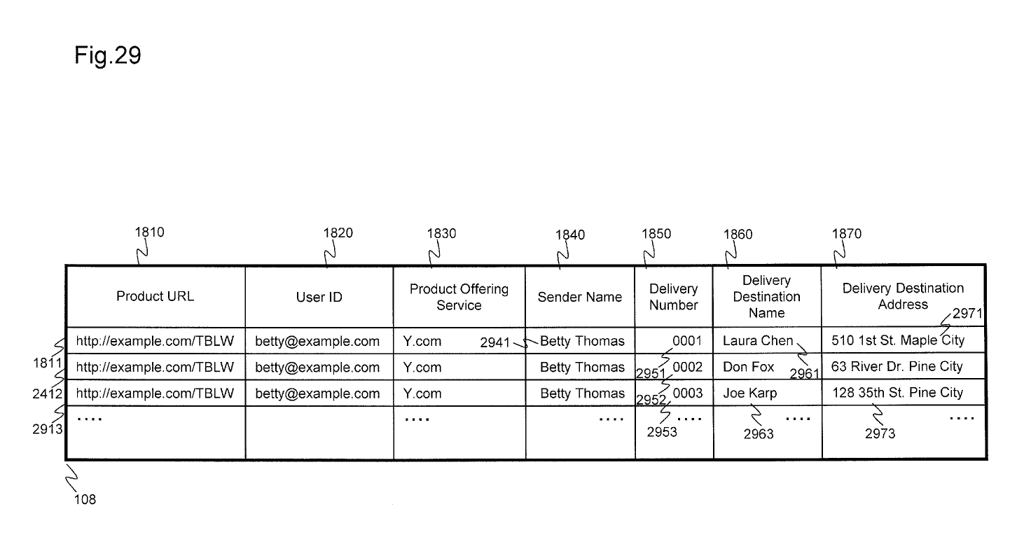

Next, the sending and receiving means 101 of the server X receives the name and the address included in the delivery information selected in step S2505 and these are correlated with the product URL stored in step 1700 and stored in the product delivery information temporary storage table 108 (step S2507). An example of the product delivery information temporary storage table 108 after step S2507 is performed is shown in FIG. 29. Because the delivery destination received from server X in step S2507 contains one name, a row 2913 is added to the product delivery information temporary storage table and the product URL stored in step S1700, the user ID of user A in Web service Y, an identification tag of Web service Y which is a product offering service, and the name of user A which is the delivery sender are copied to this row 2913. Furthermore, a delivery number 2953 generated by the delivery number generation means 111 is provided to the row 2913. In addition, the name and the address of the delivery destination received from the server Y are each stored in columns 1860 and 1870 respectively. In the example in FIG. 29, the name Joe Karp 2963 and the address 2973 correlated with the delivery number 0003 are each stored. Next, the connection of mobile terminal A with server Y is redirected to server X (step S2508).

Next, the HTML generation means 102 of server X generates an HTML code for displaying a service link screen and the sending and receiving means 101 sends the HTML code to the mobile terminal A 170 via a network. Next, the sending and receiving means 171 of mobile terminal A receives the HTML code and the display means 173 displays a link screen after the analysis by the HTML analysis means 172 (step S2509). The service link screen 1900 shown as an example in FIG. 19 is again displayed in the display means 173.

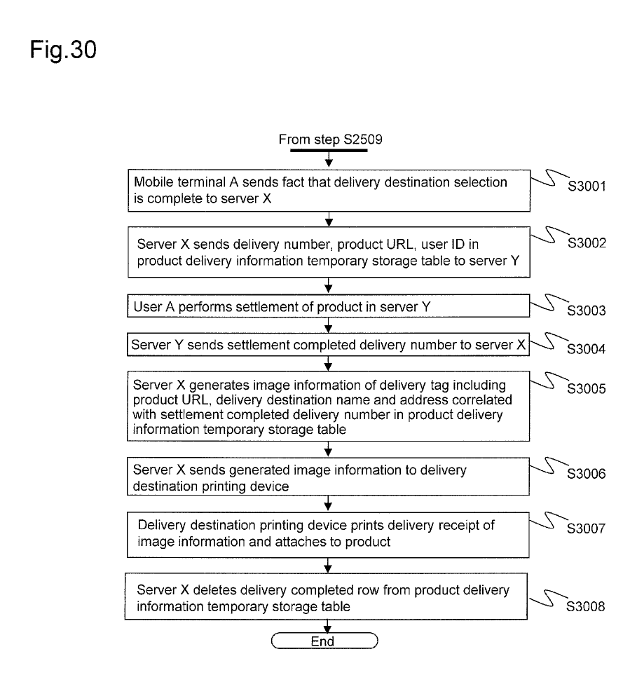

A process up to delivery if a selected product to a delivery destination is explained using the flow diagram shown in FIG. 30. User A selects the button “complete selection of person for sending a product” 1930 in the service link screen using the input means 174. The sending and receiving means 171 sends Information which indicates that selection of a delivery destination is complete to the server X via network 190 (step S3001). When the sending and receiving means 101 of server X receives this information, information in the product URL, user ID and delivery number columns correlated each delivery number is sent to the server Y from the product delivery information temporary storage table 108 to the server Y via network 190 (step S3002). In the example shown in FIG. 29, http://example.com/TBLW, which is a product URL, and betty@example.com, which is a user ID correlated with the delivery numbers 2951, 2952, and 2953, are sent to the server Y. Furthermore, this information is for purchasing of a product to be sent by user A in Web service Y. As a result, the information sent to server Y by server X in step S3002 may be any type of information as long as it allows user A to perform a payment process in server Y. For example, only the product URL, the number of products and total value may be calculated and sent to the server Y from the product delivery information temporary storage table 108.

When the sending and receiving means 141 of the server Y receives the information sent from the server X in step S3002, a purchase settlement process of a product sent by user A is performed (step S3003). This settlement may be performed using information stored within the server Y, using information obtained by a settlement means in server Y via communication with the mobile terminal A or using information obtained via a network from a different server which includes the settlement information. When settlement is completed, the sending and receiving means 141 in server Y sends a delivery number and information that settlement is complete to the server X via network 190 (step S3004). In the present embodiment, delivery numbers 0001, 0002 and 0003 are sent to the server X.

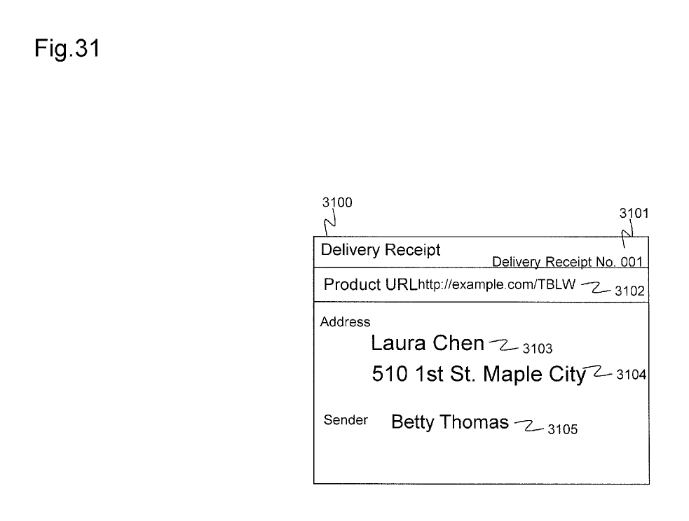

When the sending and receiving means 101 of the server X receives the delivery numbers, the search means 110 searches the product delivery information temporary storage table using a product number for which settlement is completed as a search key and a delivery name and address correlated with the delivery number, which is received, are obtained. Next, the printing information generation means 112 generates image data of a delivery receipt which includes the product URL, the delivery destination name, the delivery destination address, and the delivery sender name correlated with each of the product numbers 2951, 2952, and 2953 in FIG. 29 (step S3005). An example of an image of the delivery receipt generated from the delivery number 2951 in FIG. 29 is shown in FIG. 31. An image 3100 of a delivery receipt includes the delivery number 3101, the product URL 3102, the delivery destination name 3103, the delivery destination address 3104, and the delivery sender name 3105. These are generated based on the information in the delivery number 2951, the product URL 1811, the delivery destination name 2961, the delivery destination address 2971, and the delivery sender name 2941 shown in each of the diagrams in FIG. 29. Similarly, image data of a delivery receipt is generated with respect to the delivery number 2952 and the delivery number 2953 rows in FIG. 29. The server X receives some additional information related to the delivery destination in step S1709 and S2506 and image data which includes additional information may be generated if this information is stored in the product delivery information temporary storage table.

Next, the sending and receiving means 101 sends a generated image data group to the delivery destination printing device 120 via the network 190 (step S3006). The sending and receiving means 121 of the delivery destination printing device receives this group and a printing means 122 prints the data. The delivery destination printing device 120 is arranged at a place for delivering a product sold on the Web service Y and a printed delivery receipt is attached to each corresponding product and delivered (step S3007). After printing, a printing completion record is deleted from the product delivery information temporary storage table 108 in server X. in the present embodiment, the row of each delivery number 2951, 2952, and 2953 in FIG. 29 is deleted (step S3008). It is preferred that this information is never stored as a searchable database in a non-volatile storage means such as a hard disk or a flash memory in server X.

The delivery destination name 2961 and the delivery destination address 2971 corresponding to the delivery number 2951 in FIG. 29 are not stored in the server of Web service Y. These are stored in the delivery destination table 2200 of the server of the Web service Z and the provider of Web service Z does not want to pass these to the Web service Y as a database. In the present embodiment, after image data of a delivery receipt is generated in the temporary storage means 106 in the Web service X, the image data is sent to the product delivery section of Web service Y and printed. As a result, according to the method of the present embodiment, the provider of Web service Y does not need to input a delivery destination name and a delivery destination address, which are stored in the Web service Z, as a searchable database.

In the explanation above, the server Z sends a delivery destination list to the mobile terminal A in steps S1707 to S1709, and the mobile terminal A sends a name and an address included in the selected delivery destination information to the server X. That is, the HTML code in FIG. 23 is generated by the HTML generation means 162 in server Z. In this case, a name and address included in the delivery destination information selected in step S1708 are temporarily stored in the temporary storage means of server X. In another embodiment of the present invention, information in the delivery destination table 2200 is sent not to the mobile terminal but to the server X, and after HTML corresponding to FIG. 23 is generated by the HTML generation means 102 in server X, the HTML may be sent to the mobile terminal A. In this case, all the delivery destination information of user A stored in server Z is stored in the temporary storage means 106 in server X. In either case, it is preferred that the delivery destination information stored in server Z is stored in the temporary storage means of server X, is not saved as a searchable database and is deleted from the temporary storage means 106 in step S3008. In steps S2504 to S2506 in which the delivery destination list of user A stored in server Y is selected, a screen corresponding to FIG. 28 may be similarly generated and sent to the mobile terminal A or copied to the temporary storage means of server X from server Y, generated by server X and sent to the mobile terminal A.

Next, the effects of the present embodiment are explained. The first effect of the present embodiment is that it is possible to reduce the number of steps that should be performed from selecting a product to requesting delivery compared to a Web service which aims to sell goods or a printed item using a conventional method. After purchasing goods in a conventional Web service, a step for selecting a product from a plurality of products and a step of inputting delivery destination information for sending the selected product are required for requesting delivery. A mobile terminal has a small display capacity and it is difficult for an input means to perform multiple steps compared to a standing type terminal. According to the present embodiment, a user can select a product and request its delivery by a simple input process of reading an image code, obtaining a delivery destination list and selecting a delivery destination from the delivery destination list. This is an effect of the present embodiment whereby product selection is performed using an image code and a delivery destination information can be used as delivery destination information in a plurality of Web services used by a user.

A second effect of the present embodiment is that it is possible for a user to use different delivery destination information stored in servers in a plurality of Web services. According to a conventional system or method, when a user of a certain Web service purchases goods or printed item and requests delivery, it is possible to omit input of delivery destination information by reusing the delivery destination information stored in advance in the server of this service. However, the delivery destination information stored by the server of another Web service cannot be used. For example, according to a conventional method, user A, who uses Web service Y, uses the delivery destination information stored in the delivery destination table 2700 using the mobile terminal A shown in FIG. 27, and input of the delivery destination name and the address to the mobile terminal A can be omitted. However, according to a conventional method, when user requests delivery of a product or printed item in Web service Y, the same user A cannot omit inputting the name and address of the delivery destination using the delivery destination information in FIG. 22 stored in the server of Web service Z. As a result, it is necessary for user A to input the name and the address of the delivery destination to the mobile terminal A.

However, according to the present embodiment, user A can request delivery of a product or a printed item in Web service Y using the delivery destination information stored in the server of Web service Z. Similarly, in this case it is possible to obtain the effect of simplifying an input operation for the user A of product selection information and delivery destination information as explained above.

The first and second effects are effects of the present invention which are useful for a user. The third to seventh effects of the present embodiment explained below are useful for a provider of a Web service.

A third effect of the present embodiment is that it is possible for a certain Web service to increase sales of a product or a printed item by using delivery destination information in another Web service. According to the present embodiment, simplifying input to a mobile terminal explained in the first and second effect increases the proportion of products or printed items sold and the number of users with respect to the total number of people browsing a Web service. Generally, it is not the case that all the people who browse a Web service perform all of the steps up to purchasing a product or printed item. The greater the number of steps up to purchasing a product or a printed item the greater is the rate at which users will leave a Web service, As a result, a decrease in the number of steps up to purchasing a product or printed item using the present embodiment helps to increase sales.

For example, according to a conventional method or system, in the case where user A requests delivery of a product or a postal item sold on Web service Y to Laura Chen and Don Fox, it is necessary to input the names and the addresses of both Laura Chen and Don Fox as a destination list. However, in the present embodiment, after a product is selected using an image code (step S1105), it is possible to request delivery of a selected product by an operation for selecting Laura Chen 2311 and Don Fox 2312 (step S1708) from the delivery destination table 2200 stored in server Z and displayed in the display means 173 in the mobile terminal A. This result decreases the number of input steps and the rate at which a person leaves a Web service compared to a conventional method or system and therefore increases sales in the Web service Y. Furthermore, it is also possible for the Web service Y to maintain a competitive position with respect to a different Web service when user A can reduce the number of input steps to a mobile terminal.

A fourth effect of the present embodiment is that it is possible for a certain Web service to deliver a product or a printed item without inputting personal information such as a name and an address and without the risk of information leaks by using the delivery destination information of another Web service. For example, according to a conventional method or system, it is necessary for server Y to receive delivery information stored in server Z and store it in the storage means of server Y in order to send a product or a printed item in the Web service Y using the delivery destination information stored in server Z. Therefore, Web service Y becomes responsible in the case where delivery information held by Web service Z and stored in the server Y is leaked. However, in the present embodiment, delivery destination information stored in server Z is never sent to server Y. The delivery destination information stored in server Z is temporarily stored in the product delivery information temporary storage table 108 in the temporary storage means of server X (step S1710). When a delivery process of a product is completed, it is possible to delete the information from the product delivery information temporary storage stable (step S3008).

In this way, according to the method and system of the present embodiment, it is not necessary for Web service Y to input personal information when a product or printed item sold in Web service Y is sent using delivery destination information held by Web service Z and as a result there is no risk of information leaks.

A fifth effect of the present embodiment is that it is possible for a certain Web service to use delivery destination information stored in its server to sell a product or a printed item of another Web service. For example, in the present embodiment, user A uses delivery information stored in server Z when requesting delivery of a product or a printed item sold in Web service Y. As a result, the provider of Web service Y obtains the third and fourth effects explained above. Therefore, the provider of Web service Z can obtain compensation from the provider of Web service Y due to the third and the fourth effects explained above. For example, in the case where sales of a product or a printed item increase due to the third and the fourth effects in Web service Y, the provider of Web service Y may pay an affiliate fee to the provider of Web service Z as this compensation. Alternatively, there is also a method for mutual use by Web service Z and server Y of delivery destination information of user A stored in server Y

A sixth effect of the present embodiment is that it is possible for a provider of a certain Web service to selectively use delivery destination information stored in its server only in respect to a specified different Web service. For example, when the Web service Y is a Web service that sells books and the Web service Z is a Web service that sells Christmas cards, it is possible for the provider of Web service Z to obtain the fifth effect described above when user A uses delivery destination information of a Christmas card stored in server Z.

However, in the case where the Web service Z and the Web service Y are both Web services that sell books and are in a competitive relationship, the provider of Web service Z may not want the delivery destination information of user A stored in server Z to be used by Web service Y. In the present embodiment, it is possible for a user to send a product sold by Web service Y using the delivery destination information stored in server Z only when the provider of Web service Z makes a setting to allow use of the delivery destination information stored in server Z via Web service Y using the management terminal 185 (step S803). That is, according to the method or system related to the present embodiment, it is possible for a provider of a certain Web service to select only a different Web service which can obtain a profit from a linking service and allow use of the delivery destination information stored in a server of that Web service.

A seventh effect of the present embodiment is that an incentive is produced for a large number of Web services to link with other as a result of combining the first to the sixth effects described above. In the present embodiment, the Web service Z uses delivery destination information stored in the server of Web service Z via the Web service Y. In this way it is possible for the provider of the Web service Y and the provider of the Web service Z to obtain the effects of the present embodiment. The effect of this type of mutually befitting linking increases the more the number of Web services which link with each other using the present embodiment increases. For example, suppose Web service Y sells books, Web service Z sells Christmas cards, and Web service W sells flowers. According to the present embodiment, not only is it possible to easily request delivery of a book to the delivery destination requested by user A for delivering a Christmas card but also requesting delivery of flowers to the delivery destination requested by user A for delivering a book. At this time, the first to the fifth effects described above are increased when the delivery destination information of user A stored in the servers of each Web service Y, Z and W is mutually used compared to the case where the two Web services, Web service Y and Web service Z are linked by the method or system related to the present embodiment. That is, the effects become greater the greater the number of Web services that link with each user based on the present embodiment, and as a result, the number of linking Web service increases. This is one of the greatest effects of the present embodiment. As explained in the description of the fifth effect above, in the case where a method for controlling use of delivery destination information is not provided to a Web service which loses profits, the advantage of mutual use of delivery destination information and shared profits for competing Web service is cancelled out as in a conventional method or system. As a result, in a conventional method or system, the seventh effect of the present embodiment is not demonstrated and mutual use of delivery destination information between Web services is not promoted. The present embodiment contributes to solving this problem.

### Second and Third Embodiments

A second and a third embodiments of the present are explained below. Furthermore, the second and the third embodiments can also be combined with the first embodiment of the present invention,

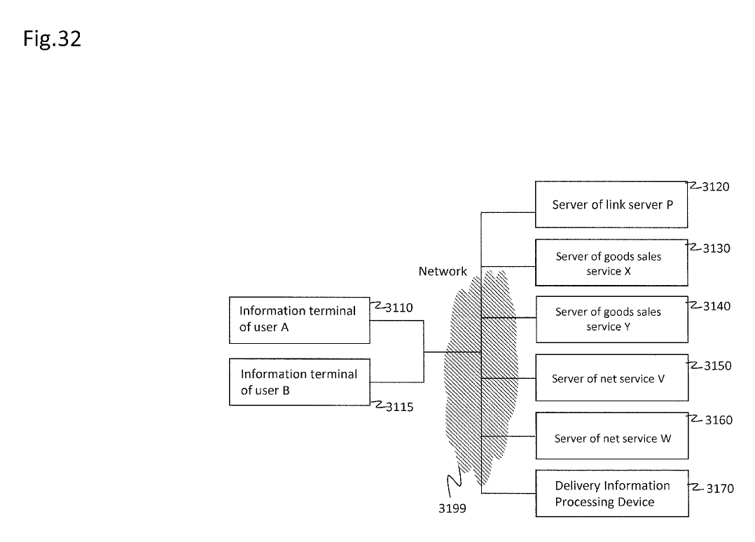

FIG. 32 is an approximate structural diagram of a goods sales system as one example of the present invention. The goods sales system as one example of the present invention is arranged with an information terminal 3110 of user A, an information terminal 3115 of user B, a server 3120 of a link service P, a server 3130 of a goods sales service X, a server 3140 of a goods sales service Y, a server 3150 of a network service V, a server 3160 of a network service W and a delivery information processing device 3170. These information terminals and servers are connected via a network 3199.

Furthermore, in the present specification and attached drawings, the server of the link service P may be abbreviated to server P, the server of the goods sales service X to server X, the server of the goods sales service Y to server Y, the server of a the network service V to server V, the server of the network service W to server W, the information terminal of user A to terminal A and the information terminal of user B to user B. In addition, the network service may be any service as long as it is a service which includes a user ID which can uniquely specify a particular user.

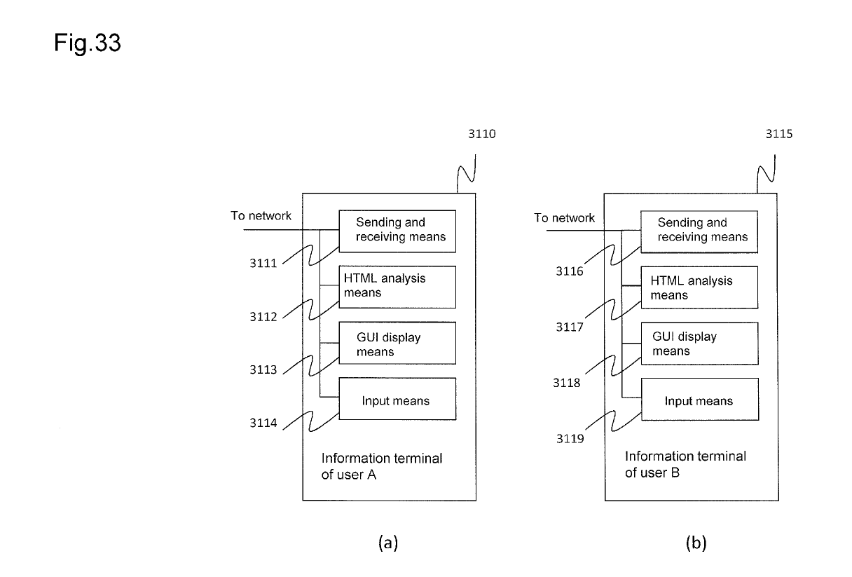

FIG. 33 shows an exemplary structure of the information terminal 3110 of user A and the information terminal 3115 of user B. The information terminal 3110 of user A includes a sending and receiving means 3111, an HTML analysis means 3112, a GUI display means 3113, and an input means 3114. The information terminal 3115 of user B includes a sending and receiving means 3116, an HTML analysis means 3117, a GUI display means 3118, and an input means 3119.

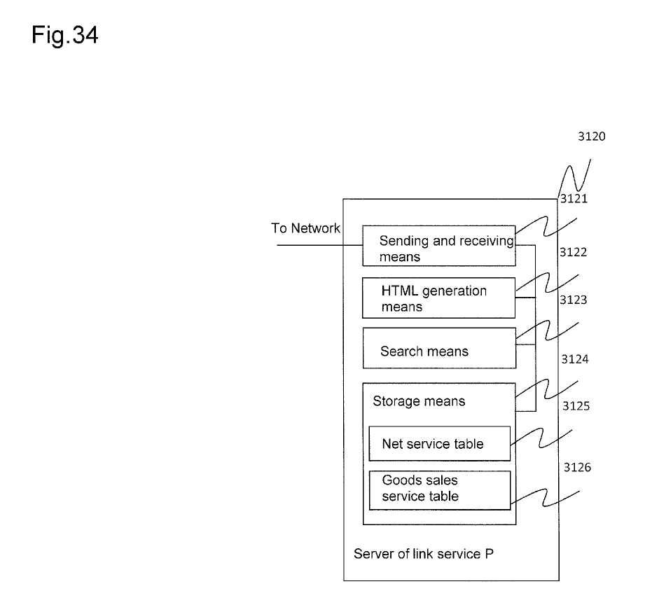

FIG. 34 shows an exemplary structure of the server 3120 of the link service P. The server 3120 of the link service P includes a sending and receiving means 3121, an HTML generation means 3122, a search means 3123, and a storage means 3124. In addition, the storage means 3124 includes a network service table 3125 and a goods sales service table 3126.

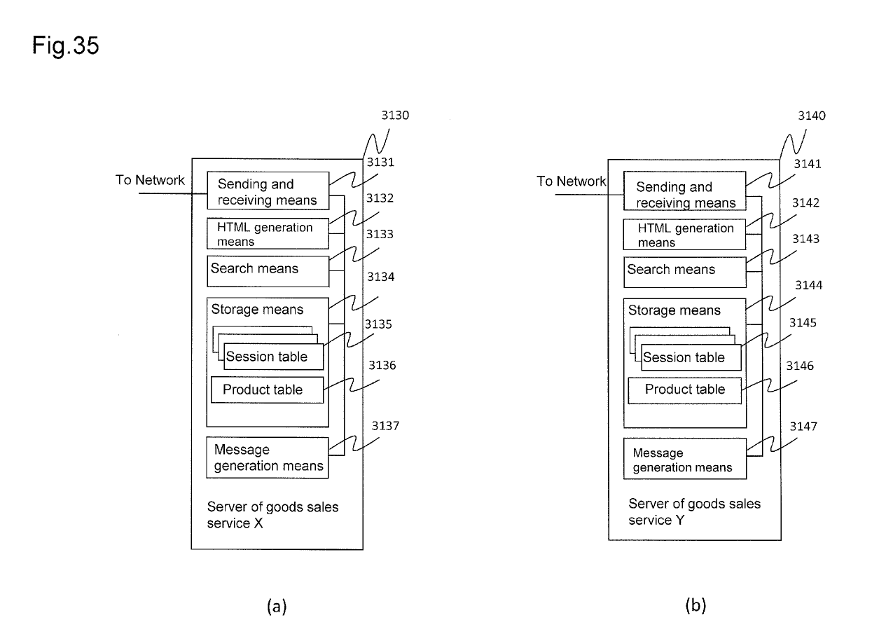

FIG. 35 shows an exemplary structure of the server 3130 of the goods sales service X and the server 3140 of the goods sales service Y. The server 3130 of the goods sales service X includes a sending and receiving means 3131, an HTML generation means 3132, a search means 3133, a storage means 3134, and a message generation means 3127. In addition, the storage means 3134 includes a session table group 3135 and a product table 3136. The server 3140 of the goods sales service Y includes a sending and receiving means 3141, an HTML generation means 3142, a search means 3143, a storage means 3144 and a message generation means 3147. In addition, the storage means 3144 includes a session table group 3145 and a product table 3146.

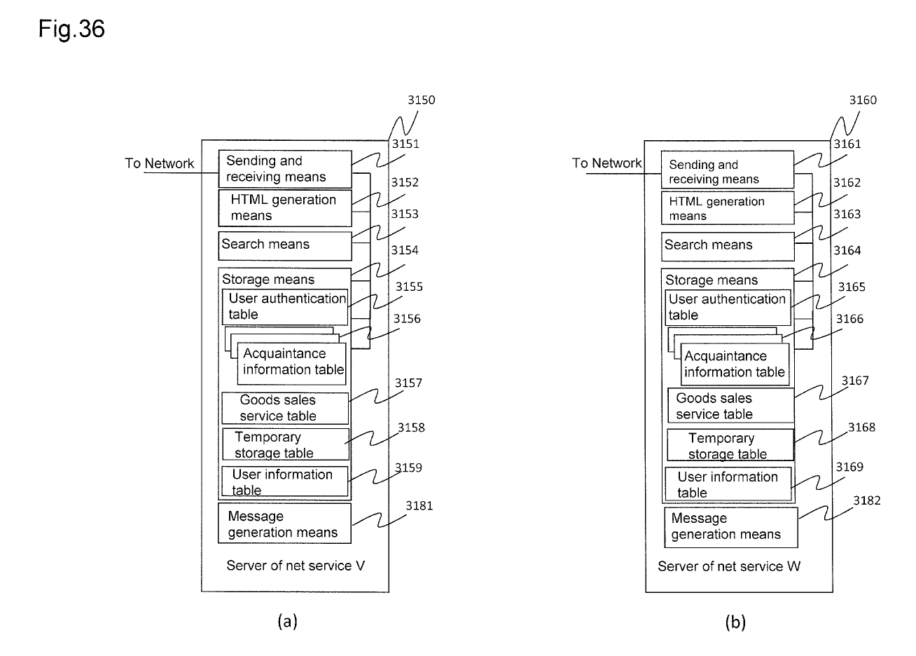

FIG. 36 shows an exemplary structure of the server 3150 of the network service V and the server 3160 of the network service W. The server 3150 of the network service V includes a sending and receiving means 3151, an HTML generation means 3152, a search means 3153, a storage means 3154, and a message generation means 3182. In addition, the storage means 3154 includes a user authentication table 3155. An acquaintance information table group 3156, a goods sales service table 3157, a temporary storage table 3158 and a user information table 3159. The server 3160 of the network service W includes a sending and receiving means 3161, an HTML generation means 3162, a search means 3163, a storage means 3164, and a message generation means 3182. In addition, the storage means 3164 includes a user authentication table 3165. An acquaintance information table group 3166, a goods sales service table 3167, a temporary storage table 3168 and a user information table 3169.

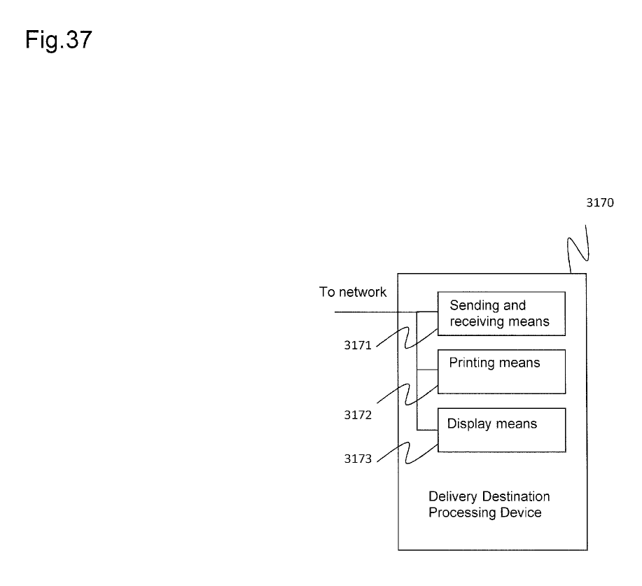

FIG. 37 shows an exemplary structure of a delivery information processing device 3170. The delivery information processing device 3170 includes a sending and receiving means 3171, a printing means 3172, and a display means 3173.

### Second Embodiment

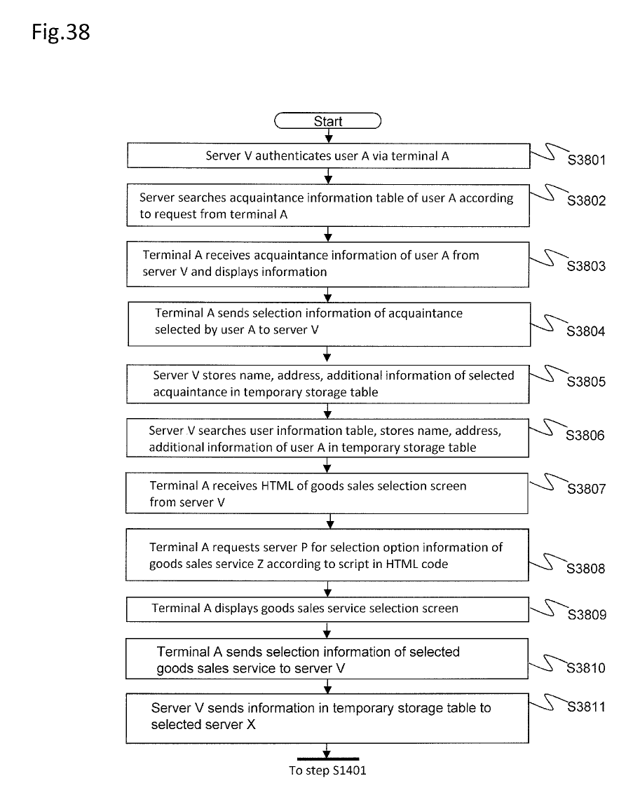

The linking process of a network service and a goods sales service related to an embodiment of the present invention is explained with reference to the flow diagram show in FIG. 38. It is assumed that user A is a user of the network service V. User A inputs authentication information in the network service V of user A via the input means 3114 while the terminal 3110 is connected to the server V 3150 via the network 3199. Below, as an example, it is possible to use a combination of an ID and password information of user A in the network service V as authentication information. However, authentication information is not limited to an ID and password information and can be any information as long as it can uniquely specify user A among a user group of the network service V such as biological authentication information. In addition, the network service V can be any type of service as long as it includes a means which can uniquely specify a user A among its users. In addition, the service V may be any type of service such as a search service, message printing service, advertisement service, SNS (social Networking Service), blog service, game, chat service, or electronic mail service. Also, the network service may be a goods sales service which includes a means for identifying a user.

Next, the sending and receiving means 3111 sends input authentication information of user A to the server 3150 via the network 3199. When the sending and receiving means 3161 receives the authentication information of user A, the search means 3153 searches the user authentication table 3153 in the storage means 3154. The user A is authenticated in server V with a match between a combination of the user ID and password received by the sending and receiving means 3153 and the user ID and password stored in advance in the user authentication table 3155 (step S3801). Here, as an example, the user authentication table 3155 is explained assuming that it includes a user ID column and a password column. However, the user authentication table 3155 is not limited to a table which includes a user ID column and a password column. The user authentication table 3155 may be any type of table as long as it stores the authentication information received by the sending and receiving means 3151 which is information that can authenticate the user A

Next, the sending and receiving means 3111 sends an acquaintance information display screen request to server V via the network 3199. Here, the acquaintance information display screen called by the information terminal A may be any type of screen as long as it displays the acquaintances of user A and information correlated with these acquaintances such as delivery destination information in a goods sales service, a friend list in a SNS service, or address destination information in a message printing service. In the server V, when the sending and receiving means 3151 receives this request, the search means 3153 searches the acquaintance information table group 3156 using the user ID of user A as a search key and acquaintance information of user A is obtained (step S3802).

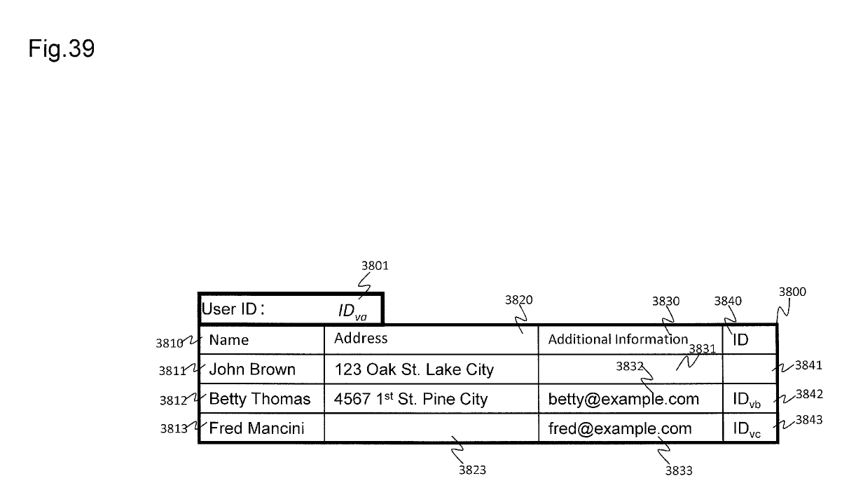

An example of one acquaintance information table 3800 of user A is shown in FIG. 39. An acquaintance information table includes a user ID field 3801 and can be searched by a search means using a user ID as search key. In addition, an acquaintance information table stores information, which is correlated with the user ID 3801, of the acquaintances of user who has a user ID. In the example shown in FIG. 39, the user table 3800 includes a name column 3810, an address column 3820, an additional information table 3830, and a user ID column 3840 of the network service V. In the example shown in FIG. 39, an electronic mail address which includes an acquaintance is storied as additional information. However, the additional information can be any information belonging to an acquaintance. In addition, the table can include any number of columns, that is, any amount of attribute information of an acquaintance of user A.

In the example shown in FIG. 39, three people, “John Brown” 3811, “Betty Thomas” 3812 and “Fred Mancini” 3183 are stored as acquaintances of user A. It is not necessary to store all the information in the columns with respect to each acquaintance, and in the example in FIG. 39 the address 3823 correlate with “Fred Mancini” and the additional information 3831 correlated with “John Brown” do not exist. In addition, an acquaintance of user A may be a user of the network service V or may not be a user of the network service V. In the example shown in FIG. 39, “Betty Thomas” and “Fred Mancini” are users of the network service V and include user IDs IDvb3842 and IDvc3843 of the network service V.

Next, the HTML generation means generates an HTML code for an acquaintance information display screen with reference to the acquaintance table of user A which is searched, and the sending and receiving means 3151 sends the code to terminal A 3110 via the network 3199. In the present embodiment, there is no limitation to using HTML code for displaying a screen. An HTML code is used as an example of information for displaying a screen. The sending and receiving means 3111 in terminal A receives the code and an acquaintance information display screen is displayed in the GUI display means 3113 after analysis by the HTML analysis means 3112 (step S3803).

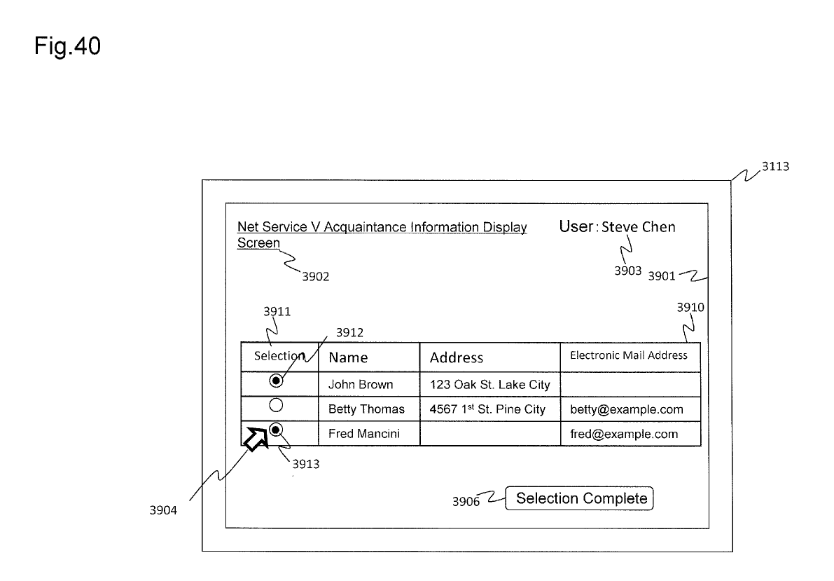

An example of an acquaintance information display screen of user A in the network service V is shown in FIG. 40. The GUI display means 3113 includes a window 3901 for offering the network service V and the window further includes a display 3902 which indicates that a display is the acquaintance information display screen of the network service V, and a display 3903 which indicates that user A is using the display. Furthermore, the acquaintance information display screen also includes an acquaintance information display part 3910. An acquaintance information display part displays a part or all of the acquaintance information stored by user A in the server V and includes an acquaintance selection part 3911 for selecting each acquaintance.

In the example shown in FIG. 40, user A moves a cursor 3904 displayed in the GUI display means 3113 using the input means 3114 and selects a selection part 3912 correlated with the acquaintance “John Brown” and a selection part 3913 correlated with the acquaintance “Fred Mancini”. In the example shown in FIG. 40, user A selects the acquaintance “John Brown” who has address information stored in the server V. However, the selected acquaintance may be a user of the network service V such as “Betty Thomas” in FIG. 40 for example. In addition, the selected acquaintance may be an acquaintance who has address information stored in server V such as “Fred Mancini” but does not have an address record stored in server V. The acquaintance selected by user A may be one acquaintance or a plurality of acquaintance. User A then moves the cursor 3904 and selects a selection completion button 3906. Next, the sending and receiving means 3111 sends the selection information of “John Brown” and “Fred Mancini” to the server 3150 via the network 3199 (step S3804). If the acquaintance information display screen is displaying name information of an acquaintance, additional information of the acquaintance such as an alternative address or an electronic email address may also be displayed.

When the sending and receiving means 3151 in the server V receives the selection information, information of the acquaintance, which is selected in step S3804 and which is stored in the acquaintance information table 3800, is stored in the temporary storage table 3158 (step S3805).

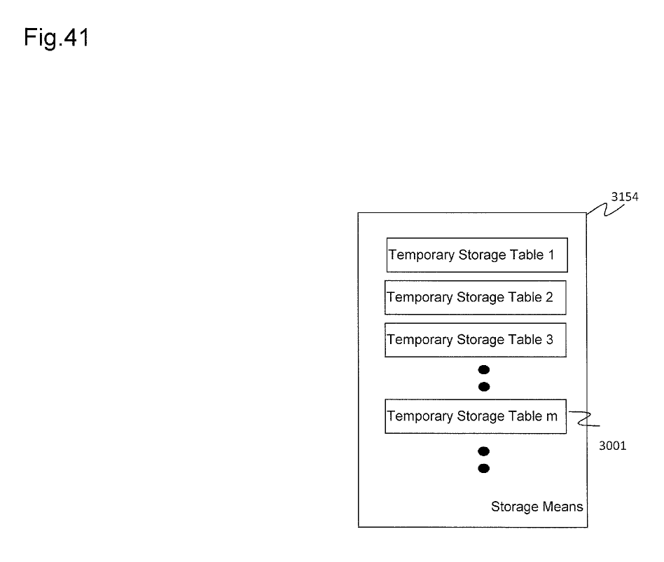

The structure of a temporary storage table created in the storage means 3154 is shown in FIG. 41. One temporary storage table is stored for each selection of an acquaintance by a user of the network service V by a similar process in steps S3802 to S3804.

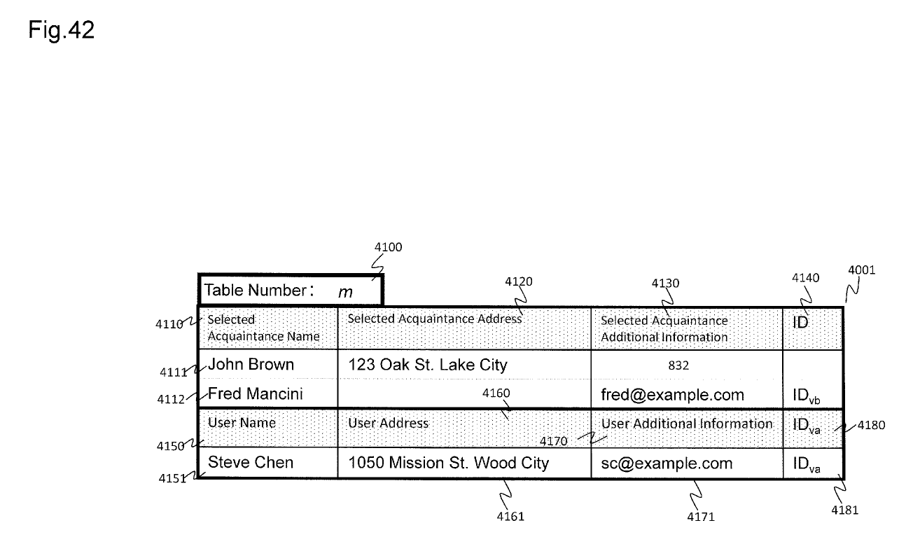

An example of a temporary storage table in the present embodiment is shown in FIG. 42. The temporary storage table 4001 includes a table number field 4100. In addition, the temporary storage table 4001 also includes a name column 4110 of a selected acquaintance, an address column 4120 of the selected acquaintance, an additional information column 4130 of a selected user and a user ID column 4140 in the case where an acquaintance is also a user of service V.

Referring to FIG. 42, in step S3805, information of the acquaintance “John Brown”, which is selected in step S3084, is stored in the row 4111 and similarly information of the acquaintance “Fred Mancini”, which is selected in step S3804, is stored in the row 4112. In addition, the temporary storage table 4001 includes a field 4151 which stores the name of user A, a field 4161 which stores the address of user A, and a field 4171 which stores additional information of the user A.

Next, the search means 3153 searches the user information table 3159 using the user ID of user A in the network service V as a search key. The name, the address, the additional information, etc. is correlated with each user ID in the network service V and stored in the user information table 3159. Next, the name, the address and, the additional information of user A, which is obtained as a result of this search, are stored in the fields 4151, 4161, and 4171 of a temporary storage table (step S3806).

Next, the HTML generation means 3152 generates an HTML code for a goods sales service selection screen and the sending and receiving means 3151 sends this to terminal A via the network 3199. In this example, information of a goods sales service linked to a network service is not included in the HTML code. The HTML code is for selecting a goods sales service for using information of user A or an acquaintance of user A selected in step S3805 and step S3806 in the goods sales service. Because information of a goods sales service which can link to a network service is obtained by terminal A from the server P in a later step S3809, this information does not have to be included in the HTML code.

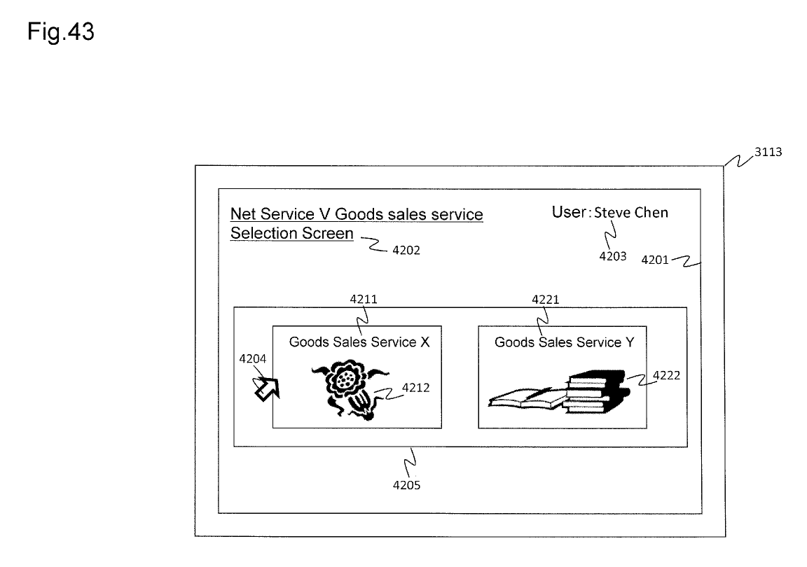

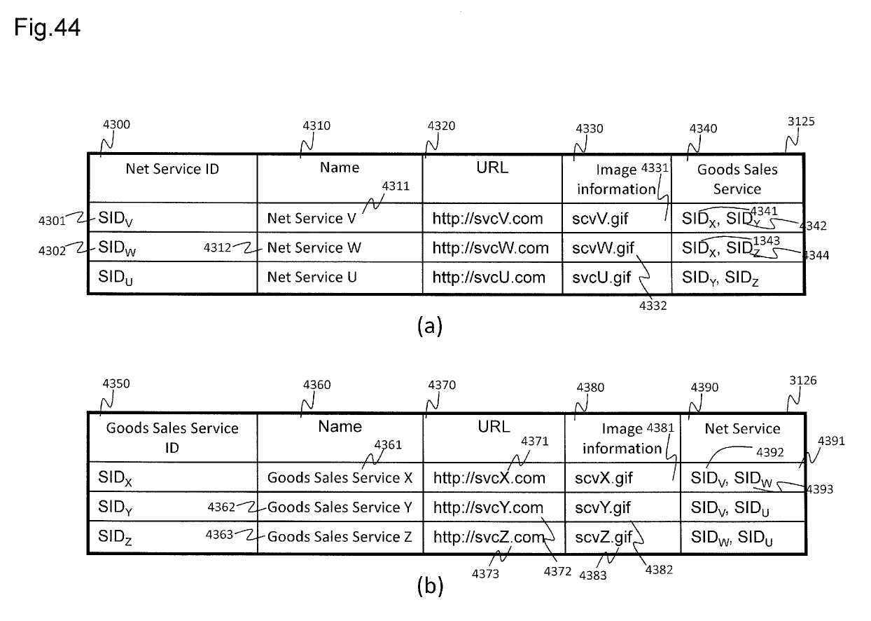

Next, the sending and receiving means 3111 receives an HTML code for a goods sales service selection screen, the code is analyzed by the HTML analysis means 3112 and the GUI display means 3113 displays the goods sales selection screen (step S3807). An example of a goods sales service selection screen is shown in FIG. 43. In the example shown in FIG. 43, the GUI display means 3113 includes a window 4201 which offers a network service, and the window further includes a display 4202 which indicates that a display is the goods sales selection screen of the network service V, a display 4203 which shows that user A is using the display, and a selection part 4205. A program which includes an instruction code comprised by a script language for example, is embedded in the service selection part 4205 within the HTML code received by terminal A from the server Y in step S3807. According this instruction code, the sending and receiving means 3111 sends a display request of a service selection part display and a network service ID for identifying the network service to the server P 3120 via the network 3199 (step S3808). In this example, the network service ID of the network service V is given as SIDv. Next, when the sending and receiving means 3121 receives these, the search means 3123 searches the network service table 3125 in the storage means 3124 using SIDv as a search key. An example of the network service table 3125 is shown in FIG. 44 (a). The network service table 3125 includes a network service ID column 4300, a network service name column, 4310, a network service URL column 4320, a network service image information column 4330, and a goods sales service ID column 4340 which can be linked with a network service. A user of a certain network service can search a goods sales service in which a product can be purchased and delivered by linking using the present embodiment by searching the linkable goods sales service ID column. In the example shown in FIG. 44 (a), SIDx4341 which is a service ID of the goods sales service X and SIDy4342 which is a service ID of the goods sales service Y are correlated with SIDv4301 which is a network service ID and stored. The search means 3123 obtains SIDx4341 and SIDy4342 as a result of this search. Next, the goods sales service table 3126 is searched using SIDx and SIDy as a search key. An example of the goods sales service table is shown in FIG. 44 (b). A goods sales service table includes a goods sales service ID column 4350, a goods sales service name column 4360, a URL column 4370, an image information column 4380, and a service ID column of a network service which can link to a goods sales service. Next, the name 4361 and 4362, URL 4371 and 4273, and image information 4381 and 4382 obtained as a result of this search are sent to terminal A via the network 3199 by the sending and receiving means 3121. When the sending and receiving means 3111 receives these, they are displayed on the service selection part 4205 (step S3809).

Referring to FIG. 43, the goods sales service name 4211 and image 4212 are each generated from fields 4361 and 4381 in the goods sales service table of server P and goods sales service name 4221 and image 4222 are generated from fields 4362 and 4382. Here, even if image information which represents each goods sales service is not displayed in the window 4201, any display may be used as long as user A can select a goods sales service of a link by clicking text to which a hyperlink is attached for example.

In the present embodiment, user A obtains information of the goods sales service 3126 from server P and the service selection part 4205 is displayed. As an alternative embodiment, a storage means of server V includes a goods sales service table and the service selection part 4205 may be displayed by including these in the HTML code received by terminal A in step S3807. In addition, in the present embodiment, user A makes an enquiry to the server P for information of a goods sales service which can link to the network service V, and server P sends the information of the linkable goods sales service to terminal A. On the other hand, in an alternative embodiment, server V makes a direct enquiry for information of a goods sales service which can link to the network service V, server P sends information 4361, 4381, 4362, 4382 of the linkable goods sales service to server V, the HTML generation means in server V generates HTML code for generating the image shown in FIG. 43 and this code may be sent to terminal A.

Next, user A moves the cursor 4204 displayed in the GUI display means using the input means 3114 and selects the image 4212 of the goods sales service X. Then, the sending and receiving means 3111 sends selection information and URL information of the goods sales service X to server V 3150 via network 3199 (step S3810).

In server V, the sending and receiving means 3151 receives the selection information and URL information of the goods sales service X. This URL information may be information 4371 within the goods sales service table in server P and may be stored in a temporary storage means in server P. Next, information stored in the temporary storage table 4001 shown in FIG. 42 in step S3805 and step S3806 is sent to the server X 3130 via network 3199 according to the URL information (step S3811). In this example, a process of storing information of user A in the temporary storage table (step S3806) is performed after acquaintance selection information is received from terminal A. However, this process is not limited to this timing and may be performed at any timing shown in FIG. 38.

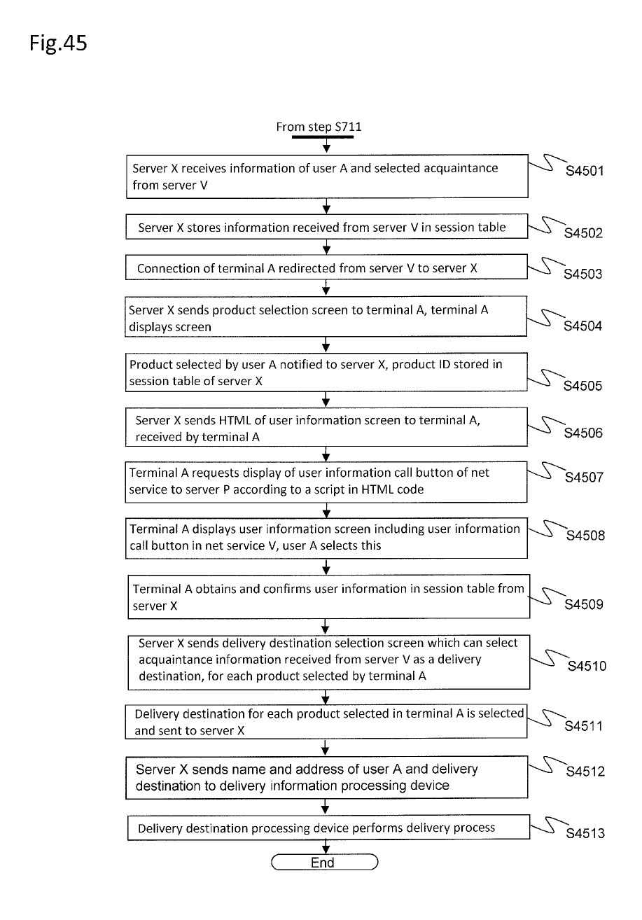

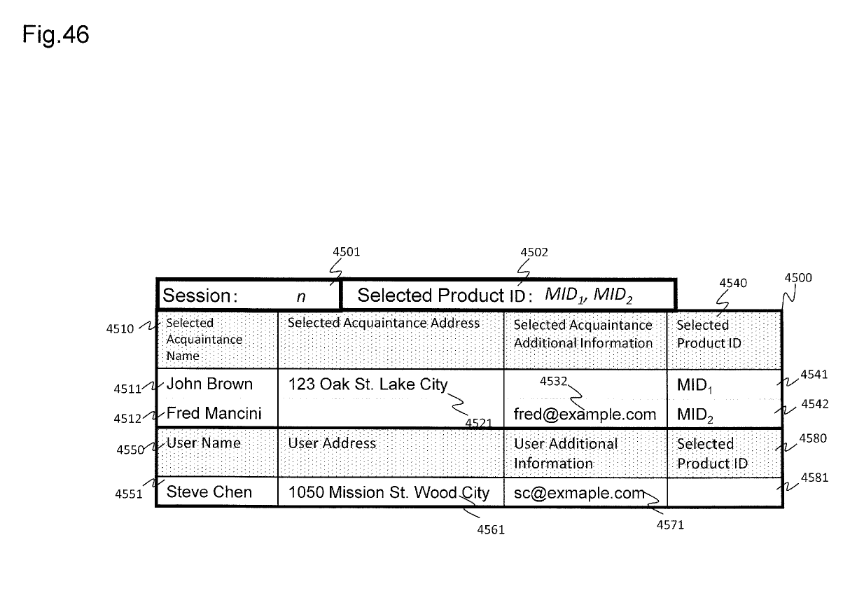

Next, a process in which user A sends a product to an acquaintance in the goods safes service X using information of user A and information of the acquaintance sent from the server V is explained using the flow chart shown in FIG. 45. The sending and receiving means 3131 of server X receives information of user A and information of an acquaintance selected as a delivery destination by user A in step S3804 sent by the server V 3150 in step S3811 (step S4501). Next, these are stored in one session table 4500 of a session table group 3135 in the storage means 3143 of server X (step S4502). A session table has a similar structure to in FIG. 41 and when server X receives information of user A and an acquaintance from another network service such as server Y or server W, a table having a structure such as in FIG. 46 for example is generated after a session number is allocated. The session table includes a session number field 4501, a selected product ID field 4502 and a field for storing information of user A and an acquaintance received from another server.

In the example of a session table shown in FIG. 46, [n] is stored as the session number 4501, and information related to “John Brown” 4511 and “Fred Mancini” 4512 which is acquaintance information received from server V 3150 in step S4501 are stored in the session table. The selected product ID field 4502 is empty at this point but a product ID of a product selected by user A in a later step S4505 is stored in this field. In addition, fields in the selected product ID column 4540 and selected product ID column 4580 correlated and stored with each acquaintance name and user name are empty at this time but product IDs are stored in these fields after a corresponding relationship between a product and a delivery destination is received by terminal A in a later step S4508. Furthermore, information related to “Steve Chen” 4551 which is information of user A received in step S4501 from server V is stored in the session table in which the session number is [n].

Next, the connection with terminal A 3110 is redirected from server 3150 to server X 3130 (step S4503). Next, the HTML generation means 3132 of server X generates an HTML code for displaying product information stored in the product table 3136 in an information terminal. The product table is correlated with a product ID for identifying the type of product and product information such as the price and, an image and characteristics of the product are correlated and stored.

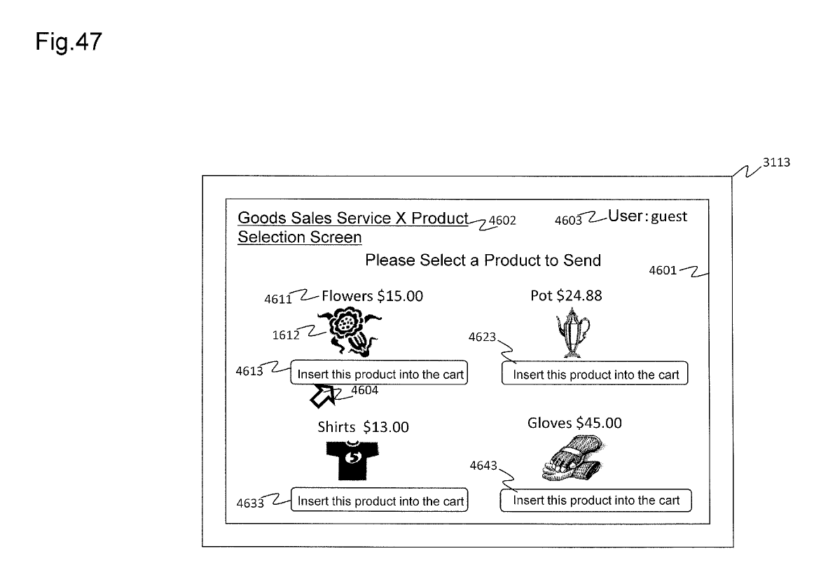

Next, the sending and receiving means 3131 sends the HTML code to terminal A via network 3199. In terminal A, when the sending and receiving means 3111 receives HTML code, the code is analyzed by the HTML analysis means 3112 and the GUI display means 3113 displays a product selection screen (step S4504). A window 4601 of the goods sales service X includes a display 4602 which indicates that a display is a product selection screen of the goods sales service X, and a display 4603 which indicates a user of the goods sales server X. In the example shown in FIG. 47, user A does not have a user ID in the goods sales service X. However, user A may have a user ID in the goods sales server X. Furthermore, the window 4601 includes a display of product information sold by the goods sales server X. In the example shown in FIG. 47, information on four products, flowers, pots, shirts and gloves, is displayed. In addition, a product selection button which has the display “insert this product into cart” correlated with each product information is displayed. For example price information 4611, product image 4612, and product selection button 4613 are displayed as flowers product information. This product information is correlated and stored with each product ID in the product table 3136 in server X and sent to terminal A in step S4504. Here, the product information which is displayed may be any type of information, In addition, in the example shown in FIG. 47, a session cart model is exemplified as a method for user to select a product. However, user A may select a product using any type of method.

Next, user A moves the cursor 4604 displayed in the GUI display means 3113 by an operation of the input means 3114 and selects the product selection button 4613 and product selection button 4623. Then, the sending and receiving means 3111 sends selection information of products correlated with the product selection button 4613 and product selection button 4623 respectively to the server X 3130 via network 3199. In server X, when the sending and receiving means 3131 receives the product selection information, a product ID of the selected product is stored in a selected product ID field (step S4505).

In the example shown in FIG. 46, MID₁ which is a product ID correlated with the product selection button 4613, and MID₂ which is a product ID correlated with the product selection button 4623 are stored in the selected product ID field 4502. At this time, a selected product is stored in the session table in which the session number is [n]. However, the delivery destination of each product is undefined and the fields 4541, 4542, and 4581 are empty at this time.

Next, the HTML generation means 3132 of server X generates an HTML code for a user information screen and the code is sent to terminal A 3110 via network 3199. The code is received by the sending and receiving means 3111 of terminal A (step S4506).

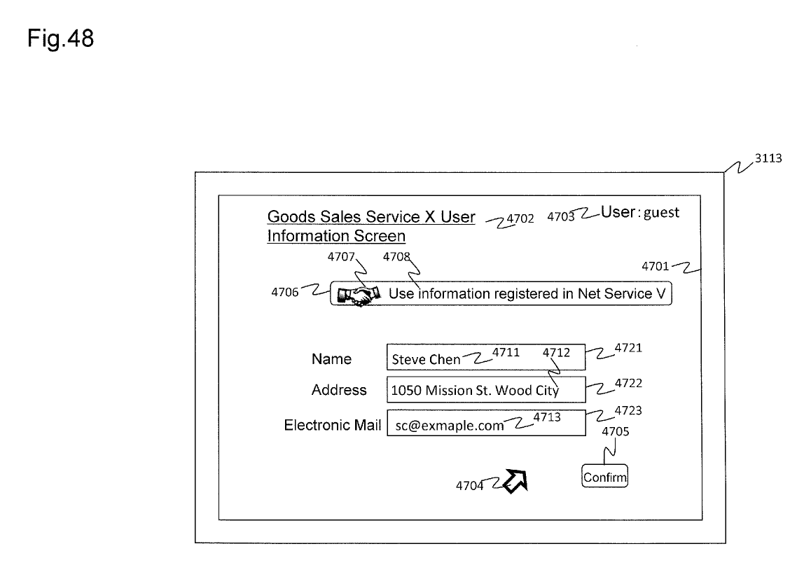

An example of a user information screen is shown in FIG. 48. The window 4701 in the user information screen includes a display 4702 which indicates that the screen is the user information screen of the goods sales service X, a display 4703 which indicates that the user is a user of the goods sales service X and a button 4706 for using user information registered in the network service V in the goods sales service X. A program which includes an instruction code comprised by a script language for example, is embedded in the button 4706 within the HTML code received by terminal A from the server X in step S4506. According to this instruction code, the sending and receiving means 3111 sends a display request of the contents of the button 4706 and SIN which is a service ID of the network service V to the server P 3120 via the network 3199. In this example, the network service ID of the network service V is given as SIDv. When the sending and receiving means 3121 receive these, the search means 3123 searches the name column 4310 and the image information column 4330 of the network service table 3125 using SIDv as a search key. As a result, the name 4311 and the image 4331 are obtained.

Next, the HTML generation means generates an HTML code which includes these and the sending and receiving means 3121 receive these and sends them to terminal A via network 3199. When the sending and receiving means 3111 of terminal A receives these, the HTML analysis means 3112 analyzes the code and a user information screen is created including the details of the button 4706 shown in FIG. 48. In the example shown in FIG. 48, the image 4707 is generated from the image 4331 and the name 4708 is generated from the name 4311. In addition, in the example shown in FIG. 48, a field 4721 for inputting the name of a user, a field 4722 for inputting an address, and a field 4723 for inputting an electronic mail address are displayed and are empty at this time. User A can input his/her own name, address, and electronic mail address in these fields. However, in the present embodiment, user A moves the cursor 4704 using the input means 3114 and selects the button 4706 (step S4508).

The sending and receiving means 3111 sends this selection information to server X via network 3199. When the sending and receiving means of server X receives this information, the sending and receiving means 3131 sends an HTML code which includes the name, address, and electronic mail address of user A stored in the session table in which the session number is [n], to terminal A via network 3199. When the sending and receiving means 3111 receives the HTML code, the image shown in FIG. 48 is displayed in the GUI display means 3113 after the analysis by the HTML analysis means 3112. In the example shown in FIG. 48, user A does not have a user ID in the goods sales service X. However, user A may have a user ID in the goods sales server X. Furthermore, at this stage, the window 4701 displays information of user A stored in the session table of server X. In the example shown in FIG. 48, the name 4711 of user A is displayed as information of field 4551 in a session table, the address 4713 of user A is displayed as information of field 4561 in a session table and electronic mail 4713 is displayed as information of field 4571 in a session table.

According to a conventional product purchasing method in a goods sales service, after a product to be purchased is selected, an operation for inputting information of a user is required. However, in the method related to one embodiment of the present invention, because the server X temporarily stores information of user A stored in advance in server V in the session table in which the session number is [n] and uses this information, user A can omit an operation for inputting his/her own information while terminal A is connected to server X. It is also possible to user A to correct the information displayed in each name, address, and electronic mail display section using the input means 3114 while the information of user A is displayed as in FIG. 48. Furthermore, in the present embodiment, a request for information for displaying the contents of button 4706 is sent by terminal A to server P and the image 4707 and name 4708 is sent from server P to terminal A. On the other hand, as an alternative embodiment, server X sends a request for displaying the contents of the button 4706 to server P, server P sends the image 4707 and name 4708 to the server X, server X sends these to terminal A which generates HTML code which includes this information and terminal A may display the image shown in FIG. 48. Furthermore, as an alternative embodiment, a link to the server P may simply be correlated with the button 4706. In this case, when user A selects button 4706 using terminal A, the connection between terminal A and server X is redirected to server P, the HTML generation means 3122 in server P generates an HTML code of a screen which includes a name and image in network service V from the network service table 3125 and goods sales service table 3126 and sends the code to terminal A. User A executes an instruction with respect to server V for using the information registered in the network service V using this screen.

Next, user A moves the cursor 4704 using the input means 3114 and selects the confirmation selection button 4705. Then, the sending and receiving means 3111 sends confirmation information of a user information screen to the server X via network 3199. When the sending and receiving means 3131 in server X receives the confirmation information, the search means 3133 searches a product table using a selection product ID stored in the session table in the state shown in FIG. 46 as a search key, and product information of a product selected by user A in step S4505 is obtained. Next, the HTML generation means 3132 generates an HTML code of a delivery destination selection screen for selecting the delivery destination of each product selected in step S4505, the sending and receiving means 3131 receives the code and sends the code to terminal A via network 3199 (step S4510), When the sending and receiving means 3111 in terminal A receives the code, the GUI display means 3113 displays a delivery destination selection screen after the analysis by the HTML analysis means 3112.

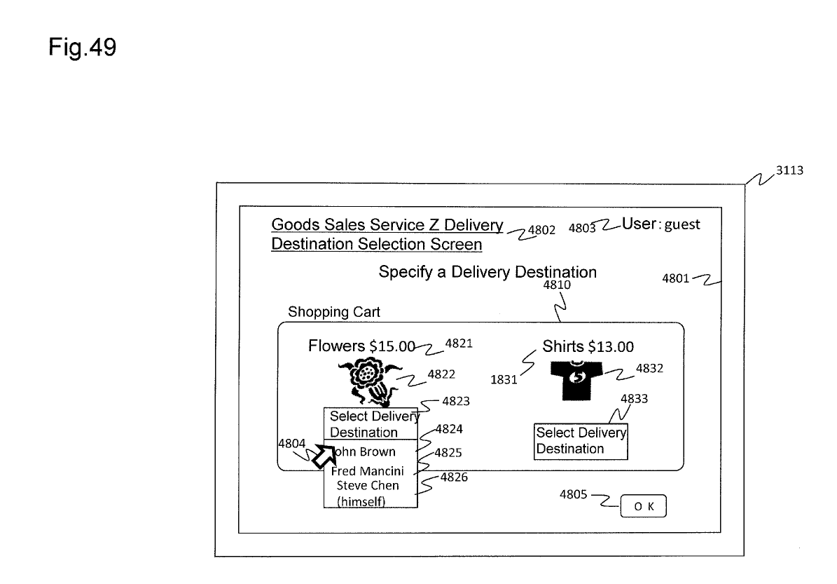

An example a delivery destination selection screen of a goods sales service in terminal A is shown in FIG. 49. The window 4801 of the delivery destination selection screen includes a display that indicates that this is the delivery destination screen. In the example shown in FIG. 49, user A does not have a user ID in the goods sales service X but may have a user ID in the goods sales service X. Furthermore, the window 4801 includes a shopping cart display part 4810. Product information of a product selected by user A in step S4505 is displayed in the shopping cart display part 4810.

In the example shown in FIG. 49, product information 4821 and 4822 related to “flowers” selected in step S4505, and product information 4831 and 4832 related to “shirts” are displayed in the shopping cart display part. Furthermore, a delivery destination section 4823 correlated with “flowers” and a delivery destination section 4833 correlated with “shirts” is displayed. At this time, the delivery destination information 4824, 4825, and 4826 correlated with the delivery destination selection part are not displayed.

User A moves the cursor 4804 and selects the delivery destination selection part 4823 using the input means 3114. The sending and receiving means 3111 sends the selection information to the server X via network 3199. When the sending and receiving means 3131 receives the selection information, the HTML generation means 3132 generates HTML code for a delivery destination selection screen which includes selection acquaintance name information 4511 and 4152 stored in the session table shown in FIG. 46, the sending and receiving means 31331 receives the HTML code and sends the code to terminal A via network 3199. The sending and receiving means in terminal A receives the HTML code and the GUI display means displays a delivery destination selection screen which includes the selected acquaintance name and the user name after the analysis by the HTML analysis means 3112. As a result, a delivery destination selection option is correlated with the delivery destination selection part 4823 and displayed as is shown in FIG. 49. “John Brown” 4824 displayed as a delivery destination selection option corresponds to the selection acquaintance name 4511 in the session table in which [n] is the session number, “Fred Mancini” 4825 corresponds to the selection acquaintance name 4512 in the session table and “Steve Chen (himself)” 4826 corresponds to the user name information 4551 in the session table in which [n] is the session number. Next, user A moves the cursor 4804 and selects the selection option “John Brown” 4824 using the input means 3114 thereby terminal A is instructed to send “flowers” to “John Brown”. Next, the sending and receiving means 3111 sends the selection information “John Brown” with respect to “flowers” to the server X via network 3199 (step S4511). When the sending and receiving means 3131 of server X receives the information, the session table in which the session number is [n] stores MID₁ which is the product ID of the selected “flowers” in the product selection ID field 4541.

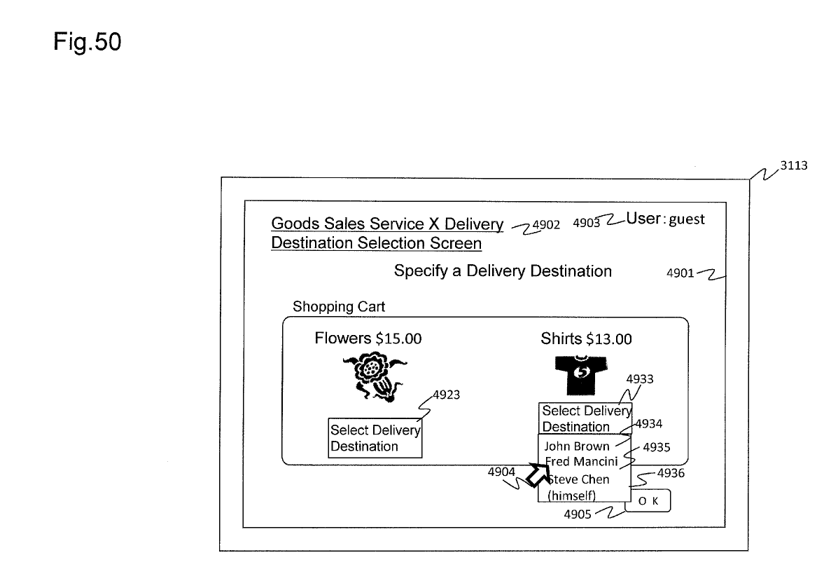

In addition, user A moves the cursor 4804 and selects the delivery destination selection part 4833 using the input means 3114. The GUI display means 3113 in terminal A displays the screen shown in FIG. 50 using a similar process as that described above. In the example shown in FIG. 50, the delivery destination selection option is displayed after being correlated with the delivery destination selection part 4933. “John Brown”4934, which is displayed as a delivery destination selection option, corresponds to the selection acquaintance name 4511 in the session table, “Fred Mancini” 4935 corresponds to the selection acquaintance name 4512 in the session table and “Steve Chen (himself)” 4936 corresponds to the user name information 4551 in the session table. Next, user A moves the cursor 4904 and selects the selection option “Fred Mancini” 4935 using the input means 3114 thereby terminal A is instructed to send “shirts” to “Fred Mancini”.

In addition, the sending and receiving means 3111 sends the selection information “Fred Mancini” with respect to “shirts” to the server X via network 3199 (step S4511). When the sending and receiving means 3131 of server X receives the information, the session table in which the session number is [n] stores MID₂ which is the product ID of the selected “shirts” in the product selection ID field 4542. Next, user A moves the cursor 4904 and selects confirmation button 4905 using the input means 3114. Then, the sending and receiving means 3111 sends the confirmation information to the server X via network 3199. The present embodiment is explained in this example using a process for sending a product to an acquaintance. However, the present embodiment is not limited to this. It is possible to specify a delivery destination to the user him/herself and not an acquaintance by selecting “Steve Chen (himself)” 4826 or 4836 in step S4508 described above. In addition, in this example, terminal A individually sends selection information with respect to “flowers” and “shirts” in the shopping cart to the server X. However, in the present embodiment the information may also be sent simultaneously to the server X.

At this time, sender information of user A, delivery destination information and product ID and delivery information for each delivery destination required for delivery of a product to an acquaintance obtained by server X from user A are stored in the session table in which the session number is [n] by the process in step S3801 to S4507.

Next, the sending and receiving means 3131 sends the information in the session table in which the session number is [n] to the delivery information processing device 3170 via network 3199 (step S4512). In the delivery information processing device, the sending and receiving means 3171 receives this information. As is shown in FIG. 46, MID₁ which is a product ID correlated with the acquaintance “John Brown” and which corresponds to an address and “flowers” are stored. As a result, the printing means 3172 prints the name 4551 and address 4561 of user A and information of the sender and “John Brown” 4511 and his address 4521 as information of the delivery destination on a delivery receipt. In addition, the display means 3173 displays the relationship between the printed receipt and the product ID and a delivery process of the product which includes MID₁ is performed based on this relationship (step S4513).

On the other hand, with respect to “Fred Mancini” 4512 to whom user A sends a “shirt”, because an address is not stored in a session table in which the session number is [n] at this time, the process in step S4511 cannot be performed. In this case, the message generation means 3137 in server X creates a message requesting input of an address, and the sending and receiving means 3131 sends this message via network 3199 using the electronic mail address 4532 in the session table in which the session number is [n]. When the sending and receiving means 3111 receives the address information from the information terminal of “Fred Mancini”, the information is correlated with “Fred Mancini” 4512 and stored in the selected acquaintance information field 4522 in the session table. Following this, steps S4512 and S4513 are performed similarly to the process with regard to “John Brown”. In addition, when the address is not stored in the session table in which the session number is [n] as in “Fred Mancini”, the server X sends a message sending request to server V, the message generation means 3182 in server V generates a message requesting an input of an address and this message may be sent to the information terminal of “Fred Mancini” using the electronic mail address 3833 in the temporary storage table 3800 as the address by the sending and receiving means 3151.

Here, a process where user A sends a product purchased in the goods sales service X to an acquaintance stored in the network service V is complete. Furthermore, in the present embodiment, a display for correlating an acquaintance or a user who are the delivery destination, with a product within a shopping cart is explained using a pull down type user interface in FIG. 49 and FIG. 50. The user interface can be any type of user interface as long as multiple relationships can be established between an acquaintance or a user and products such as a checkbox or radio button for example. In addition, in the present embodiment, user A moves to a goods sales service while two acquaintances in the network service V are selected. As a result, two products are selected in the goods sales service X, and the processes in step S4510 and S4511 are performed using the screen shown in FIG. 49 and FIG. 50 in order to correlate an acquaintance selected in network service V with each product. In the present embodiment, user A may move to the goods sales service X while only user A is selected in the network service V. In this case, because it is clear that the delivery destination of a selected product is user A, it is possible to omit the processes in step S4510 and S4511 using the screen in FIG. 49 and FIG. 50.

Next, a process whereby user B who has a user ID in the network service W performs a purchasing and delivery process of a product in the goods sales service X using user information and acquaintance information stored in the network service W is explained. However, because this process is almost the same as the process shown in each of the flow charts in FIG. 38 and FIG. 45, these will be explained while appropriately omitting overlapping explanations. Furthermore, an explanation will be given replacing server V with server W, user A with user B and terminal A with terminal B in the explanation using FIG. 38 and FIG. 45 below.

Here, it is assumed that user B is a user of the network service W. User B inputs user B's authentication information in the network service W to terminal B via an input means 3119 while terminal B 3115 is connected to a server W 3160 via the network 3199. A combination of an ID and password information of user B in the network service W is used as an example of authentication information. However, the authentication information can be any type of information as long as the information can uniquely specify user B among a user group of the network service W such as biological authentication information. In addition, the net server W can be any service as long as the service includes a means for identifying user B among a user group of this service. For example, service W may be a search service, a goods sales service, a message printing service, an advertisement service or an SNS (Social Networking Service).

Next, a sending and receiving means 3116 sends input authentication information of user B to the server W 3160 via network 3199. When the sending and receiving means 3161 receives the authentication information of user B, the search means 3163 searches a user authentication table 3165 in the storage means 3164. User B is authenticated by server B when a combination of the user ID and password information received by the sending and receiving means 3161, and the user ID and password information stored in advance in the user authentication table 3165 match (step S3801). Here, the user authentication table 3165 is explained assuming the table includes a user ID column and a password column as an example. However, the table may be any type of table as long as it stores information which authenticates that the authentication information received by the sending and receiving means 3161 belongs to user B

Next, the sending and receiving means 3116 of terminal B sends an acquaintance information display screen request to the server W via network 3199. Here, the acquaintance information display screen request called by terminal B can be any screen as long as it displays information correlated with user B and an acquaintance of user B such as delivery destination information in a goods sales service, a friend list in an SNS service, or address information in a message printing service. When the sending and receiving means 3161 in server W receives this request, the search means 3163 searches an acquaintance information table 3166 using the user ID of user B as a search key and acquaintance information of user B is obtained (step S3802). In the example of the present embodiment, the acquaintance information table is explained having the same structure as in FIG. 39.

Next, the HTML generation means 3162 generates an HTML code for displaying an acquaintance information display screen using the searched acquaintance table of user B, and the sending and receiving means 3161 sends the HTML code to terminal B 3115 via network 3199. The sending and receiving means 3116 of terminal B receives the HTML code, and the GUI display means 3118 displays the acquaintance information display screen after the analysis by the HTML analysis means 3117 (step S3803).

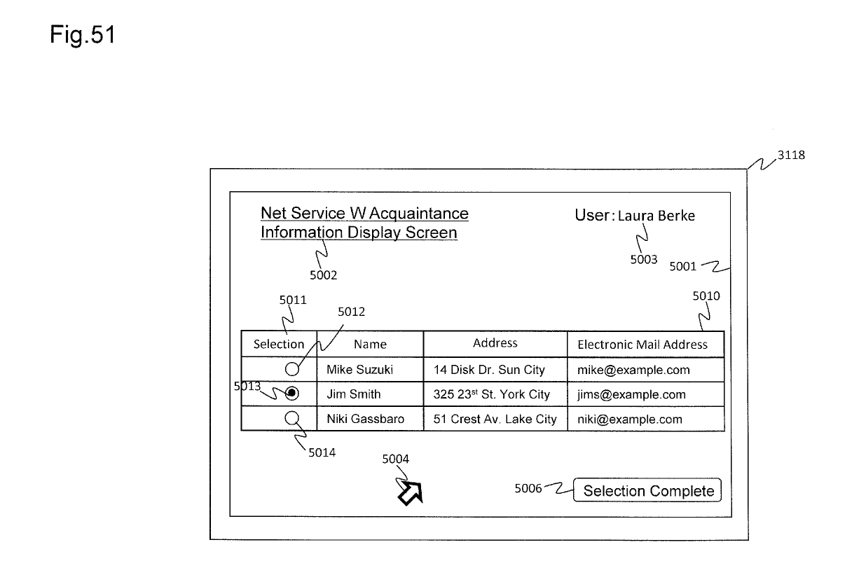

An example of an acquaintance information display screen of user B in the network service W is shown in FIG. 51. The GUI display means 3118 includes a window 5001 for offering the network service W and the window further includes a display 5002 which indicates that a display is the acquaintance information display screen of the network service W, and a display 5003 which indicates that user B is using the display. Furthermore, the acquaintance information display screen also includes an acquaintance information display part 5010 for displaying acquaintance information received by the sending and receiving means 3116 from server W. An acquaintance information display part displays a part or all of the acquaintance information stored in the server W and includes an acquaintance selection part 5011 for selecting each acquaintance.

In the example shown in FIG. 51, user B moves a cursor 5004 displayed in the GUI display means 3118 using the input means 3119 and selects a selection part 5013 correlated with the acquaintance “Jim Smith” who is an acquaintance. The number of acquaintances selected by user B may be one or a plurality. User B further moves the cursor 5004 and selects a selection completion button 5006. Next, the sending and receiving means 3116 sends the selection information of “Jim Smith” to the server W 3160 via the network 3199 (step S3804).

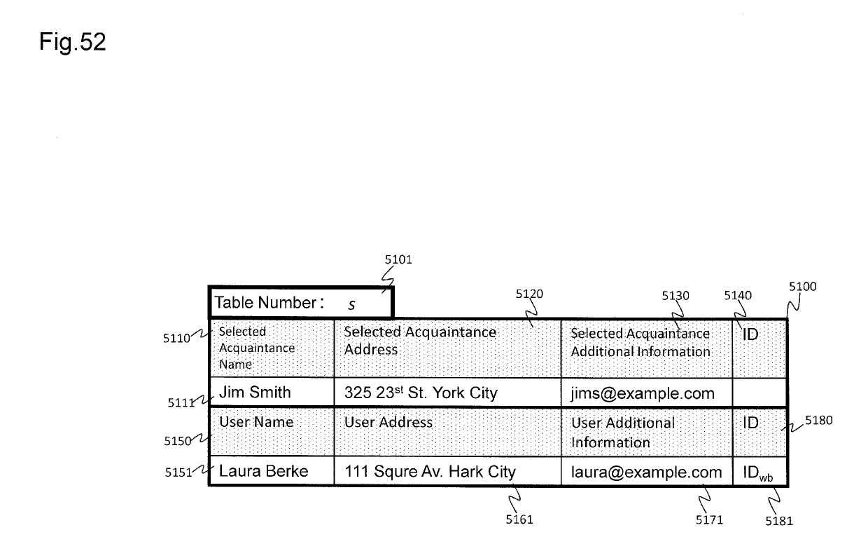

When the sending and receiving means 3161 in the server W receives the selection information, information of an acquaintance selected in step S3804 and stored in the acquaintance information table is stored in the temporary storage table 3168 (step S3805). Here, an explanation is continued with the temporary storage table in server W having the structure as shown in FIG. 41. An example of a temporary storage table in server W is shown in FIG. 52. The temporary storage table 5100 includes a table number field 5101. In addition, the temporary storage table 5100 also includes a name column 5110 of a selected acquaintance, an address column 5120 of a selected acquaintance, an additional information column 5130 of a selected user and a user ID column 5140 in the case where an acquaintance is also a user of service W.

Referring to FIG. 52, in step S3805, information of the acquaintance “Jim Smith” selected in step S3084 is stored in the row 5111. In addition, the temporary storage table 5100 includes a field 5151 which stores the name of user A, a field 5161 which stores the address of user A, a field 5171 which stores additional information of the user A, and a field 5181 which stores a user ID.

Next, the search means 3163 searches the user information table 3169 using the user ID of user B in the network service W as a search key. The name, address, additional information, etc. is correlated with each user ID in the network service W and stored in the user information table 3169. Next, the name, the address, and the additional information of user B which is obtained as a result of this search are stored in the fields 5151, 5161 and 5171 of a temporary storage table (step S3806).

Next, the HTML generation means 3162 generates an HTML code for a goods sales service selection screen and the sending and receiving means 3161 sends this to terminal B 3115 via the network 3199. In this example, information of a goods sales service linked to the network service W is not included in the HTML code. The HTML code is for selecting a goods sales service for using information of user B or an acquaintance of user B selected in step S3805 and step S3806 in the goods sales service. Because information of a goods sales service which can link to a network service is obtained by terminal B from the server P in a later step S3809, this information does not have to be included in the HTML code.

Next, the sending and receiving means 3116 in terminal B receives the HTML code for a goods sales service selection screen, this is analyzed by the HTML analysis means 3117 and the GUI display means 3118 displays the goods sales selection screen (step S3807).

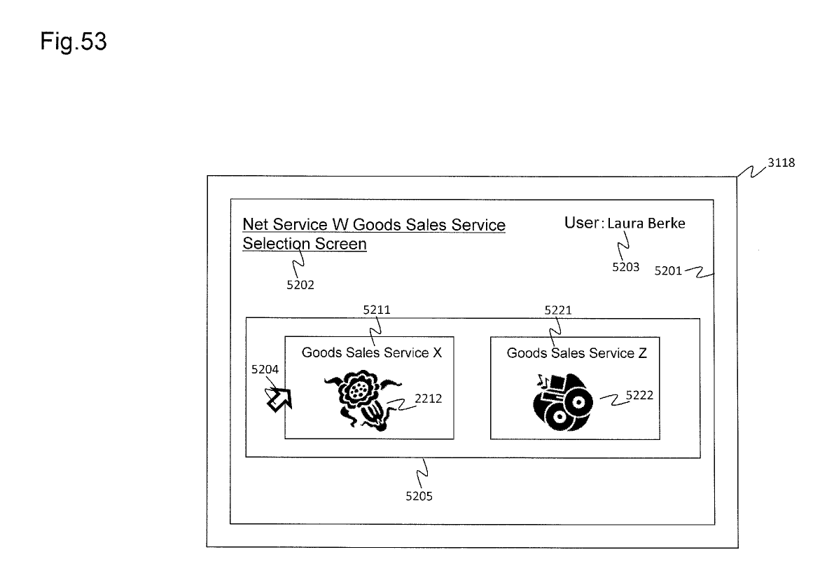

An example of a goods sales service selection screen is shown in FIG. 53. In the example shown in FIG. 53, the GUI display means 3118 includes a window 5201 which offers the network service W, and the window further includes a display 5202 which shows that a display is the goods sales selection screen of the network service W, and a display 5203 which shows that user B is using the display, and a selection part 5205. A program which includes an instruction code comprised by a script language for example, is embedded in the service selection part 5205 within the HTML code received by terminal B from the server W in step S3807. According to this instruction code, the sending and receiving means 3116 sends a display request of a service selection part display and a network service ID for identifying the network service W to the server P 3120 via the network 3199 (step S3808).

In this example, the network service ID of the network service W is given as SIDw. Next, when the sending and receiving means 3121 in server P receives these, the search means 3123 searches the network service table 3125 in the storage means 3124 using SIDw as a search key.

An example of the network service table 3125 is shown in FIG. 44 (a). In the example shown in FIG. 44 (a), SIDx4343 which is a service ID of the goods sales service X and SIDz4344 which is a service ID of the goods sales service Z are stored after being correlated with SIDw4302 which is a network service ID. The search means 3123 obtains SIDx4343 and SIDz4344 as a result of this search. Next, the goods sales service table 3123 is searched by the search means 3123 using SIDx and SIDz as a search key.

An example of the goods sales service table is shown in FIG. 44 (b). Next, the names 4361 and 4363, URLs 4371 and 4273, and image information 4381 and 4383, which are obtained as a result of this search, are sent to the terminal B via the network 3199 by the sending and receiving means 3121.

When the sending and receiving means 3116 in terminal B receives these, they are displayed on the service selection part 5205 (step S3809).

Referring again to FIG. 53, the goods sales service name 5211 and image 5212 are each generated from fields 4361 and 4381 in the goods sales service table of server P and goods sales service name 5221 and image 5222 are generated from fields 4363 and 4383. Here, even if image information which represents each goods sales service is not displayed in the window 5201, any display may be used as long as user B can select a goods sales service of a link by clicking text to which a hyperlink is attached for example. In the present embodiment, user B obtains information of the goods sales service 3126 from server P and the service selection part 4205 is displayed. However, a storage means of server W may include a goods sales service table and the service selection part 4205 may be displayed by including these in the HTML code received by terminal B in step S3807. In addition, in the present embodiment, user B makes an enquiry to the server P for information of a goods sales service which can link to the network service W, and server P sends the information of the linkable goods sales service to terminal B. On the other hand, in an alternative embodiment, server W makes a direct enquiry for information of a goods sales service which can link to the network service W, server P sends information 4361, 4381, 4363, and 4383 of the linkable goods sales service to server W, the HTML generation means in server W generates HTML code for generating the image shown in FIG. 53 and this code may be sent to terminal B.

In this way, in the present embodiment, a correlation of a certain network service and a goods sales service which can use acquaintance information and user information stored in the network service are stored in advance in a network service table 3125 and goods sales service table 3126. For example, as is shown in FIG. 43, in the goods sales service selection screen of user A, who uses network service V, the use of acquaintance information and user information in the goods sales service X and goods sales service Y are displayed as a selection option. In the goods sales service selection screen of user B who uses the network service W shown in FIG. 53, the use of acquaintance information and user information in the goods sales service X and goods sales service Z are displayed as a selection option. A selection option which changes according to this type of context is offered to a user based on the corresponding relationship of the network service Z and a goods sales service stored in server P. In this way, it is possible to change the linking relationship between a plurality of network services and a plurality of goods sales services and when changing this linking relationship it is not necessary to add a change to a server of the network service or the server of a goods sales service. This is an effect offered by the link server P.

Next, user A moves the cursor 5204 displayed in the GUI display means 3118 using the input means 3119 and selects the image 5212 of the goods sales service X. Then, the sending and receiving means 3116 sends selection information of the goods sales service X to server W 3160 via network 3199 (step S3810).

In server W, the sending and receiving means 3161 receives the selection information and URL information of the goods sales service X. This URL information may be information 4371 within the goods sales service table in server P and may be stored in a temporary storage means in server W. Next, information stored in the temporary storage table shown in FIG. 52 in step S3805 and step S3806 is sent to the server X 3130 via network 3199 according to the URL information (step S3811). In this example, a process of storing information of user B in the temporary storage table (step S3806) is performed after acquaintance selection information is received from terminal B. However, this process is not limited to this timing and may be performed at any timing shown in FIG. 38.

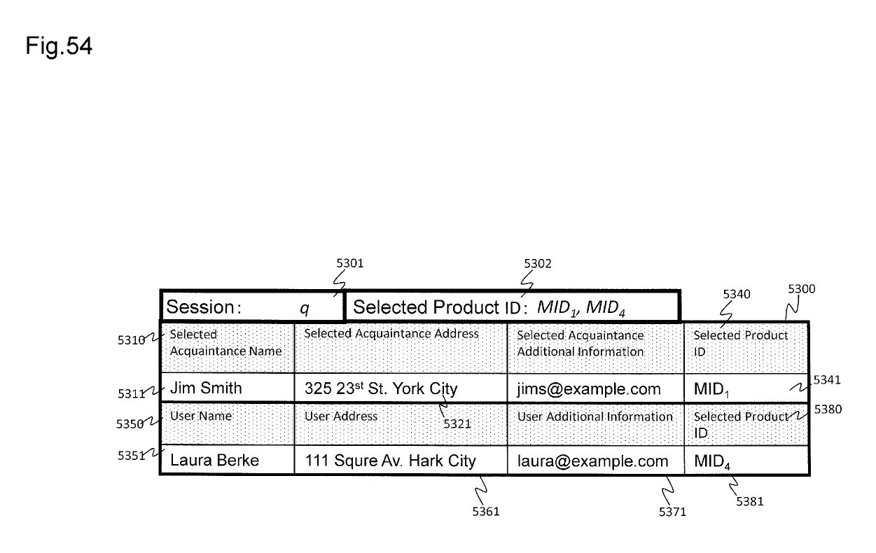

Next, a process in which user B sends a product to an acquaintance in the goods sales service X using information of user B and information of the acquaintance sent from the server W is explained using the flow diagram shown in FIG. 45. The sending and receiving means 3131 of server X receives information of user B and information of an acquaintance selected as a delivery destination by user B in step S3804 sent by the server W 3160 in step S3809 (step S4501). Next, these are stored in one session table 5300 of a session table group 3135 in the storage means 3143 of server X (step S4502). An example of a session table used in a process of user B is shown in FIG. 54. [q] is stored as the session number 5301, and information related to “Jim Smith” 5311 which is acquaintance information received from server W 3160 are stored in the session table. In addition, fields in the selected product ID column 5340 and selected product ID column 5380 correlated and stored with each acquaintance name and user name are empty at this time but product IDs are stored in these fields after a corresponding relationship between a product and a delivery destination is received by terminal B in a later step S4508. Furthermore, information related to “Laura Berke” 5351 which is information of user B received in step S4501 from server W is stored in the session table in which the session number is [q].

Next, a connection with terminal B 3110 is redirected from server W 3160 to server X 3130 (step S4503). Next, the HTML generation means 3132 of server X generates HTML code for displaying product information stored in the product table 3136 in an information terminal. The product table is correlated with a product ID for identifying the type of product and product information such as the price and, an image and characteristics of the product are correlated and stored.

Next, the sending and receiving means 3131 sends the HTML code to terminal B 3115 via network 3199. In terminal B, when the sending and receiving means 3116 receives the HTML code, this is analyzed by the HTML analysis means 3117, and the GUI display means 3118 displays a product selection screen (step S4504). An example of the product selection screen displayed here is already shown in FIG. 47. In this example, although a product selection screen with respect to user A and a product selection screen with respect to user B are the same, different product selection screen may also be displayed.

Next, user B moves the cursor 4604 displayed in the GUI display means 3118 by an operation of the input means 3119 and selects the product selection button 4613 and product selection button 4643. Then, the sending and receiving means 3116 sends selection information of products correlated with the product selection button 4613 and the product selection button 4643 respectively to the server X 3130 via network 3199. In server X, when the sending and receiving means 3131 receives the product selection information, a product ID of the selected product is stored in a selected product ID field (step S4505). In the example shown in FIG. 54, MID₁ which is a product ID correlated with the product selection button 4613, and MID₄ which is a product ID correlated with the product selection button 4643, are stored in the selected product ID field 5302. At this time, a selected product is stored in the session table in which the session number is [q]. However, the delivery destination of each product is undefined and the fields 5341 and 5381 are empty at this time.

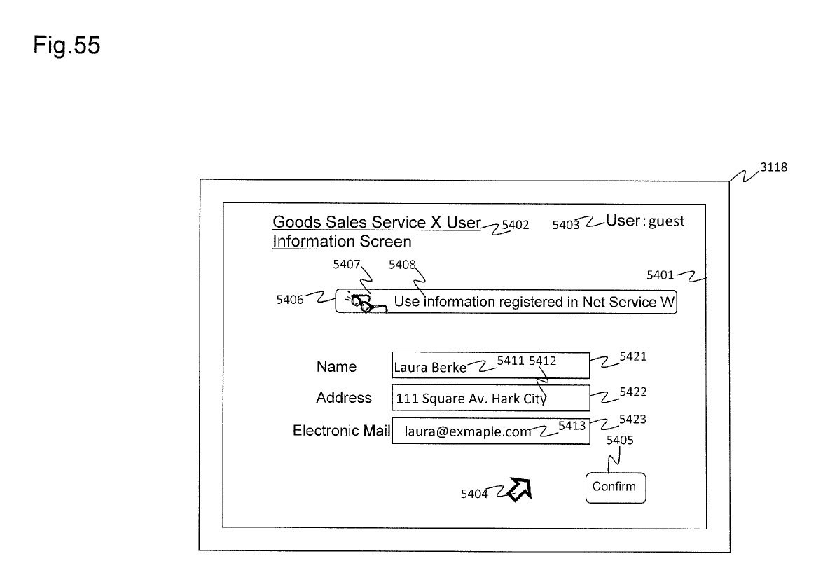

Next, the HTML generation means 3132 of server X generates HTML code for a user information screen and the code is sent to terminal B 3115 via network 3199. The code is received by the sending and receiving means 3116 of terminal B (step S4506). An example of a user information screen is shown in FIG. 55. The window 5401 in the user information screen includes a display 5402 which shows that the screen is the user information screen of the goods sales service X, a display 5403 which shows that the user is a user of the goods sales service X and a button 5406 for using user information registered in the network service in the goods sales service X. A program which includes an instruction code comprised by a script language for example, is embedded in the button 5406 within the HTML code received by terminal B from the server X in step S4506. According to this instruction code, the sending and receiving means 3116 of terminal B sends a display request of the contents of the button 5406 and SIDw which is a service ID of the network service W to the server P 3120 via the network 3199. When the sending and receiving means 3121 of server P receives these, the search means 3123 searches the name column 4310 and the image information column 4330 of the network service table 3125 using SIDw as a search key. As a result, the name 4311 and the image 4331 are obtained. Next, the HTML generation means generates an HTML code which includes these and the sending and receiving means 3121 receive these and sends them to terminal B via network 3199. When the sending and receiving means 3116 of terminal B receives these, the HTML analysis means 3117 analyzes this and a user information screen is created including the details of the button 5406 shown in FIG. 55 (step S4508).

In the example shown in FIG. 55, the image 5407 is generated from the image 4332 and the name 5408 is generated from the name 4312. in addition, in the example shown in FIG. 55, a field 5421 for inputting the name of a user, a field 5422 for inputting an address, and a field 5423 for inputting an electronic mail address are displayed and are empty at this time. User B can input his/her own name, address, and electronic mail address in these fields using the input means 3119. However, in the present embodiment, user B moves the cursor 5404 using the input means 3119 and selects the button 5406 (step S4509).

The sending and receiving means 3111 sends this selection information to server X via network 3199. When the sending and receiving means of server X receives this information, the sending and receiving means 3131 sends HTML code which includes the name, address, and electronic mail address of user B stored in the session table in which the session number is [q], to terminal B via network 3199. When the sending and receiving means 3116 receives the HTML code, the image shown in FIG. 55 is displayed in the GUI display means 3118 after the analysis by the HTML analysis means 3117. In the example shown in FIG. 55, user B does not have a user ID in the goods sales service X. However, user B may have a user ID in the goods sales server X. Furthermore, at this stage, the window 5401 displays information of user B stored in the session table of server X.

In the example shown in FIG. 55, the name 45411 of user B is displayed as information of field 5351 in a session table, the address 5412 of user B is displayed as information of field 5361 in a session table and electronic mail 5413 is displayed as information of field 5371 in a session table. According to a conventional product purchasing method in a goods sales service, after a product to be purchased is selected, an operation for inputting information of a user is required. However, in the method related to one embodiment of the present invention, because the server X temporarily stores information of user B stored in advance in server W in the session table in which the session number is [q] and uses this information, user B can omit an operation for inputting his/her own information while terminal B is connected to server X. It is also possible for user A to correct the information displayed in each name, address, and electronic mail display section using the input means 3194 while the information of user B is displayed as in FIG. 55. Furthermore, in the present embodiment, a request for information for displaying the contents of button 5406 is sent by terminal B to server P and the image 5407 and the name 5408 are sent from server P to terminal B. On the other hand, as an alternative embodiment, server X sends a request for displaying the contents of the button 5406 to server P, server P sends the image 5407 and name 5408 to the server X, server X sends these to terminal B which generates an HTML code which includes this information and terminal B may display the image shown in FIG. 55. Furthermore, as an alternative embodiment, a link to the server P may simply be correlated with the button 5406. In this case, when user B selects button 5406 using terminal B, the connection between terminal B and server X is redirected to server P, the HTML generation means 3122 in server P generates HTML code of a screen which includes a name and an image in network service W from the network service table 3125 and goods sales service table 3126 and sends the code to terminal B. User B executes an instruction with respect to server W for using the information registered in the network service W using this screen.

Next, user B moves the cursor 5404 using the input means 3119 and selects the confirmation selection button 5405. Then, the sending and receiving means 3116 sends confirmation information of a user information screen to the server X via network 3199. When the sending and receiving means 3131 in server X receives the confirmation information, the search means 3133 searches a product table using a selection product ID stored in the session table in the state shown in FIG. 54, and product information of a product selected by user B in step S4505 is obtained. Next, the HTML generation means 3132 generates an HTML code of a delivery destination selection screen for selecting the delivery destination of each product selected in step S4505, the sending and receiving means 3131 receives the code and sends the code to terminal B via network 3199 (step S4510), When the sending and receiving means 3116 in terminal B receives the code, the GUI display means 3118 displays a delivery destination selection screen after the analysis by the HTML analysis means 3117.

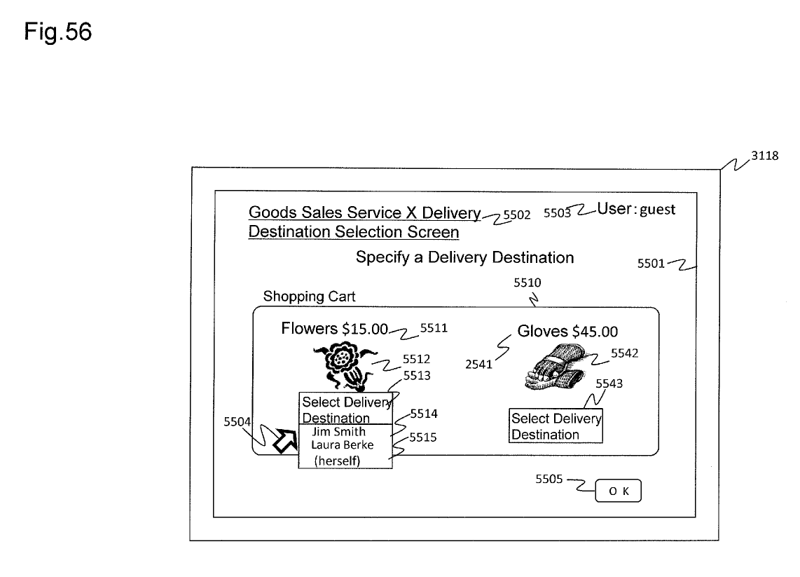

An example of a delivery destination selection screen of a goods sales service in terminal B is shown in FIG. 56. The window 5501 of the delivery destination selection screen includes a display 5502 that shows this is the delivery destination screen. In the example shown in FIG. 56, user B does not have a user ID in the goods sales service X but may have a user ID in the goods sales service X. Furthermore, the window 5501 includes a shopping cart display part 5510. Product information of a product selected by user B in step S4505 is displayed in the shopping cart display part 5510. In the example shown in FIG. 56, product information 5541 and 5512 related to “flowers” selected in step S4505, and product information 5541 and 5542 related to “gloves” are displayed in the shopping cart display part. Furthermore, a delivery destination section 5513 correlated with “flowers” and a delivery destination section 5543 correlated with “gloves” is displayed. At this time, the delivery destination information 5414 and 5415 correlated with the delivery destination selection part 5513 are not displayed.

User B moves the cursor 5504 and selects the delivery destination selection part 5513 using the input means 3119. The sending and receiving means 3116 sends the selection information to the server X via network 3199. When the sending and receiving means 3131 receives the selection information, the HTML generation means 3132 generates an HTML code for a delivery destination selection screen which includes selection acquaintance name information 5311 and user name information 5351 stored in the session table shown in FIG. 54, the sending and receiving means 3131 receives the HTML code and sends this to terminal B via network 3199. The sending and receiving means 3116 in terminal B receives the HTML code and the GUI display means 3118 displays a delivery destination selection screen which includes the selection acquaintance name and user name after the analysis by the HTML analysis means 3117. As a result, a delivery destination selection option is correlated with the delivery destination selection part 5513 and displayed as is shown in FIG. 56. “Jim Smith” 5514 displayed as a delivery destination selection option corresponds to the selection acquaintance name 5311 in the session table in which [q] is the session number, and “Laura Berke” 5515 corresponds to the selection acquaintance name 5351 in the session table.

Next, user B moves the cursor 5504 and selects the selection option “Jim Smith” 5514 using the input means 3119 thereby terminal B is instructed to send “flowers” to “Jim Smith”. Next, the sending and receiving means 3116 sends the selection information “Jim Smith” with respect to “flowers” to the server X via network 3199 (step S4511). When the sending and receiving means 3131 of server X receives the information, the session table in which the session number is [q] stores MID₁ which is the product ID of the selected “flowers” in the product selection ID field 5341.

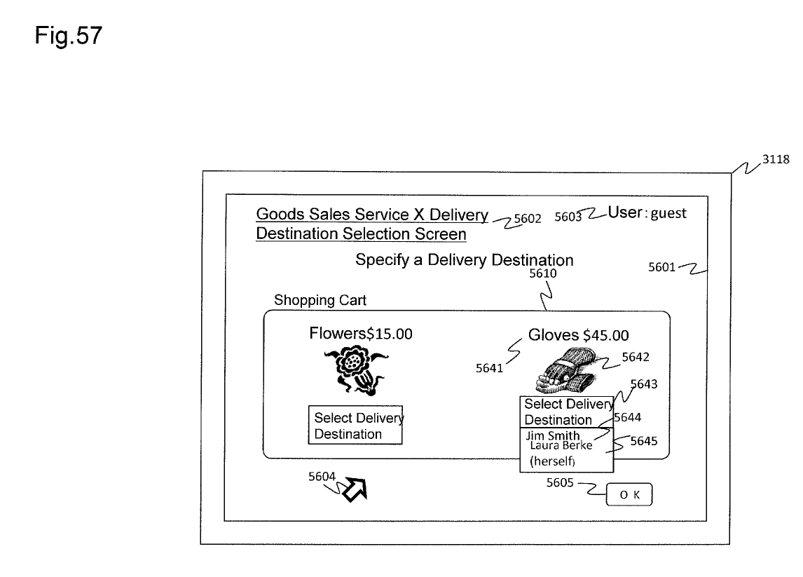

In addition, user B moves the cursor 5404 and selects the delivery destination selection part 5543 using the input means 3119. The GUI display means 3118 in terminal B displays the screen shown in FIG. 57 using a similar process as that described above.

In the example shown in FIG. 57, a screen is correlated with the delivery destination selection option 5463 and the delivery destination selection option is displayed. “Jim Smith” 5644 displayed as a delivery destination selection option corresponds to the selection acquaintance name 5311 in the session table in which the session number is [q], and “Laura Berke (herself)” 5645 corresponds to the user name information 5351 in the session table in which the session number is [q].

Next, user B moves the cursor 5604 and selects the selection option “Laura Berke (herself)” 5645 using the input means 3119 thereby “Laura Berke” is set as the delivery destination for “gloves”. Then, the sending and receiving means 3116 sends the selection information “Laura Berke” with respect to “gloves” to the server X via network 3199 (step S4511). When the sending and receiving means 3131 of server X receives the information, the session table in which the session number is [q] stores MID₄ which is the product ID of the selected “gloves” in the product selection ID field 5381.

Next, user B moves the cursor 5604 and selects confirmation button 5605 using the input means 3119. Then, the sending and receiving means 3116 sends the confirmation information to the server X via network 3199. In addition, in this example, terminal B individually sends selection information with respect to “flowers” and “gloves” in the shopping cart to the server X. However, the information may also be sent simultaneously to the server X. At this time, sender information of user B, delivery destination information and product ID and delivery information for each delivery destination required for delivery of a product to an acquaintance obtained by server X from user B are stored in the session table in which the session number is [q] by the process in step S3801 to S4507.

Next, the sending and receiving means 3131 sends the information in the session table in which the session number is [q] to the delivery information processing device 3170 via network 3199 (step S4512). In the delivery information processing device, the sending and receiving means 3171 receives this information. As is shown in FIG. 54, MID₁ which is a product ID correlated with the acquaintance “Jim Smith” and which corresponds to an address and “flowers” are stored. In addition, MID₁ which is a product ID correlated with the acquaintance “Laura Berke” and which corresponds to an address and “flowers” are stored. As a result, the printing means 3172 prints the name 5351 and address 5361 of user B as information of the sender and “Jim Smith” 5311 and his address 5321 as information of the delivery destination on a delivery receipt. In addition, the display means 3173 displays the relationship between the printed receipt and the product ID and a delivery process of the product which includes MID₁ is performed based on this relationship (step S4513). At the same time, the printing means 3172 prints the name 5351 and the address 5361 of user B as information of the sender and the name of the same user 5351 and his address 5361 as information of the delivery destination on a delivery receipt. In addition, the display means 3173 displays the relationship between the printed receipt and the product ID and a delivery process of the product which includes MID₄ is performed based on this relationship (step S4513)

Here, a process where user B sends a product purchased in the goods sales service X to an acquaintance and to him/herself stored in the network service W is complete. Furthermore, in the present embodiment, the goods sales service X can perform a process for purchasing and delivering a product in the goods sales service X using an acquaintance list stored in the servers of a plurality of network services. That is, according to the present embodiment, the server of goods sales service X receives user information from the servers of a plurality of different network services, and can perform a process for purchasing and delivering a product more easily than a conventional technique using the user information or acquaintance information. In the present embodiment of the present invention, for example, even if a change occurs in the goods sales service X such as an increase or a decrease in the number of network services which can receive user information, it is sufficient to change only the network service table 3125 and the goods sales service table 3126 in the server of the link service P, and it is not necessary to upgrade the server X 3130 in the goods sales service X or the server 3150 in the network service V.

### Third Embodiment

In the second embodiment, a purchasing and delivery process is performed in the following order. A user selects a delivery destination in a network service, moves to a goods sales service selected in a screen of the network service and selects a product. However, in a third embodiment explained below, a user begins the process while using a goods sales service. The user first selects a product in the goods sales service, then selects a network service which obtains a delivery destination and then moves to the selected network service before selecting the delivery destination. In the second embodiment, the server of the goods sales service holds context information which describes which network service provides the user information or the acquaintance information used in the goods sales service in order to move from the network service to the goods sales service. As a result, for example, as is shown in the button 4706 displayed in FIG. 48 or in the button 5406 displayed in FIG. 55, a network service which obtains user information or acquaintance information is present to a user having been uniquely specified. However, in the third embodiment which starts from the goods sales service, the server of the goods sales service does not hold this context information. As a result, a different process to that in the second embodiment is required.

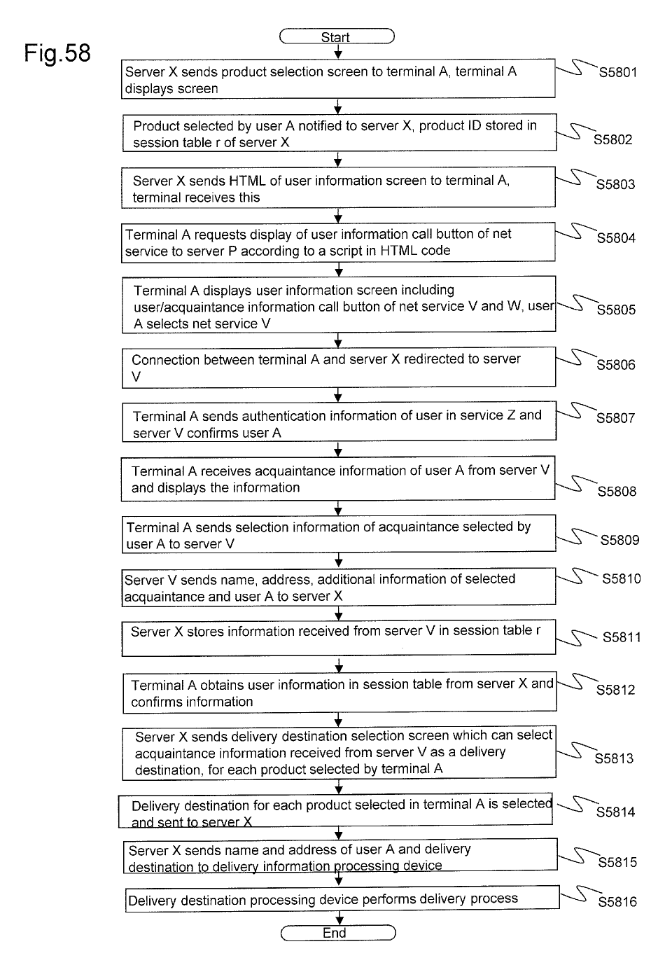

The third embodiment is explained below while referring to the flow chart in FIG. 58. First, user A connects terminal A 3110 to the server X 3130 via the network 3199. The HTML generation means 3132 of server X generates an HTML code for a product selection screen using information stored in a product table 3136. The sending and receiving means 3131 sends this code to terminal A via the network 3199. When the sending and receiving means 3111 receives this, this is analyzed by the HTML analysis means 3112 and the product selection screen shown in FIG. 47 is displayed by the GUI display means 3113 (step S5801). Next, user A moves the cursor 4604 displayed in the GUI display means 3113 by operating the input means 3114, and selects a product selection button 4613 and a product selection button 4623. Then, the sending and receiving means 3111 sends selection information of products correlated with the product selection button 4613 and the product selection button 4623 respectively to server X 3130 via network 3199. In server X, when the sending and receiving means 3131 receives the product selection information, a session table in which a session number is [r] is generated in a storage means 3134. The session table in which the session number is [r] has the structure shown in FIG. 46. In the explanation below, the session number 4501 explained using FIG. 46 is replaced with r.

Next, a product ID of a product of which selection information is received from terminal A is stored by a storage means in a product selection ID field 4502 of a the session table in which the session number is [r] (step S5802). In the example shown in FIG. 46, MID₁ which is a product ID correlated with the product selection button 4613, and MID₂ which is a product ID correlated with the product selection button 4623, are stored in the selected product ID field 4502. At this time, a selected product is stored in the session table in which the session number is [r]. However, all other fields are empty. In the second embodiment, information is already stored in each field which stores acquaintance or user information at the time where the selected product ID is stored in step S4505. However, in the third embodiment, this information is stored in the field in a later step.

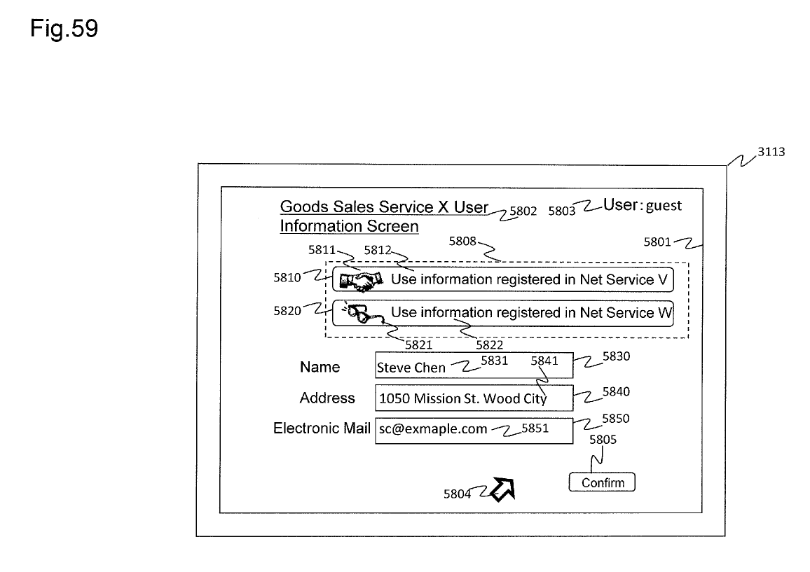

Next, the HTML generation means 3132 of server X generates an HTML code for a user information screen and the code is sent to terminal A 3110 via network 3199. The code is received by the sending and receiving means 3111 of terminal A (step S5803). An example of a user information screen is shown in FIG. 59. The window 5801 in the user information screen includes a display 5802 which shows that the screen is the user information screen of the goods sales service X, a display 5803 which shows that the user is a user of the goods sales service X and a service selection part 5808. A program which includes an instruction code comprised by a script language for example, is embedded in the within a region 5808 of the HTML code received by terminal A from the server X. According to this instruction code, the sending and receiving means 3111 sends a display request of the contents of the region 5808 and SIDx which is a service ID of the goods sales service x to the server P 3120 via the network 3199. Referring to FIG. 44, when the sending and receiving means 3121 receive this, the search means 3123 searches the goods sales service table 3126 and the network service column 4390 using SIDx as a search key. Then, SIDv4392 and SIDw4329 which represent the network service V as a network service which can use user information or acquaintance information in the goods sales service X are obtained. Next, the search means 3123 searches the name column 4310 and the image information column 4330 of the network service table 3125 using SIDv and SIDw as a search key. As a result, the name 4311 and the image 4331 of the network service V and the name 4312 and the image 4332 of the network service W are obtained. Next, the HTML generation means generates a HTML code which includes these and the sending and receiving means 3121 sends them to terminal A via network 3199. When the sending and receiving means 3111 of terminal A receives these, the HTML analysis means 3112 analyzes this and a user information screen is created including the details of the service selection part 5808 shown in FIG. 59. In the example shown in FIG. 59, a selection button 5810 of the network service V and a selection button 5820 of the network service W are displayed. The image 5811 is generated from the image 4331 sent from the server P and the name 5812 is generated from the name 4311 sent from the server P. In addition, the image 5821 is generated from the image 4332 sent from server P and the name 5822 is generated from the name 4332 sent from server P. Furthermore, in the third embodiment, a request for information which displays the contents of the service selection part 5808 is sent by terminal A to the server P and the selection buttons 5810 and 5820 are sent from the server P to terminal A. As an alternative embodiment however, a request for displaying the contents of the network service region 5808 may be sent to the server P by the server X, the server P may send the selection buttons 5810 and 5820 to the server X, the server X may generate an HTML code which includes these buttons and send the code to terminal A and terminal A may perform the display shown in FIG. 59. As a further alternative embodiment, a link to server P may simply be correlated with the service selection part 5808. In this case, when user A selects the service selection part, the connection between terminal A and server X is redirected to server P, the HTML generation means 3122 in server P generates an HTML code of a screen for selecting network service V and network service W from the network service table 3125 and goods sales service table 3126 and sends the code to terminal A. User A selects service V using this screen.

In addition, in the example shown in FIG. 59, a field 5830 for inputting the name of a user, a field 5840 for inputting an address, and a field 5850 for inputting an electronic mail address are displayed and are empty at this time. User A can input his/her own name, address, and electronic mail address in these fields using the input means 3114. However, in the present embodiment, it is possible to obtain this information from a server of the network service V in which user A stores user information and acquaintance information without inputting information into these fields. As a result, user A moves the cursor 5804 using the input means 3114 and selects the selection button 5810 (step S5805).

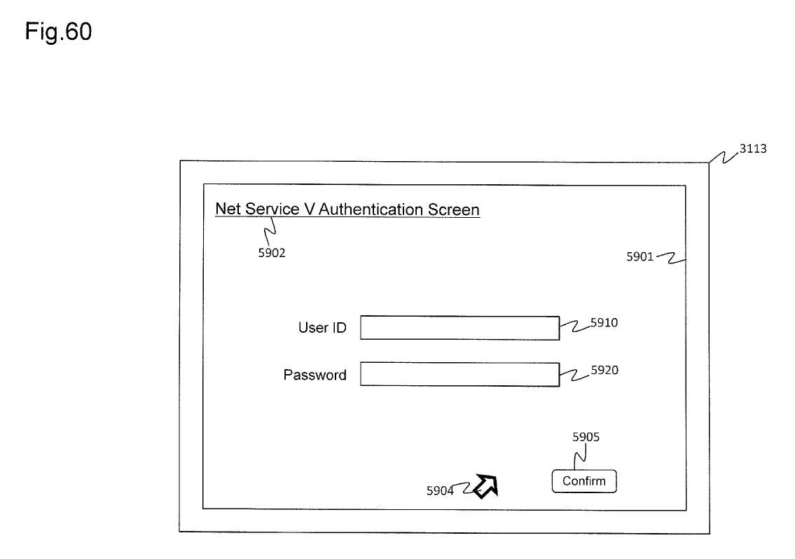

Next, the connection from terminal A to server X is redirected from server X to server V (step S5806). The HTML generation means 3152 generates HTML code for a user authentication screen and the sending and receiving means 3151 sends the code to terminal A via the network 3199. When the sending and receiving means 3111 receives the code, an authentication screen of network service V is displayed in the GUI display means 3113 after the analysis by the HTML analysis means 3112. An example of an authentication screen of the network service V is shown in FIG. 60. The window 5901 of the network service V includes a display 5902 which shows the screen is the authentication screen of the network service V, a user ID input part 5910, a password input part 5920 and a confirmation button 5905. User A moves the cursor 5904 using the input means 3114, inputs the user ID of user A in the network service V into the input part 5910 and the password intro the 5920 and selects the confirmation button 5905. Then, the ID and password input from the input means 3113 are sent to the server V via network 3199. When the sending and receiving means 3151 receives the ID and password, the search means 3153 searches the user authentication table 3155 and user A is authenticated when there is a match between the ID and password of user A stored in advance (step S5807). Here, a combination of a user ID and password are used in authenticating user A. However, in the present embodiment, authentication is not limited to this. For example, any method can be used as long as it can uniquely specify user A among users of the network service V such as biological authentication information.

Next, the search means 3153 of server V searches the acquaintance information table 3156 using the user ID of user A as a search key and acquaintance information of user A is obtained. An example of the acquaintance information table 3156 is shown in FIG. 39. In the example shown in FIG. 39, three people, “John Brown” 3811, “Betty Thomas” 3812 and “Fred Mancini” 3183 are stored as acquaintances of user A. It is not necessary to store all the information in the columns with respect to each acquaintance. In the example in FIG. 39, the address 3823 correlated with “Fred Mancini” does not exist and the additional information 3831 correlated with “John Brown” does not exist. In addition, an acquaintance of user A may be a user of the network service V or may not be a user of the network service V. In the example shown in FIG. 39, “Betty Thomas” and “Fred Mancini” are users of the network service V and include user IDs, IDvb 3842 and IDvc 3843, of the network service V.

Next, the HTML generation means 3152 generates an HTML code for an acquaintance information display screen using the acquaintance table of user A which is searched and the sending and receiving means 3151 sends this to terminal A 3110 via the network 3199. The sending and receiving means 3111 in terminal A receives this and an acquaintance information display screen is displayed in the GUI display means 3113 after the analysis by the HTML analysis means 3112 (step S5808).

An example of an acquaintance information display screen of user A in the network service V is shown in FIG. 40. The acquaintance information display part 3910 displays a part or all of the acquaintance information stored by user A in the server V and includes an acquaintance selection part 3911 for selecting each acquaintance.

In the example shown in FIG. 40, user A moves a cursor 3904 displayed in the GUI display means 3113 using the input means 3114 and selects a selection part 3912 correlated with the acquaintance “John Brown” and a selection part 3913 correlated with the acquaintance “Fred Mancini”. In the example shown in FIG. 40, user A selects the acquaintance “John Brown” who has address information stored in the server V. However, the selected acquaintance may be a user of the network service V such as “Betty Thomas” in FIG. 40 for example. In addition, the selected acquaintance may be an acquaintance who has address information stored in server V such as “Fred Mancini” but does not have an address record stored in server V. The acquaintance selected by user A may be one acquaintance or a plurality of acquaintance. User A then moves the cursor 3904 and selects a selection completion button 3906. Next, the sending and receiving means 3111 sends the selection information of “John Brown” and “Fred Mancini” to the server 3150 via the network 3199 (step S5804).

The sending and receiving means 3151 of server X receives this selection information. The sending and receiving means 3151 sends the name, address and addition aI information of an acquaintance selected by user in step S5809, and the name, the address, and the additional information of user A him/herself from among acquaintance information of user A stored in the acquaintance information table to server X via network 3199 (step S5810).

When the sending and receiving means 3131 receives this information, it is stored in a session table in which the session number is [r]. Again referring to FIG. 46, the selected acquaintance name “John Brown” and his address 4521 sent in step S5810, the selected acquaintance name “Fred Mancini” 4512 and his additional information 4532, and the name of user himself “Steve Chen” 4551 and his address 4561 and additional information 4571 are stored in the session table in which the session number is [r] (step S5811). At this stage, the selected product ID columns 4540 and 4580 are empty.

Next, the sending and receiving means 3131 sends the HTML code which includes the name, the address and the electronic mail address of user A stored in the session table in which the session number is [r], to terminal A via network 3199. When the sending and receiving means 3112 of terminal A receives the HTML code, an image which includes the name, the address and the electronic mail address of user A shown in FIG. 59 is displayed in the GUI display means 3113 after the analysis by the HTML analysis means 3112. In the example shown in FIG. 59, user A does not have a user ID in the goods sales service X. However, unlike the case shown in FIG. 59, user A may have a user ID in the goods sales server X. At this stage, the window 5801 displays information of user A stored in the session table of server X. In the example shown in FIG. 59, the name 5831 of user A is displayed as information of field 4551 in a session table, the address 5841 of user A is displayed as information of field 4561 in a session table and electronic mail 5851 is displayed as information of field 4571 in a session table. According to a conventional product purchasing method in a goods sales service, after a product to be purchased is selected, an operation for inputting information of a user is required. However, in the present embodiment, because the server X temporarily stores information of user A stored in advance in server V in the session table in which the session number is [r] and uses this information, user A can omit an operation for inputting his/her own information while terminal A is connected to server X. It is also possible for user A to correct the information displayed in each name, address, and electronic mail display section using the input means 3114 while the information of user A is displayed as in FIG. 59.

Next, user A moves the cursor 4704 using the input means 3114 and selects the confirmation selection button 5805. Then, the sending and receiving means 3111 sends confirmation information of a user information screen to the server X via network 3199. When the sending and receiving means 3131 in server X receives the confirmation information, the search means 3133 searches a product table using a selection product ID stored in the session table in the state shown in FIG. 46 as a search key, and product information of a product selected by user A in step S5802 is obtained. Next, the HTML generation means 3132 generates an HTML code of a delivery destination selection screen for selecting the delivery destination of each product selected in step S5802, the sending and receiving means 3131 receives this and sends this to terminal A via network 3199 (step S5813). When the sending and receiving means 3111 in terminal A receives this, the GUI display means 3113 displays a delivery destination selection screen after the analysis by the HTML analysis means 3112.

An example of a delivery destination selection screen of a goods sales service in terminal A is shown in FIG. 49. The window 4801 of the delivery destination selection screen includes a display 4802 that shows this is the delivery destination selection screen. In the example shown in FIG. 49, user A does not have a user ID in the goods sales service X but may have a user ID in the goods sales service X as described above. Furthermore, the window 4801 includes a shopping cart display part 4810. Product information of a product selected by user A in step S5802 is displayed in the shopping cart display part 4810. In the example shown in FIG. 49, product information 4821 and 4822 related to “flowers” selected in step S5802, and product information 4831 and 4832 related to “shirts” are displayed in the shopping cart display part. Furthermore, a delivery destination section part 4823 correlated with “flowers” and a delivery destination section part 4833 correlated with “shirts” is displayed. At this time, the delivery destination information 4824 and 4825 correlated with the delivery destination selection part 4823 are not displayed.

User A moves the cursor 4804 and selects the delivery destination selection part 4823 using the input means 3114. The sending and receiving means 3111 sends the selection information to the server X via network 3199. When the sending and receiving means 3131 receives the selection information, the HTML generation means 3132 generates an HTML code for a delivery destination selection screen which includes selection acquaintance name information 4511 and 4152 stored in the session table shown in FIG. 46, the sending and receiving means 31331 receives this and sends this to terminal A via network 3199. The sending and receiving means 3111 in terminal A receives the HTML code and the GUI display means 3113 displays a delivery destination selection screen which includes the selection acquaintance name and user name after the analysis by the HTML analysis means 3112. As a result, a delivery destination selection option is correlated with the delivery destination selection part 4823 and displayed as is shown in FIG. 49. “John Brown” 4824 displayed as a delivery destination selection option corresponds to the selection acquaintance name 4511 in the session table in which [n] is the session number, “Fred Mancini” 4825 corresponds to the selection acquaintance name 4512 in the session table and “Steve Chen (himself)” 4826 corresponds to the user name information 4551 in the session table in which [n] is the session number. Next, user A moves the cursor 4804 and selects the selection option “John Brown” 4824 using the input means 3114 thereby terminal A is instructed to send “flowers” to “John Brown”. Next, the sending and receiving means 3111 sends the selection information of “John Brown” with respect to “flowers” to the server X via network 3199 (step S4511). When the sending and receiving means 3131 of server X receives the information, the session table in which the session number is [r] stores MID₁ which is the product ID of the selected “flowers” in the product selection ID field 4541.

In addition, user A moves the cursor 4804 and selects the delivery destination selection part 4833 using the input means 3114. The GUI display means 3113 in terminal A displays the screen shown in FIG. 50 using a similar process as that described above. In the example shown in FIG. 50, the delivery destination selection option is correlated with the delivery destination selection part and displayed. “John Brown” 4934 displayed as a delivery destination selection option corresponds to the selection acquaintance name 4511 in the session table, “Fred Mancini” 4935 corresponds to the selection acquaintance name 4512 in the session table and “Steve Chen (himself)” 4936 corresponds to the user name information 4551 in the session table. Next, user A moves the cursor 4904 and selects the selection option “Fred Mancini” 4935 using the input means 3114 thereby terminal A is instructed to send “shirts” to “Fred Mancini”.

In addition, the sending and receiving means 3111 sends the selection information “Fred Mancini” with respect to “shirts” to the server X via network 3199 (step S5814). When the sending and receiving means 3131 of server X receives the information, the session table in which the session number is [r] stores MID₂ which is the product ID of the selected “shirts” in the product selection ID field 4542. Next, user A moves the cursor 4904 and selects confirmation button 4905 using the input means 3114. Then, the sending and receiving means 3111 sends the confirmation information to the server X via network 3199. The present embodiment is explained in this example using a process for sending a product to an acquaintance. However, the present embodiment is not limited to this. It is possible to specify a delivery destination to the user him/herself and not an acquaintance by selecting “Steve Chen (himself)” 4826 or 4836 in step S4508 described above. In addition, in this example, terminal A individually sends selection information with respect to “flowers” and “shirts” in the shopping cart to the server X. However, in the present embodiment the information may also be sent simultaneously to the server X. At this time, sender information of user A, the delivery destination information and the product ID and the delivery information for each delivery destination required for delivery of a product to an acquaintance obtained by server X from user A are stored in the session table in which the session number is [r] by the process in step S5801 to S5814.

Next, the sending and receiving means 3131 sends the information in the session table in which the session number is [n] to the delivery information processing device 3170 via network 3199 (step S5815). In the delivery information processing device, the sending and receiving means 3171 receives this information. As is shown in FIG. 46, MID₁ which is a product ID correlated with the acquaintance “John Brown” and which corresponds to an address and “flowers” are stored. As a result, the printing means 3172 prints the name 4551 and the address 4561 of user A and information of the sender and “John Brown” 4511 and his address 4521 as information of the delivery destination on a delivery receipt. In addition, the display means 3173 displays the relationship between the printed receipt and the product ID and a delivery process of the product which includes MID₁ is performed based on this relationship (step S5816). On the other hand, with respect to “Fred Mancini” 4512 to whom user A sends a “shirt”, because an address is not stored in a session table in which the session number is [r] at this time, the process in step S5816 cannot be performed. In this case, the message generation means 3137 in server X creates a message requesting input of an address, and the sending and receiving means 3131 sends this message via network 3199 using the electronic mail address 4532 in the session table in which the session number is [r]. When the sending and receiving means 3111 receives the address information from the information terminal of “Fred Mancini”, the information is correlated with “Fred Mancini” 4512 and stored in the selected acquaintance information field 4522 in the session table. Following this, steps S5815 and S45816 are performed the same as “John Brown”.

First, after user selects a product in the goods sales service X, information of user a him/herself and acquaintance information is stored in the server X of the goods sales service from the server of the network service V in which user A stores acquaintance information, and using this information a process for easily sending a product in the goods sales service is complete.

Next, several effects of the present invention explained using the second and third embodiments above are explained. As already described, the largest problem in a link between various network services which become an advertisement media and goods sales services is a low closing rate in the goods sales service. It is generally said the closing rate of users which move to a goods sales service via an advertisement is between 1% to 5%. As a result, there is significant room for improving the profits of both goods sales services and network services, and improving closing rates is the most important problem from the view point of business.

There are two methods for improving a closing rate of a user via a network service in a goods sales service. The first method is reducing the number of steps in an input process when a user purchases a product in a goods sales service. The second method is increasing the incentive to a user of a network service to purchase a product when mobbing to the goods sales service. The present invention provides the following five effects in this type of situation.

The first effect of the present embodiment is that it is possible to significantly reduce the leaving rate in the input of a user in the case where the user moves to a goods sales service which uses an embodiment of the present invention via a network service which uses an embodiment of the present invention compared to a conventional method. This effect is related to the second embodiment. In a conventional method, a user moves to a goods sales services according to an advertisement link in a network service. Following this, the user selects a product, registers their name and address, registers the name and address of a delivery destination and registers settlement information in this order. Many users who move to a goods sales service according to an advertisement link displayed in a network service are users who are using the goods sales service for the first time. While selection of a product is relatively easy by a simple click of a product, inputting the name and address of a user is complex, and many users leave the goods sales service at the point where they are requested to input their name and address. In all goods sales service which uses a conventional method, the leaving rate at an input screen of user information is the main reason for a decrease in a closing rate. On the other hand, according to an embodiment of the present invention, the name, address and electronic mail address of a use is displayed simply by clicking the button 4706 or button 5406 in the user information input screen in FIG. 48 or FIG. 55 for example. In this way, the number of user input steps is greatly reduced which contributes to a decrease in the leaving rate.

The second effect is that it is possible to significantly reduce a leaving rate at the input of user information or delivery information compared to a conventional method even in the case where a user who moves to a goods sales service which uses an embodiment of the present invention via a network service which uses an embodiment of the present invention, or a user who uses a goods sales service who uses an embodiment of the present invention from the start purchases a product. This effect is related to the third embodiment. In a conventional method, there is no move to a goods sales service together with the user information stored in a server of a network service, which is different to the method related to an embodiment of the present invention. However, as explained in the third embodiment, if a goods sales service uses the method of the present invention, it is possible for a user to store his/her own name and address and to select a network service which uses the method of the present invention as is shown in FIG. 59 for example. In the example in FIG. 59, the name, the address, and the electronic mail of a user is displayed simply by clicking the selection button 5810 or selection button 5820, inputting authentication information of a network service used by the user as is shown in FIG. 60. Compared to the second embodiment, an input step of authentication information is added. However, number of user input steps is greatly reduced which contributes to a decrease in the leaving rate compared to an input of a name and address according to a conventional method.

The third effect is that an input of the name and address of a delivery destination in a goods sales service which uses an embodiment of the present information is simplified. In a conventional method, it is necessary to input the name and the address for each acquaintance to whom a product is to be delivered, and because there are many user input steps the leaving rate is decreased. In particular, in a goods sales service which aims to send a plurality of different gifts to a plurality of different acquaintances, not only are there many input steps but the user interface for input multiple relationships between delivery destinations and products which also decreases the closing rate. However, according to an embodiment of the present invention, a selection option of a delivery destination for each product is displayed as is shown in FIG. 49 or FIG. 50 for example, and the input process of a delivery destination is completed simply by clicking the name of acquaintance who is the delivery destination. The number of steps is significantly fewer compared to an input process of a name and address according to a conventional method. In addition, because there is no need for a keyboard, this is particularly applicable to an input using a mobile terminal. For these reasons the closing rate in a goods sales service is improved.

The fourth effect is that it is possible to allow a user of a network service which uses an embodiment of the present invention to move to a goods sales service while holding a large purchasing incentive in a goods sales service. According to a conventional method, a network service includes a URL for identifying a goods sales service as link information, and a user moves to a goods sales service according to this link. At this time, many of the incentives for a user of a network service to click a link are to browse product information. As a result, after moving to a goods sales service, a user browses product information but the proportion of users who leave without purchasing product is high. However, a user of a network service which uses an embodiment of the present invention moves to a goods sales service while selecting the user him/herself or an acquaintance as the delivery destination. This means that that a user moves to a goods sales service holding a clear intention to “send a product to myself or an acquaintance”. This can realize an improvement in the closing rate of a goods sales service.

The first effect is that it is easy to increase the number of linking network services and goods sales services without adding a change to a server in each network service or each goods sales service and increasing even if the number of network services or goods sales service which use an embodiment of the present invention increases. For example, suppose that only a network service X and goods sales service V are linked by the method relating to an embodiment of the present invention as shown in the second embodiment. At this time, a goods sales service selection screen displayed in a display means of terminal A in step S3809 is not shown in FIG. 43 but is the screen in which only the goods sales service X 4211 is displayed as a selection option. Following this, when the goods sales service Y begins a link with network service V, the goods sales service selection screen must be changed as is shown in FIG. 43. In this way, changing the goods sales service selection screen generated by the HTML generation means 3152 in server V cannot be realized every time the number of linking goods sales services increases. However, according to an embodiment of the present invention, the server selection part 4205 in FIG. 43 is sent to terminal A 3110 by link server P and is displayed. As a result, in the case where network service V creates a new link with the goods sales service Y, a link according to the present invention between network service V and goods sales service Y can be realized simply by refreshing the information of the network service table 3125 and the goods sales service table 3126 in server P without adding a change to server V.

Similarly, suppose only the network service X and the goods sales service V are linked by the method related to an embodiment of the present invention as shown in the third embodiment. The service selection screen displayed in terminal A in step S5805 is not the screen shown in FIG. 59 but the screen in which only the network service V 51810 is displayed as a selection option. Following this, when network service W starts a link with the goods sales service X, the service selection part 5808 must be changed as is shown in FIG. 59. in this way, changing the service selection screen generated by the HTML generation means 3152 in server X cannot be realized every time the number of network services increases. However, according to an embodiment of the present invention, the service selection part 5808 in FIG. 59 is sent to terminal A 3110 by the link server P 3120 and is displayed. As a result, in the case where the goods sales service X creates a new link with the network service W, a link according to the present invention between the goods sales service X and the network service W can be realized simply by refreshing the information of the network service table 3125 and the goods sales service table 3126 in the server P without adding a change to the server X. This fifth effect is not important when there are few linked network services and goods sales service as is shown in FIG. 32. However, when many network services which use an embodiment of the present invention and many goods sales services which use an embodiment of the present invention are linked, that is, when forming an advertisement is formed, this is effective in preventing a waste in server upgrade costs in each service.

In the explanation of the embodiments of the present invention, a network service is a service which stores the name and the address of a user him/herself correlated to a user ID and name and address of an acquaintance in its server. There are services such as a client management service, postcard creation service, event participation management database, or gift address management service as examples of a network service which includes this type of name and address. In this way, in the case where a network service which stores the name and address of users and acquaintances in a server in advance and a goods sales service are linked by the method of the present invention, the effects of reducing the number of input steps by a user is clear and is directly connected to improving the closing rate of a goods sales service.

In addition, while a network service in the present invention stores the ID of an acquaintance correlated with a user ID, the service may also be a service which does not store the name and address of an acquaintance. There are services which offer functions such as electronic mail, voice communication, SNS, blogs etc. All of these services include a means for sending a message to an acquaintance using an acquaintance ID as a search key. Therefore, even if the name and the address of an acquaintance are not stored in a server of a network service in advance, it is possible for a network service or goods sales service to send a request to an acquaintance who receives a product for registering their name and address before step S4511 or step S5814 using thee means for sending this message. If an acquaintance registers an acquaintance name and address in a network service or goods sales service according to this message, it is possible to perform the processes under step S4511 and step S5814. In this way, in the case where a goods sales service sends a product and is linked to a network service which does not store the name and the address of an acquaintance which becomes a delivery destination in a server in advance, it is the acquaintance receiving the product who inputs his/her name and address and not a user who purchases a product in the goods sales service. As a result, it is possible to reduce the number of input steps by a user in a goods sales service and improve a closing rate even when linked with a network service in this way compared to the conventional method.

According to the present invention, it is possible to reduce a product purchasing step and sending process step when a user moves to a goods sales service via a network service advertisement, and improve usefulness for users. Furthermore, it is also possible to significantly improve a closing rate in a goods sales service and increase the profits of a network service and goods sales service.

In addition, according to the present invention, when a user request delivery of a good or postal item in a certain Web service using a mobile terminal, it is possible to use the name and address which are delivery destination information stored in the server of a different Web service as the delivery destination for sending the good or postal item using this Web service. In this way, it is possible to reduce the number of display and input steps compared to a Web service using a conventional method or system and improving usefulness for users. In addition, in the present invention, despite realizing these effects, it is not necessary to send delivery destination information of a user stored in the server of a different Web service to the server of a certain Web service and the provider of this certain Web service cannot use this delivery destination information. In addition, because the server of a certain Web service does not need to receive delivery destination information of the this Web service, the provider of the certain Web service can reduce the risk of personal information leaks. Furthermore, in the present embodiment, the provider of a different Web service can permit only a specified Web service use of a user's delivery destination information stored in the server of a different Web service. As a result of these effects, mutual use of delivery destination information among a plurality of Web services using mobile terminals is promoted, usefulness for users is improved and the profits of all linked Web service providers using the present invention are improved.

What is claimed is:

1. A system comprising a first server providing a first network service which a first user uses, a first information terminal of the first user, and a second server providing a first goods sales service;
wherein the first server sends to the first information terminal of the first user first name information of a first acquaintance of the first user and second name information of a second acquaintance of the first user wherein the first server correlates and stores a first ID which uniquely specifies the first user from among users of the first network service,
the first information terminal displays the first name information of the first acquaintance and the second name information of the second acquaintance,
the first user selects the first name information of the first acquaintance displayed on the first information terminal,
the first information terminal sends the selection information of the first acquaintance to the first server,
the first server sends first address information and the first name information of the first acquaintance which the first server correlates and stores with the first ID to the second server;
the second server sends first product information of a first product to be sold by the first goods sales service and second product information of a second product to be sold by the first goods sales service to the first information terminal,
the first information terminal displays the first product information and the second product information,
the first information terminal sends selection information of the first product selected by the first user to the second server, and
the second server performs a first sending process in which the first product is sent to the first acquaintance by sending the first name information and the first address information of the first acquaintance in a state being correlated with the first product information to a first sending process system.

2. A system comprising a first server providing a first network service which a first user uses, a first information terminal of the first user, and a second server providing a first goods sales service;
wherein the first server sends the first information terminal of the first user first name information of a first acquaintance of the first user and second name information of a second acquaintance of the first user wherein the first server correlates and stores a first ID which uniquely specifies the first user from among users of the first network service,
the first information terminal displays the first name information and the second name information of the second acquaintance by the first information terminal,
the first user selects the first name information and the second name information, which are displayed on the first information terminal,
the first information terminal sends the selection information of the first acquaintance and the second acquaintance to the first server,
the first server sends the first name information and first address information of the first acquaintance which the first server correlates and stores with the first ID, and the second name information and second address information of the second acquaintance which the first server correlates and stores with the first ID to the second server,
the second server sends first product information of a first product to be sold by the first goods sales service and second product information of a second product to be sold by the first goods sales service to the first information terminal,
the first information terminal displays the first product information and the second product information,
the first information terminal sends selection information of the first product selected by the first user to the second server,
the second server sends the first name information and the second name information in a state being correlated with the first product information to the first information terminal,
the first information terminal displays the first name information and the second name information in a state of being correlated with the first product information,
the first user selects the first name information,
the first information terminal sends the selection information of the first name information to the second server, and
the second server performs a first sending process in which the first product is sent to the first acquaintance by sending the name information and the address information of the first acquaintance in a state being correlated with the first product information to a first sending process system by the second server.

3. The system according to claim 1, wherein the second server sends first user name information of the first user stored in the first server and first user address information of the first user to the second server, and the second server sends the first user name information and the first user address information to the first sending process system to be used in the first sending process.

4. A system comprising a first server providing a first network service which a first user uses, a first information terminal of the first user, and a second server providing a first goods sales service;
wherein the first server send to the first information terminal of the first name information of a first acquaintance of the first user and first user name information of the first user wherein the first server correlates and stores a first ID which uniquely specifies the first user from among users of the first network service,
the first information terminal displays the first name information of the first acquaintance and the first user name information,
the first user selects the first name information,
the first information terminal sends the selection information of the first name information to the first server,
the first server sends first address information of the first user and first user name information correlated and stored with the first ID to the second server,
the second server send first product information of a first product to be sold by the first goods sales service and second product information of a second product to be sold by the first goods sales service to the first information terminal,
the first information terminal displays the first product information and the second product information,
the first information terminal sends selection information of the first product selected by the first user to the second server,
the second server performing a second sending process in which the first product is sent to the first user by sending the first user name information and the first user address information in a state being correlated with the first product information to a first sending process system.

5. The system according to claim 1, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information displayed on the second information terminal,
the second information terminal sends the selection information of the third acquaintance to the third server,
the third server send third address information of the third acquaintance and the third name information which the third server correlates and stores with the second ID to the second server,
the second server sends the first product information and the second product information to the second information terminal,
the second information terminal displays the first product information and the second product information,
the second information terminal sends selection information of the first product selected by the second user to the second server, and
the second server performs a third sending process in which the first product is sent to the third acquaintance by sending the third name information and the third address information in a state being correlated with the first product information to the first sending process system.

6. The system according to claim 1, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information and the fourth name information,
the second information terminal sends the selection information of the third acquaintance and the fourth acquaintance to the second server,
the third server sends the third name information and third address information of the third acquaintance which the third server correlates and stores with the second ID, and the fourth name information and fourth address information of the fourth acquaintance which the third server correlates and stores with the second ID,
the second server sends first product information of a first product to be sold by the first sales goods service and second product information of a second product to be sold by the first goods sales service to the second information terminal,
the second information terminal displays the first product information and the second product information,
the second information terminal sends selection information of the first product selected by the second user to the second server,
the second server sends the third name information and the forth name information in a state being correlated with the first product information to the second information terminal,
the second information terminal displays the third name information and the fourth name information in a state being correlated with the first product information,
the second user selects the third name information,
the second information terminal sends selection information of the third acquaintance to the second server, and
the second server performs a third sending process in which the first product is sent to the third acquaintance by sending the third name information and the third address information in a state being correlated with the first product information to the first sending process system by the second server.

7. The system according to claim 5, wherein
the third server sends the second name information and the second address information of the second user which the third server stores to the second server, and
the second server send the second name information and the second address information to the first sending process system to be used in the third sending process.

8. The system according to claims 1, wherein
a third server providing a second network service which a second user uses sends third name information of a third acquaintance of the second user and second user name information of the second user to a second information terminal of the second user wherein the second server correlates and stores a second ID which uniquely specifies the second user from among users of the second network service,
the second terminal displays the third name information and the name information and the second user name information,
the second user selects the second user name information displayed on the second information terminal,
the second information terminal sends selection information of the second user to the third server
the third server sends second user address information of the second user and the second user name information which the third server correlates and stores with the second ID to the second server,
the second server sends the first product information and the second product information to the second information terminal,
the second information terminal displays the first product information and the second product information,
the second information server sends selection information of the first product selected by the second user to the second server, and
the second server performs a fourth sending process in which the first product is sent to the second user by sending the second user name information and the second user address information in a state being correlated with the first product information to the first sending process system.

9. The system according to claims 1, wherein
the first server sends to the first information terminal the first name information and the second name information,
the first information terminal displays the first name information and the second name information,
the first user selects the first name information displayed on the first information terminal,
the first information terminal sends selection information of the first acquaintance to the first server,
the first server sends the first address information and the first name information to a fourth server which provides a second goods sales service,
the fourth server sends third product information of a third product to be sold by the second goods sales service and fourth product information of a fourth product to be sold by the second goods sales service to the first information terminal,
the first information terminal displays the third product information and the fourth product information,
the first information terminal sends selection information of the third product selected by the first user to the fourth server, and
the fourth server performs a fifth sending process in which the third product is sent to the first acquaintance by sending the first name information and the first address information in a state being correlated with the third product information to the second sending process system.

10. A system comprising a first server providing a first goods sales server which a first user uses, a first information terminal of the first user, and a second server of a first network service that the first users uses;
wherein the first server sends first product information of a first product to be sold by the first goods sales service and second product information of a second product to be sold by the first goods sales service to the first information terminal,
the first information terminal displays the first product information and the second product information,
the first information terminal sends first selection information of the first product selected by the first user to the first server,
the first information terminal sends a first ID for identifying the first user among users of a first network service and a first password of the first user to the second server,
the second server authenticates the first user using the first ID and the first password,
the second server sends to the first information terminal first name information of a first acquaintance of the first user and second name information of a second acquaintance of the first user which the second server correlates and stores with the first ID,
the first information terminal displays the first name information and the second name information,
the first user selects the first name information displayed in the first information terminal,
the first information terminal sends selection information of the first acquaintance to the second server,
the second server sends first address information of the first acquaintance and the first name information which the second server correlates and stores with the first ID to the first server, and
the first server performs a sending process in which the first product is sent to the first acquaintance by sending the first name information and the first address information in a state being correlated with the first product information to a sending process system.

11. A system comprising a first server of a first goods sales service which a first user uses, a first information terminal of the first user, and a second server of a second network service
wherein the first server sends first product information of a first product to be sold by a first goods sales service and second product information of a second product to be sold by the first goods sales service to a first information terminal,
the first information terminal displays the first product information and the second product information,
the first information terminal sends first selection information of the first product selected by the first user to the first server,
the first information terminal receives first network service information of a first network service and second network service information of the second network service from the second server which provides a link service,
the first user selects the first network service information using the first information terminal,
the first information terminal sends a first ID of the first user for identifying the first user among users of the first network service and a first password of the first user to a third server of the first network service specified by the first network service information,
the third server authenticates the first user using the first ID and the first password,
the third server sends first name information of a first acquaintance of the first user and second name information of a second acquaintance of the first user which the third server correlates and stores with the first ID to the first information terminal,
the first information terminal displays the first name information and the second name information,
the first user selects the first name information displayed in the first information terminal,
the first information terminal sends selection information of the first acquaintance to the third server,
the third server sends first address information of the first acquaintance and the first name information which the third server correlates and stores with the first ID to the first server, and
the first server performs a sending process in which the first product is sent to the first acquaintance by sending the first name information and the first address information in a state being correlated with the first product information to a sending process system.

12. A system executing comprising a first server having a first table which correlates and stores a product identification tag and product additional information and providing a Web service, a mobile terminal, a second server, and a third server:
wherein the first server generates an image code which represents a product identification tag in the first table,
the mobile terminal sends a first identification tag of a user in the first Web service to the first server,
the first server authenticates the first user identification tag,
the mobile terminal sends the product identification tag to the first server after the mobile terminal reads the image code,
the first server sends the product identification tag and the first user identification tag to a second server,
the second server correlates the product identification tag and the first user identification tag and stores in a first row of a second table,
the mobile terminal sends a second user identification tag of the user in a second Web service to a third server which provides a second Web service,
the third server authenticates the second user identification tag,
the third server sends delivery destination information of the user stored in the third sever to the mobile terminal,
the mobile terminal displays delivery destination information of the user,
the mobile terminal sends selection completed delivery destination information selected by the mobile terminal to the third server,
the third server sends the selection completed delivery destination information to the second server by the second server,
the second server correlates the selection completed delivery destination information with the product identification tag and the first user identification tag in the first row and storing in the first row of the second table,
the second server performs a process for sending the selection completed delivery destination information to a printing device when the second server receives payment completion information from the first server.

13. The system according to claim 12, wherein the first row is deleted from the second table after the second server sends the selection completed delivery destination information to the printing device.

14. The system according to claim 12, wherein before the process is performed, the second server receives a first service identification tag which represents the first Web service from a management terminal of the third Web service;
the second server correlates a second service identification tag which represents the third Web service and the first service identification tag and stores in a third table; and
the second server does not perform the process apart from the first Web service represented by the first service identification tag and the third Web service represented by the second service in the third table.

15. A mobile terminal executing the steps comprising:
sending a first identification tag of a first user in a first Web service and a first authentication tag of the user in the first Web service to a first server which provides the Web service,
receiving a service identification tag group comprised from a plurality of identification tags which shows each of a plurality of Web services other than the first Web service by a second server which provides a link service,
sending a specific service identification tag which shows a third Web service selected by the user from the service identification tag group using an input means to the second server,
sending a second identification tag of the user in the third Web service and a second authentication tag of the user in the third Web service to a third server which provides the third Web service,
receiving a plurality of delivery destination information groups of the user stored by the third server by the third server,
sending partial delivery destination information groups selected by the user using the input means from among the delivery destination information groups to the third server, and
sending payment information to the first server.

16. The system according to claim 2, wherein the second server sends first user name information of the first user stored in the first server and first user address information of the first user to the second server, and the second server sends the first user name information and the first user address information to the first sending process system to be used in the first sending process.

17. The system according to claim 2, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information displayed on the second information terminal,
the second information terminal sends the selection information of the third acquaintance to the third server,
the third server send third address information of the third acquaintance and the third name information which the third server correlates and stores with the second ID to the second server,
the second server sends the first product information and the second product information to the second information terminal,
the second information terminal displays the first product information and the second product information,
the second information terminal sends selection information of the first product selected by the second user to the second server, and
the second server performs a third sending process in which the first product is sent to the third acquaintance by sending the third name information and the third address information in a state being correlated with the first product information to the first sending process system.

18. The system according to claim 4, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information displayed on the second information terminal,
the second information terminal sends the selection information of the third acquaintance to the third server,
the third server send third address information of the third acquaintance and the third name information which the third server correlates and stores with the second ID to the second server,
the second server sends the first product information and the second product information to the second information terminal,
the second information terminal displays the first product information and the second product information,
the second information terminal sends selection information of the first product selected by the second user to the second server, and
the second server performs a third sending process in which the first product is sent to the third acquaintance by sending the third name information and the third address information in a state being correlated with the first product information to the first sending process system.

19. The system according to claim 2, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information and the fourth name information,
the second information terminal sends the selection information of the third acquaintance and the fourth acquaintance to the second server,
the third server sends the third name information and third address information of the third acquaintance which the third server correlates and stores with the second ID, and the fourth name information and fourth address information of the fourth acquaintance which the third server correlates and stores with the second ID,
the second server sends first product information of a first product to be sold by the first sales goods service and second product information of a second product to be sold by the first goods sales service to the second information terminal,
the second information terminal displays the first product information and the second product information,
the second information terminal sends selection information of the first product selected by the second user to the second server,
the second server sends the third name information and the forth name information in a state being correlated with the first product information to the second information terminal,
the second information terminal displays the third name information and the fourth name information in a state being correlated with the first product information,
the second user selects the third name information,
the second information terminal sends selection information of the third acquaintance to the second server, and
the second server performs a third sending process in which the first product is sent to the third acquaintance by sending the third name information and the third address information in a state being correlated with the first product information to the first sending process system by the second server.

20. The system according to claim 4, wherein
a third server providing a second network service to a second user sends to a second information terminal third name information of a third acquaintance of the second user and fourth name information of a fourth acquaintance of the second user wherein the third server correlates and stores a second ID which uniquely specifies the second user from among users of the second network service,
the second information terminal displays the third name information and the fourth name information,
the second user selects the third name information and the fourth name information,
the second information terminal sends the selection information of the third acquaintance and the fourth acquaintance to the second server,
the third server sends the third name information and third address information of the third acquaintance which the third server correlates and stores with the second ID, and the fourth name information and fourth address information of the fourth acquaintance which the third server correlates and stores with the second ID,
the second server sends first product information of a first product to be sold by the first sales goods service and second product information of a second product to be sold by the first goods sales service to the second information terminal,
the second information terminal displays the first product information and the second product information,
the second information terminal sends selection information of the first product selected by the second user to the second server,
the second server sends the third name information and the forth name information in a state being correlated with the first product information to the second information terminal,
the second information terminal displays the third name information and the fourth name information in a state being correlated with the first product information,
the second user selects the third name information,
the second information terminal sends selection information of the third acquaintance to the second server, and
the second server performs a third sending process in which the first product is sent to the third acquaintance by sending the third name information and the third address information in a state being correlated with the first product information to the first sending process system by the second server.

21. The system according to claim 2, wherein
a third server providing a second network service which a second user uses sends third name information of a third acquaintance of the second user and second user name information of the second user to a second information terminal of the second user wherein the second server correlates and stores a second ID which uniquely specifies the second user from among users of the second network service,
the second terminal displays the third name information and the name information and the second user name information,
the second user selects the second user name information displayed on the second information terminal,
the second information terminal sends selection information of the second user to the third server
the third server sends second user address information of the second user and the second user name information which the third server correlates and stores with the second ID to the second server,
the second server sends the first product information and the second product information to the second information terminal,
the second information terminal displays the first product information and the second product information,
the second information server sends selection information of the first product selected by the second user to the second server, and
the second server performs a fourth sending process in which the first product is sent to the second user by sending the second user name information and the second user address information in a state being correlated with the first product information to the first sending process system.

22. The system according to claim 4 wherein
a third server providing a second network service which a second user uses sends third name information of a third acquaintance of the second user and second user name information of the second user to a second information terminal of the second user wherein the second server correlates and stores a second ID which uniquely specifies the second user from among users of the second network service,
the second terminal displays the third name information and the name information and the second user name information,
the second user selects the second user name information displayed on the second information terminal,
the second information terminal sends selection information of the second user to the third server
the third server sends second user address information of the second user and the second user name information which the third server correlates and stores with the second ID to the second server,
the second server sends the first product information and the second product information to the second information terminal,
the second information terminal displays the first product information and the second product information,
the second information server sends selection information of the first product selected by the second user to the second server, and
the second server performs a fourth sending process in which the first product is sent to the second user by sending the second user name information and the second user address information in a state being correlated with the first product information to the first sending process system.

23. The system according to claim 2, wherein
the first server sends to the first information terminal the first name information and the second name information,
the first information terminal displays the first name information and the second name information,
the first user selects the first name information displayed on the first information terminal,
the first information terminal sends selection information of the first acquaintance to the first server,
the first server sends the first address information and the first name information to a fourth server which provides a second goods sales service,
the fourth server sends third product information of a third product to be sold by the second goods sales service and fourth product information of a fourth product to be sold by the second goods sales service to the first information terminal,
the first information terminal displays the third product information and the fourth product information,
the first information terminal sends selection information of the third product selected by the first user to the fourth server, and
the fourth server performs a fifth sending process in which the third product is sent to the first acquaintance by sending the first name information and the first address information in a state being correlated with the third product information to the second sending process system.

24. The system according to claim 4, wherein
the first server sends to the first information terminal the first name information and the second name information,
the first information terminal displays the first name information and the second name information,
the first user selects the first name information displayed on the first information terminal,
the first information terminal sends selection information of the first acquaintance to the first server,
the first server sends the first address information and the first name information to a fourth server which provides a second goods sales service,
the fourth server sends third product information of a third product to be sold by the second goods sales service and fourth product information of a fourth product to be sold by the second goods sales service to the first information terminal,
the first information terminal displays the third product information and the fourth product information,
the first information terminal sends selection information of the third product selected by the first user to the fourth server, and
the fourth server performs a fifth sending process in which the third product is sent to the first acquaintance by sending the first name information and the first address information in a state being correlated with the third product information to the second sending process system.

25. The system according to claim 13, wherein before the process is performed, the second server receives a first service identification tag which represents the first Web service from a management terminal of the third Web service;
the second server correlates a second service identification tag which represents the third Web service and the first service identification tag and stores in a third table; and
the second server does not perform the process apart from the first Web service represented by the first service identification tag and the third Web service represented by the second service in the third table.
